(19) United States
(12) Patent Application Publication
(10) Pub. No.: US 2026/0237792 A1
(43) Pub. Date: Aug. 13, 2026

(54) BATTERIES WITH INTEGRATED HIGH-FREQUENCY HEATERS POWERED BY EXTERNAL SOURCES OR BATTERY POWER

(71) Applicant: Omnitek Partners LLC, Ronkonkoma, NY (US)

(72) Inventor: Jahangir S. Rastegar, Stony Brook, NY (US)

(73) Assignee: Omnitek Partners LLC, Ronkonkoma, NY (US)

(21) Appl. No.: 19/534,542

(22) Filed: Feb. 9, 2026

Related U.S. Application Data
(60) Provisional application No. 63/756,115, filed on Feb. 8, 2025.

(51) Int. Cl. H01M 10/6571; H01M 10/42; H01M 10/44; H01M 10/615

(52) U.S. Cl. CPC H01M 10/6571; H01M 10/425; H01M 10/44; H01M 10/615

(57) ABSTRACT

An integrated self-heating device including: a battery having a core with an electrolyte having ions therein; a heater/ionic exciter coupled to the battery to provide a high frequency input to the battery; a controller configured to control the heater/ionic exciter to operate in each of at least two modes and to enable and disable providing the high frequency input to the battery; and a temperature sensor circuit configured to receive an indication of a temperature of the battery, the temperature sensor circuit is coupled to the controller to provide the controller with the indication of the temperature of the battery, the controller controls the heater/ionic exciter to operate in the first mode when the temperature of the battery is below an operational temperature range and to operate in the second mode when the battery receives fast charging and is within the operational temperature range.

### CROSS-REFERENCE TO RELATED APPLICATIONS

This application claims the benefit of priority to U.S. Provisional Application 63/756,115, filed on Feb. 8, 2025, the entire contents of which is incorporated herein by reference.

### BACKGROUND

### Field

This disclosure is directed to methods and devices for fast charging batteries and more particularly to methods and devices for fast charging batteries at high DC currents while avoiding damage to the battery. At low temperatures, the battery electrolyte may be heated directly before rapid charging. The methods and devices are applicable to primary and secondary batteries, such as Lithium-ion, Lithium-polymer, NiMH and lead-acid batteries and are also applicable to super-capacitors. The batteries and battery packs may be integrated with the high-frequency current generating electronic circuits that are used during charging and be powered by external sources or powered by battery while the battery is powering an electrically powered platform.

### Prior Art

The performance of batteries and super-capacitors is significantly reduced at low temperatures. This is the case for both primary and rechargeable batteries. In addition, current lithium-ion and Lithium-polymer battery technology does not allow battery charging at temperatures below zero degrees C. and charging at temperatures below their optimal level has been shown to reduce battery life.

Current solutions that try to address cold weather effects on batteries include heating the exterior of the battery by integrating “heaters” into the battery compartment or using heating blankets, or recently by embedding heating elements inside the batteries.

It is also well known that even at their optimal performance temperature, usually around room temperature, if the battery is charged at high rates, i.e., the so-called “fast charging”, does also similarly damage batteries and reduces the battery life. This is particularly the case in lithium-ion, Lithium-polymer, and other similar batteries that are used or are planned to be used in various vehicles and other mobile platforms as well as for large energy storage applications. Fast charging, particularly at 2C-3C rates and higher, of such batteries is very important since it is one of the main challenges in many applications, such as in electric vehicles and trucks and other electric powered platforms. It is appreciated that fast charging at 2C-3C or higher is desired to be without damage to the battery and reduction in its life, i.e., the so-called cycle time.

In many applications, when electronic sensors, safety and power management electronics are needed for battery packs, they are packaged inside the battery pack for ease of implementation in the overall battery-operated platform and other issues, such as safety, space savings, technical reason, such as reducing and controlling wire lengths, noise reductions, etc. In addition, by packaging the required sensory and electronics into battery and battery pack, avoids the need for the platform user to engage in the process of connecting and in some cases even instrumenting and testing the operation of the various added components, which would make it difficult for the user and the process prone to mistakes and may lead to hazardous operational conditions.

### SUMMARY

Methods and devices for direct and rapid heating of battery electrolyte at low temperatures and maintaining the battery temperature at its optimal performance level are disclosed. The technology has been extensively tested on a wide range of primary and secondary batteries at temperatures as low as −54° C. without causing any damage to the batteries. The technology is applicable to almost all primary and secondary batteries, such as Lithium-ion, Lithium-polymer, NiMH and lead-acid batteries. The technology is also applicable to super-capacitors and has been used to rapidly heat super-capacitors at temperatures as low as −54° C. without any damage.

The methods and devices are based on direct heating of the battery electrolyte using appropriately formed high frequency AC currents. The methods and devices take advantage of the electrical characteristics of the batteries and super-capacitors to heat the electrolyte directly and very rapidly to its optimal operating temperature without causing any damage.

The developed electrolyte heating units are externally powered at extremely low temperatures at which the battery is unable to provide a significant amount of power. Once the battery can provide enough power, the battery temperature may be raised to its optimal level and maintained at that level by power from the battery itself. The battery may be fully charged or discharged.

The developed electrolyte heating units are inherently highly efficient and safe and can be readily integrated into the battery safety and protection circuitry and battery chargers.

The following are some of the main characteristics of the disclosed methods and devices:
It requires no modification to the battery and super-capacitor.
The basic physics of the process and extensive tests clearly show no damage to the battery and super-capacitor.
The battery pack protection electronic units, such as those for Lithium-ion and Lithium-polymer batteries, can be modified to ensure continuous high-performance operation at low temperatures.
The battery electrolyte and super-capacitor is directly and uniformly heated, therefore bringing a very cold battery to its optimal operating temperature very rapidly and minimizing heat loss from the battery.
Direct electrolyte heating requires significantly less electrical energy than external heating such as with the use of heating blankets.
Standard sized Li-ion or Li-polymer batteries can be used instead of thin and flat battery stack packaging to accelerate external heating via heating blankets or the like.
The technology is simple to implement and low-cost.

The configuration and operation of the electrolyte heating units are described herein in detail and sample heating curves from −54° C. to 20° C. for Li-ion, Li-polymer and lead-acid batteries are presented and discussed.

It is appreciated that currently, one of the main challenges of using rechargeable batteries, such as Lithium-ion, Lithium-polymer, and other similar rechargeable batteries is the amount of relatively long time that it takes to fully charge them. This is particularly the case in Electric Vehicle (EV) and other electrically powered mobile platforms, such as trucks, lift-trucks, cranes, and the like platforms.

It is, therefore, highly desirable to have methods and devices that could be used to charge batteries, such as Lithium-ion, Lithium-polymer, and other similar rechargeable batteries, at significantly higher rates that are currently available and are generally below 1C rate, so that the batteries could be charged significantly faster that is currently possible without damaging the battery and significantly reducing their life cycle. Such battery “fast charging” capabilities would address one of the main challenges facing EV and electric truck, and other electric platform applications.

There is therefore a need for methods and devices for fast charging rechargeable batteries, i.e., charging them at rates that of over 2C-3C and even higher, without causing more damage than is currently limiting the life cycle of such batteries.

It would also be highly desirable if the developed “fast Charging” battery chargers to be provided with “fast charging” capability at low temperatures.

A need, therefore, exists for methods and systems for fast charging rechargeable batteries, such as Li-ion, Li-polymer, the so-called solid-state batteries, and the like, at rates of 2C-3C and higher, even up to 4C-6C, without causing damage to the battery and reducing its life and cycle life.

Accordingly, methods and systems are provided that can be used to charge rechargeable batteries, such as Li-ion, Li-polymer, the so-called solid-state batteries at rates that may exceed 2C-3C, without causing damage to the battery and reducing its life and cycle life.

It is appreciated that a very large number of battery chargers already exists and are being used to charge various rechargeable batteries, including Li-ion, which could be converted to fast-chargers without requiring any changes in the charger and in the devices and platforms, such as electric vehicles, trucks, lift-trucks, construction, material handling equipment, and the like, that would be using the fast-charger. It is therefore highly desirable to develop methods to “convert” existing battery chargers to “fast-chargers” capable of charging batteries at high rates, such as at rates that are at or over 2C-3C.

A need therefore exists for methods and systems that can “convert” existing battery chargers to “fast chargers” without requiring any changes in the charger and in the devices and platforms, such as electric vehicles, trucks, lift-trucks, construction, material handling equipment, and the like, that would be using the resulting fast-chargers.

Accordingly, methods and systems are provided that can be used to “convert” existing battery chargers to “fast chargers” without requiring any changes in the charger and in the devices and platforms, such as electric vehicles, trucks, lift-trucks, construction, material handling equipment, and the like, that would be using the resulting fast-chargers.

It is appreciated that in certain applications, such as in electric vehicles, trucks, various mobile platforms, and the like, it is highly desirable to have the disclosed high-frequency direct battery electrolyte heating capability incorporated into these platforms so that their batteries could be charged at any desired rate, including fast rates, using the available chargers.

A need therefore exists for methods and systems to incorporate the disclosed high-frequency direct battery electrolyte heating capability into various fixed or mobile platforms and devices, such as electric vehicles, trucks, various mobile platforms, and the like.

Accordingly, methods and systems are provided that can be used incorporate the disclosed high-frequency direct battery electrolyte heating capability into various fixed or mobile platforms and devices, such as electric vehicles, trucks, various mobile platforms, and the like.

It is appreciated that in certain applications, such as in electric vehicles, trucks, various mobile platforms, and the like, the high-frequency direct battery electrolyte heating capability disclosed in U.S. Pat. Nos. 10,063,076; 10,855,085; 11,211,809; 11,211,810; 11,594,908; and 12,074,301; U.S. Patent Application Publication Nos. 2020/0176998; 2021/0304972; 2021/0307113; 2022/0113750; 2023/03440292023/0359231 and 2024/0136616 and U.S. patent application Ser. No. 18/244,275, the entire contents of each of which are incorporated herein by reference, can be integrated into the battery packs to eliminate the need for the electrically powered platform user having to go through the process of making the proper connections and having to ensure that the added components and their wiring are properly protected from damage during platform operation, and also in many cases, avoid the need for the user to properly attach temperature sensors and the like to the battery and test for their proper operation, etc. With such battery and battery pack integrated high-frequency direct battery electrolyte heating capability, the user only needs to install the battery as it has usually been done for any battery or battery pack. It is also appreciated that such batteries and battery packs that are integrated with the high-frequency direct battery electrolyte heating capability can then be used by the platform user to directly replace existing batteries and battery packs.

A need therefore exists for methods and systems to incorporate the disclosed high-frequency direct battery electrolyte heating capability into various batteries and battery packs for use in various battery powered fixed or mobile platforms and devices, such as electric vehicles, trucks, various mobile platforms, back-up power sources, electrical energy storage systems, and the like.

Accordingly, methods and systems are provided that can be used to incorporate the disclosed high-frequency direct battery electrolyte heating capability into various batteries and battery packs for use in fixed or mobile platforms and devices, such as electric vehicles, trucks, various mobile platforms, back-up power sources, electrical energy storage systems, and the like.

It is appreciated that when external power sources, such as line power, is available to an electrically powered platform, which in general means that a platform is stationary or is positioned in a location with available power a certain source, such as an electrically powered vehicle being parked in an electrical charging station, then batteries and battery packs that are integrated with high-frequency direct battery electrolyte heating capability in such platforms must be provided with the means of connecting to the externally powered electrical charging systems and charging of the batteries and battery packs.

It is also appreciated that the external power may be from a generator provided in a “partially electrically powered” platform, such as a generator provided in a vehicle or other platforms that are also powered by generators that are driven by internal combustion engines or even solar or wind power.

A need therefore exists for methods and systems to develop batteries and battery packs with integrated high-frequency direct battery electrolyte heating capability that can be connected to externally powered electrical chargers for their charging.

Accordingly, methods are provided for the development of batteries and battery packs with integrated high-frequency direct battery electrolyte heating capability that can be connected to externally powered electrical chargers for their charging.

It is also appreciated that in general, it is highly desirable that the batteries and battery packs that are integrated with integrated high-frequency direct battery electrolyte heating capability be provided with the means of allowing the user to “bypass” or “disable” the integrated capability, which would preferably also allow the means of programming it range of operational temperatures, operational times, such as time to start and end operation, etc., to batch the platform operational schedule, environment, etc.

A need therefore also exists for methods for the design and fabrication of batteries and battery packs that are integrated with integrated high-frequency direct battery electrolyte heating capability and are provided with the means for the user of the platform that is powered by the battery or battery pack to program the operation of the integrated high-frequency direct battery electrolyte heating system in terms of various operational requirements, for example, the required temperature levels, heating rates, timing of the required start and end, and the like.

Accordingly, methods are provided for the development of batteries and battery packs with integrated high-frequency direct battery electrolyte heating capability that can be programmed by the user of the battery powered platform for its desired operation, such as the required temperature levels, heating rates, timing of the required start and end, and the like.

It is appreciated that when external power sources, such as line power, is not available to an electrically powered platform, which in general means that the electrically powered platform is in motion or is located where there is no external power source available, then the battery and battery pack integrated high-frequency heating systems must be provided with the capability of providing their battery electrolyte heating function using electrical power of the battery and battery pack, i.e., to operate in a self-heating mode.

A need therefore exists for methods and systems to develop batteries and battery packs with integrated high-frequency direct battery electrolyte heating capability that can provide their battery electrolyte heating function using electrical power of the battery and battery pack, i.e., to operate in a self-heating mode.

Accordingly, methods are provided for the development of batteries and battery packs with integrated high-frequency direct battery electrolyte heating capability that can provide their battery electrolyte heating function using electrical power of the battery and battery pack, i.e., to operate in a self-heating mode.

It is also appreciated that when external power sources, such as line power, is usually available to an electrically powered platform but once the electrically powered platform leaves the station at which external power is available, or if the external power is terminated for some reason at some point while the platform is still in the said station, then it is highly desirable that the battery and battery pack that is used to power the electrically powered platform be capable of “switching” from its “externally powered mode” to a aforementioned “self-powered” mode of operation.

A need therefore exists for methods and systems to develop batteries and battery packs with integrated high-frequency direct battery electrolyte heating capability that can be connected to externally powered electrical chargers for their heating and charging functions and when the external power becomes unavailable, then begin to function in their aforementioned self-powered mode.

Accordingly, methods are provided for the development of batteries and battery packs with integrated high-frequency direct battery electrolyte heating capability that can be connected to externally powered electrical chargers for their heating and charging functions and when the external power becomes unavailable, then begin to function in their aforementioned self-powered mode.

It is also appreciated that the above self-heating mode of the integrated high-frequency direct battery electrolyte heating capability is also used when an “external power source” onboard the electrically powered platform, such as by generators that are driven by internal combustion engines or by solar or wind power or the like, is provided, and is used for charging the battery or battery pack used for self-heating purposes.

It is also appreciated that since batteries and battery packs with integrated high-frequency direct battery heating capability are usually used to power systems that are provided with electrical and electronic and the like components and systems that may be adversely affected by high-frequency currents of the integrated heating system, therefore it is highly desirable that high-frequency current filtering capability be provided in the integrated high-frequency direct battery heating battery and battery pack units (system) so prevent any adverse effect on the system and operation of the electrically powered platform using such batteries and battery packs.

A need therefore exists for methods and systems to develop batteries and battery packs with integrated high-frequency direct battery electrolyte heating capability for use in electrically powered platforms and devices, such that the high-frequency current that is superimposed over the DC current that is provided by the battery and battery pack is filtered by an appropriate low-pass filter so that it would not adversely affect the operation of the electrical, electronic, and other components, devices and systems of the platform.

Accordingly, methods are provided for the development of batteries and battery packs with integrated high-frequency direct battery electrolyte heating capability for use in electrically powered platforms and devices, such that the high-frequency current that is superimposed over the DC current that is provided by the battery and battery pack is filtered by an appropriate low-pass filter so that it would not adversely affect the operation of the electrical, electronic, and other components, devices and systems of the platform.

“Battery capacity” is a measure (typically in Amp-hr) of the charge stored by the battery. The battery capacity represents the maximum amount of energy that can be extracted from the battery under certain specified conditions. However, the actual energy storage capabilities of the battery can vary significantly from the “nominal” rated capacity, as the battery capacity depends strongly on the age, past history of the battery, charging and discharging rates of the battery and the temperature.

The charging/discharging rates affect the rated battery capacity. If the battery is discharged very rapidly, i.e., if the battery discharge current is high, then the amount of energy that can be extracted from the battery is reduced and the battery capacity would be lower. The actual mechanisms that contribute to this capacity reduction is not well known, but it can be said that in general, it occurs since the components that are required for the required reactions to occur do not necessarily have enough time and/or energy to their required positions. Therefore, only a fraction of the total reactants is converted to other forms, and therefore the energy that becomes available is reduced. Alternately, if the battery is discharged/charged at a very slow rate using a low current, more energy can be extracted from the battery and the battery capacity is higher.

Therefore, the battery capacity should include the charging/discharging rates that they are defined at. A common way of specifying battery capacity is to provide the battery capacity as a function of the time in which it takes to fully discharge the battery, noting that in practice, batteries usually cannot be fully discharged.

The temperature of a battery will also affect the energy that can be extracted from it. At higher temperatures, the battery capacity is typically higher than at lower temperatures. However, intentionally elevating battery temperature is not an effective method to increase battery capacity as this also decreases battery lifetime.

A need therefore exists for methods and systems to reduce the level of reduction of battery capacity as it is charged at higher rates.

Accordingly, methods are provided for the development of systems that would allow battery charging at higher rates with reduced loss of battery capacity.

A need also therefore exists for methods and systems to make available higher levels of battery capacity as the battery is discharged at higher rates.

Accordingly, methods are provided for the development of systems that would allow battery discharge at higher rates with reduced loss of battery capacity.

It is also appreciated that it is highly desirable to develop methods to integrate systems that allow battery charging/discharging with lower reduction in the battery capacity into batteries and battery packs so that the users can readily replace existing batteries and battery packs in their mobile and stationary platforms with such integrated battery and battery pack systems.

A need therefore exists for methods and systems to develop batteries and battery packs with integrated components that allow battery charging/discharging with lower reduction in the battery capacity into batteries and battery packs so that the users can readily replace existing batteries and battery packs in their mobile and stationary platforms with such integrated battery and battery pack systems.

Accordingly, methods are provided for the development of batteries and battery packs with integrated components that allow battery charging/discharging with lower reduction in the battery capacity into batteries and battery packs so that the users can readily replace existing batteries and battery packs in their mobile and stationary platforms with such integrated battery and battery pack systems.

It is also appreciated that it is highly desirable to have systems that would allow charging batteries and battery packs at low temperatures by providing the means of heating the batteries to their optimal charging temperature range and then charging them while maintaining their temperature at or close to their optimal charging temperature range, including at high charging rates (fast charging rates), and also provide the means of applying high-frequency with relatively low amplitude AC currents to the batteries and battery packs during charging as well or battery power, for the purpose of increasing battery life and increasing capacity at high charge/discharge rates.

A need therefore exists for methods and systems to provide battery and battery pack capability for their heating to a prescribed charging temperature range before charging and then charging them at higher charging rates and applying high-frequency and relatively low amplitude AC current to the battery and battery pack using external power or battery power to achieve larger capacity and improved life cycle.

Accordingly, methods are provided for the development of systems that would provide battery and battery pack capability for their heating to a prescribed charging temperature range before charging and then charging them at higher charging rates and applying high-frequency and relatively low amplitude AC current to the battery and battery pack using external power or battery power to achieve larger capacity and improved life cycle.

It is also appreciated that the environmental temperature is not always around the optimal charging and discharging temperature of the battery in fixed and mobile partially or fully electrically powered platforms. In fact, even in regions with moderate climate, the average environmental temperature is well below the optimal battery charging temperature of around 20 degrees C. for Lithium-ion batteries. For example, in New York state, the average temperature year around was under 15 degrees C., i.e., well below the optimal charging temperature range of around 20 degrees C. Now, noting that the life cycle of Lithium-ion batteries is decreased with temperature as shown in the plot of FIG. 2, at even 15 degrees C. the life cycle of the battery is significantly reduced as compared to temperatures in the range of 20-25 degrees C.

It is, therefore, highly desirable to have methods and systems that would enable batteries to be charged and discharged at temperatures that are below their corresponding optimal temperatures while their capacity and life cycle are minimally affected.

A need therefore exists for methods and systems that would enable batteries to be charged and discharged at temperatures that are below their optimal levels with minimal reduction in the battery capacity and life cycle.

Accordingly, methods are provided for the development of systems that would enable batteries to be charged and discharged at temperatures that are below their optimal levels with minimal reduction in the battery capacity and life cycle.

### BRIEF DESCRIPTION OF THE DRAWINGS

FIG. 1 illustrates the plot of relative capacity of commercial 18650 Li-ion batteries as a function of temperature.

FIG. 2 illustrates the plot of State of Health (SOH) of 18650 Li-ion batteries vs. number of cycles as a function of operating temperature.

FIG. 3 illustrates the liquid-solid phase diagram of EMC-EC. The closed dots represent measured data for three different solutions of LiPF6 in an EMC-EC solvent.

FIG. 4 illustrates an equivalent (lumped) circuit model of a battery that is subjected to a high-frequency AC current.

FIG. 5 illustrates an equivalent circuit model of a battery for high frequency heating at a given battery temperature.

FIG. 6: Illustrates the plot of the amplitude of the applied test AC voltage at the battery terminals as a function of frequency.

FIG. 7: Illustrates the plot of the amplitude of the applied test AC current at the battery terminals as a function of frequency.

FIG. 8 illustrates the plot of the amplitude ration of the voltage and current as a function of frequency.

FIG. 9 illustrates the plot of the phase angle (leading) between the voltage and current waveforms of FIGS. 6 and 7, respectively.

FIG. 10 illustrates the plot of heating rate at room temperature for the tested CR123A Li-ion battery as a function of heating current frequency with a fixed RMS current of 4 A.

FIG. 11 illustrates the plot of heating curves for the CR123 Li-ion battery by externally supplied power at 80 KHz at various AC current amplitudes.

FIG. 12 illustrates the plot of heating rate of the CR123 Li-ion battery with 80 kHz current of different amplitudes as measured and as predicted by the developed model, equation (11).

FIG. 13 illustrates the block diagram of a high-frequency current battery heating device that is powered by an external power source.

FIG. 13A illustrates the schematic of the high-frequency current battery heating circuit of the device of FIG. 13, which is powered by an external power source.

FIG. 14 illustrates the schematic of a high-frequency current battery heating circuit that is powered by the battery power for self-heating.

FIG. 15 illustrates the plot of high-frequency heating rate curves for a Li-ion CR123 battery from several low temperatures to room temperature using externally provided power source to power the heating circuit.

FIG. 16 illustrates the plot of the temperature of a Li-ion CR123 battery being self-heated in an extreme cold environment of −60° C. The plot of a companion Li-ion CR123 battery that is not heated is also provided.

FIG. 17 illustrates the plot of the temperature of a large Lead-acid battery as its temperature is maintained within a specified range with the high-frequency AC current battery electrolyte heating system of FIGS. 13A and 13B.

FIG. 18 illustrates the heating rate for a 12 V Type 29HM lead acid battery at room temperature with externally powered high-frequency AC current as a function of current frequency and applied current.

FIG. 19 illustrates a graph showing battery voltage as a function of frequency with battery current held constant at 20 A.

FIG. 20 illustrates a graph showing battery current as a function of frequency with battery voltage held constant at 50 mV.

FIG. 21 illustrates a graph showing battery frequency response.

FIG. 22 illustrates a graph showing measured heating rates for the Die Hard 12 V lead acid battery at constant currents.

FIG. 23 illustrates a Li-ion battery electrolyte AC voltage heating test set-up.

FIG. 24 illustrates a graph showing Plots of electrolyte heating of an 18650 Li-ion battery cell as measured by the battery surface temperature as a function of time.

FIG. 25 illustrates a block diagram of the rapid battery charging and high-frequency current battery electrolyte heating device system (“Fast-Charger System”) that is powered by an external power source for use to charge batteries at a prescribed rate, including at very high-rates and in cold temperatures.

FIG. 25A illustrates a block diagram of a fully “Integrated Battery Heater and Charger” shown in FIG. 25 with high-frequency current battery electrolyte heating device system (“Fast-Charger System”) that is powered by an external power source for use to charge batteries at a prescribed rate, including at very high-rates and in cold temperatures.

FIG. 26 illustrates a block diagram of a rapid battery charging and high-frequency current battery electrolyte heating device system (“Fast-Charger System”) that is powered by an external power source and constructed with an existing battery charger unit.

FIG. 27 illustrates a block diagram of the rapid battery charging and high-frequency current battery electrolyte heating device system (“Fast-Charger System”) that uses an adaptor to connect an available “Battery Charger” and a “Battery Heater/Ionic Exciter”, both externally powered, to the battery via provided connectors.

FIG. 28 illustrates a block diagram of a rapid battery charging and high-frequency current battery electrolyte heating device system (“Fast-Charger System”) with its “Battery Heater/Ionic Exciter” and related component having been incorporated into the electrically powered platform, which is then connected to an external charger for charging the platform battery.

FIG. 29 illustrates a block diagram of a modified “Platform Integrated Fast-Charging System” embodiment of FIG. 28 for providing battery self-powered heating when the battery charger is not connected to the platform and when it is not turned on to charge the battery.

FIG. 30 illustrates a block diagram of a rapid battery charging and high-frequency current battery electrolyte heating device system (“Fast-Charger System”) that is powered by the battery power and uses a battery charger for charging the battery.

FIG. 31 illustrates a block diagram of a battery or battery pack with integrated battery-powered (self-heating) high-frequency battery electrolyte heating capability, referred to as the “Integrated Self-Heating Battery”.

FIG. 32 illustrates the block diagram of the “Integrated Self-Heating Battery” of the embodiment of FIG. 31 that is provided with a separate battery charger connector.

FIG. 33 illustrates the block diagram of a battery or battery pack with integrated high-frequency battery electrolyte heating/ionic-excitation capability that can be powered by the battery as well as an external power source.

FIG. 34 illustrates the block diagram of a battery or battery pack with integrated high-frequency and low current AC ionic-exciter for reducing battery capacity reduction due to high charge and discharge rates.

FIG. 35 illustrates the block diagram of a system for high-frequency current heating batteries/battery-packs for optimal charging and powering electrically-powered platforms and increasing battery capacity and life cycle, referred to as the “Universal High-Frequency Battery Conditioning System” embodiment of the present invention.

FIG. 36 illustrates the block diagram of the system embodiment of FIG. 34 that is constructed as an integrated battery/battery-pack unit with battery-powered high-frequency battery conditioning units.

FIG. 37 illustrates the block diagram of the battery-integrated system embodiment of FIG. 36 with a separate charger connection.

FIG. 38 illustrates the block diagram of the “Universal High-Frequency Battery Conditioning System” embodiment of FIG. 35 with high-frequency AC current generators that may be powered by external sources.

FIG. 39 illustrates the block diagram of the “Battery with Integrated Universal Conditioner” embodiment of FIG. 36 with high-frequency AC current generators that may be powered by external sources.

### DETAILED DESCRIPTION

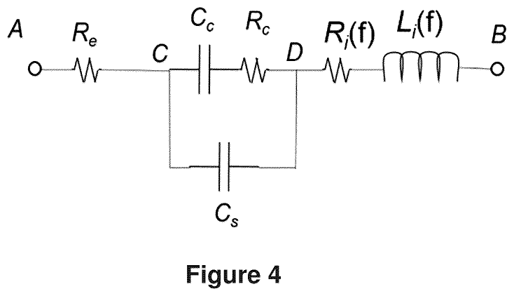

To describe the developed direct battery electrolyte heating technology, consider a Lithium-ion battery. The basic operation of the battery may be approximately modeled with the equivalent (lumped) circuitry shown in FIG. 4.

In this model, the resistor Rₑ is considered to be the electrical resistance against electrons from freely moving in conductive materials with which the electrodes and wiring are fabricated. The equivalent resistor Rᵢ and Lᵢ represent the resistance to free movement of Lithium ions by the battery electrolyte and equivalent inductance of the same, respectively. The capacitor Cₛ is the surface capacitance, which can store electric field energy between electrodes, acting like parallel plates of capacitors. The resistor R_{c} and capacitor Cc represent the electrical-chemical mechanism of the battery in which C_{c} is intended to indicate the electrical energy that is stored as chemical energy during the battery charging and that can be discharged back as electrical energy during the battery discharging, and R_{c} indicates the equivalent resistance in which part of the discharging electrical energy is consumed (lost) and essentially converted to heat. The terminals A and B indicate the terminals of the Lithium-ion battery.

In the Li-ion model of FIG. 4, the components Rᵢ, R_{c} and C_{c}, are highly sensitive to temperature. At low temperature, the resistance of the resistor Rᵢ increases due to the increase in the “viscous” resistance of the electrolyte to the movement of lithium ions. This increase in resistance causes higher losses during charging and discharging of the Li-ion battery. Low temperature charging passes (relatively high) currents through the indicated components R_{c} and C_{c} and it is well known that such low temperature charging results in so-called lithium plating, which is essentially irreversible, prevents battery charging and permanently damages the battery.

The operation of the Li-ion battery, as modeled in FIG. 4, may then be described as follows. If an AC current with high enough frequency is applied to the battery, due to the low impedance of the capacitor Cₛ, there will be no significant voltage drop across the capacitor, i.e., between the junctions C and D, and the circuit effectively behaves as if the capacitor Cₛ were shorted. As a result, the applied high frequency AC current essentially passes through the resistors Rₑ and Rᵢ and inductor Lᵢ and not through the Rₑ and C_{c} branch to damage the electrical-chemical components of the battery. Any residual current passing through the R_{c} and C_{c} branch would also not damage the battery due to its high frequency and zero DC component of the applied current. The high frequency AC current passing through the resistors Rₑ and Rᵢ and inductor Lᵢ will then heat the battery core, thereby increasing its temperature. If the high frequency AC current is applied for a long enough period, the battery core temperature will rise enough to make it safe to charge using the commonly used DC current charging methods.

It is appreciated that inductance Lᵢ in the model of FIG. 4 can only be assumed to be constant at relatively low passing AC current frequencies. This is the case since for a given AC current level, as the frequency of the passing current increases, the increase in the speed of the ionic “oscillatory” motions in the battery electrolyte would increase the heat loss across the modeled inductance Lᵢ in FIG. 4. This has been shown to be the case for Li-ion and lead-acid battery experiments, the results of one such experiment with a lead-acid battery is provided below.

In this experiment, a lead-acid battery voltage and current characteristics were measured over a frequency span range from 1 kHz to 70 kHz.

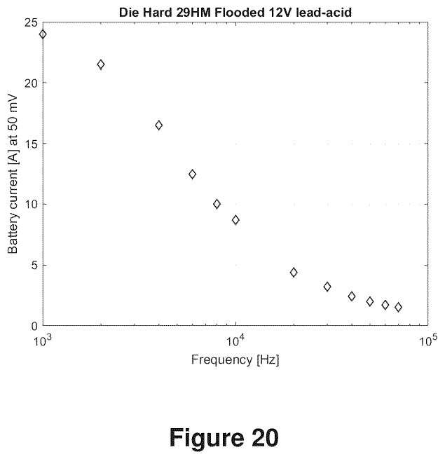

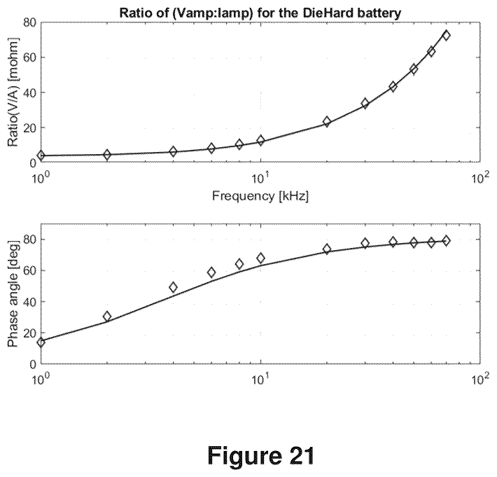

A 12 V flooded lead acid battery (Die Hard model #29-HM, m=27.1 kg and capacity=65 Ah) was used in this experiment. FIG. 19 shows the voltage response of the battery as a function of frequency at a constant current of 20 A and FIG. 20 is the current response at a constant voltage of 50 mV. In FIG. 20, the indicated voltage is its increase about the battery voltage of 12 V. Both current and voltage are measured at the battery terminals.

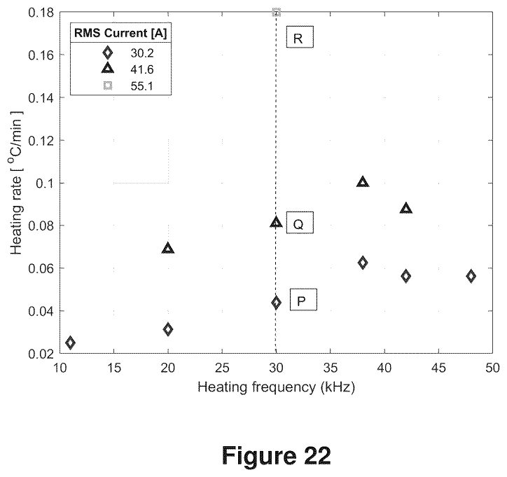

The measured voltage and current data of FIGS. 19 and 20 were then used to extract the amplitude ratio of the voltage and current and the phase angle (leading) between the measured voltage and current waveforms. The response obtained from both data sets (voltage vs. frequency and current vs. frequency) were identical and the plots from the constant voltage test are shown in FIG. 21.

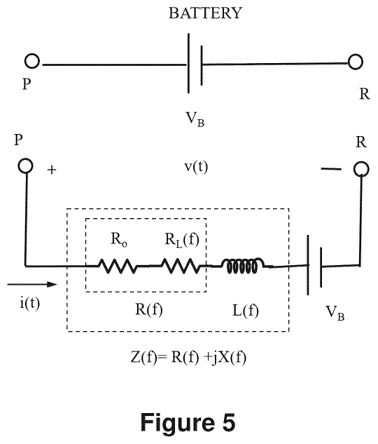

As can be seen in the plots of FIG. 21, as the frequency is increased, the phase shift is increased and approaches 90 degrees, which means that the battery is exhibiting the characteristics of an “inductive” element. However, as it is shown later in this section, when an AC current with a constant amplitude is applied to the battery, as the current frequency is increased, the amount of heat that is generated inside the battery is increased. This indicates that if we want to develop a model to represent the battery heating process due to high frequency current, the first order approximation of such a model should look as shown in the diagram of FIG. 5. It should be noted that terms such as “resistance” and “inductance” are borrowed from the electric circuit terminology for convenience.

In the model of FIG. 5, R₀ is the resistance component that is constant (possibly mostly due to the conductive components of the battery) and R_{L}(f) is the frequency dependent resistance component of the battery, which is due to the oscillatory motion of the ions inside the battery electrolyte. The frequency dependent resistance R_{L}(f) is therefore expected (and verified as shown later) to increase with frequency up to a certain frequency and begin to drop with further increase in the frequency.

Borrowing the terms “resistance” and “inductance” from the electric circuit terminology, the model of FIG. 5 includes a non-frequency dependent “resistor” Rₒ, and a frequency dependent “inductor” and a frequency dependent “resistor”. The battery “impedance” Z(f) is therefore given by

$$Z ( f ) = R ( f ) + jX ( f ) \qquad ( 1 )$$

Using the first order approximation, R(f) and X(f) can be expressed as,

$$R ( f ) = [ {R}_{0} + {P}_{1} f ] and X ( f ) = {P}_{2} f \qquad ( 2 )$$

where f is the frequency in Hz, R₀ is the resistance in mΩ, and P₁ and P₂ are constant coefficients with units [mΩ/Hz] and [mΩ/Hz], respectively, which are to be determined by fitting the data provided by the plots of FIG. 21. For the present battery, the resistance Rₒ was measured to be R₀=3.8 mΩ using the DC step method.

Referring to FIG. 5, the voltage v(t) and the current i(t) at the battery terminals are given by

$$v ( t ) = {V}_{o} cos ( 2 π ft + {θ}_{v} ) and i ( t ) = {I}_{o} cos ( 2 π ft + {θ}_{i} ) \qquad ( 3 )$$

where Vₒ and θᵥ are the amplitude and phase angle of the voltage and Iₒ and θᵢ are the amplitude and phase angle of the current waves, respectively. The DC voltage term corresponding to the battery voltage is excluded from the equation. Using phasor notation, the battery “impedance” Z(f) is expressed in terms of its magnitude and phase as

$$\vert Z ( f ) \vert = \sqrt{{R}^{2} ( f ) + {X}^{2} ( f )} = \sqrt{{( 3.8 + {P}_{1} f )}^{2} + {( {P}_{2} f )}^{2}} \qquad ( 4 )$$

$$Δ f [ deg ] = \frac{180}{π} {tan}^{- 1} [ \frac{X ( f )}{R ( f )} ] = \frac{180}{π} {tan}^{- 1} [ \frac{{P}_{2} f}{( 3.8 + {P}_{1} f )} ] \qquad ( 5 )$$

Either equation (4) or equation (5) can be used to obtain the unknown coefficients P₁ and P₂, for example, through a non-linear least squares curve fitting technique. Using equation (5) for fitting to the phase data in FIG. 21, the unknown coefficients are calculated as P₁=0.155×10⁻³ mΩ/Hz and P₂=1.05×10⁻³ mΩ/Hz. The solid line shows the fit obtained. These recovered parameters P₁ and P₂ were used to obtain the solid line in the (V/I) ratio (i.e., |Z(f)|) plot of FIG. 21.

During heating, the RMS current I, flowing through the frequency dependent “resistor” R(f) of the battery generates heat due to the absorbed power I²R(f). The absorbed power, indicated as P(f, I), can then be expressed as

$$\begin{matrix}P ( f , I ) = {I}^{2} R ( f ) = {I}^{2} [ 3.8 + {P}_{1} f ] \times {10}^{3} [ W ] \\ where R ( f ) = ( {R}_{0} + {P}_{1} f ) and {R}_{0} = 3.8 \times {10}^{- 3} Ohm .\end{matrix} \qquad ( 6 )$$

This absorbed power raises the temperature of the battery based on its mass m (kg), specific heat capacity Cₚ (J·kg⁻¹·° C.⁻¹) and duration t(s). The increase in temperature DT (° C.) is given by

$$Δ T = \frac{P ( f , I ) t}{{C}_{p} m} \qquad ( 7 )$$

Now defining β as expressed in equation (8) and replacing the above values for m and Cₚ for the present battery, we get

$$β = \frac{{mC}_{P}}{60} = \frac{( 2 7.1 kg ) ( 7 27.1 {Jkg}_{\cdot }^{- 1 o} {C}^{- 1} )}{60} = 328.5 W / ( {°C}^{- 1} / min ) \qquad ( 8 )$$

The heating rate HR (° C./min) is then obtained by dividing equation (7) by time (which is now in minutes) and using β as expressed in equation (8) to get

$$HR ( f , I ) = \frac{Δ T}{t} = \frac{1}{β} {I}^{2} [ {R}_{o} + {P}_{1} f ] [ °C . / min ] \qquad ( 9 )$$

Now substituting the values of R₀, P₁ and β into equation (9), the heating rate for the tested battery becomes

$$HR ( f , I ) = 3.04 \times {10}^{- 6} [ 3.8 + 0.155 \times {10}^{- 3} f ] {I}^{2} [ °C . / min ] \qquad ( 10 )$$

where f is in Hz and I is the rms current in A.

It should be noted that the heating model expressed in equation (10) is derived from the battery characterization using sinusoidal current and voltage waveforms.

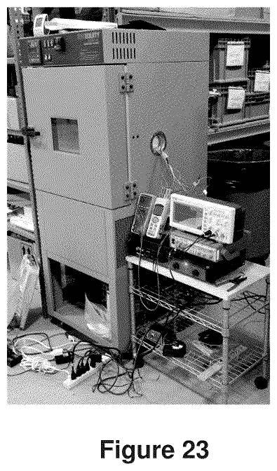

To verify the high frequency heating model shown in FIG. 5 and the derived heating rate equation (10), heating measurements were performed on the 12 V flooded lead acid battery using the high frequency heating system that applies a prescribed AC current with a selected frequency. Measurements were performed on the uninsulated battery at room temperature. At constant heating currents, the internal temperature of the battery (monitored by a thermocouple mounted in the electrolyte) was recorded over a time duration of 10 mins to 16 mins. The heating rate HR (° C./min) was obtained from the temperature difference at the start and end of the test. FIG. 22 shows the plot of the heating rate as a function of frequency for the indicated AC currents.

The equation (10) is then used to calculate the heating rates at the currents of points P, Q and R, FIG. 5, i.e., at 30.2, 41.6 and 55.1 A, respectively, and compare the results with the measured values at those points.

At point P, FIG. 22, the measured heating rate is 0.044° C./min with I=30.2 A and f=30 kHz. From equation (10) and including the required scaling factor of \sqrt{3} (for the triangular shaped applied current at frequencies above 10 KHz), the heating rate is calculated to be 0.041° C./min as shown below.

$$HR ( f , I ) = \sqrt{3} \times 3.04 \times {10}^{- 6} [ 3.8 + 0.155 \times {10}^{- 3} f ] {( 30.2 )}^{2} = 0.0 \; 41 [ °C . / min ]$$

The measured heating rates at points Q and R in FIG. 22 are 0.10° C./min with I=41.6 A and 0.18° C./min with I=55.1 A, respectively, at the current frequency of f=30 kHz. The corresponding calculated heating rates were then similarly obtained using equation (10) as 0.08° C./min and 0.14° C./min at points Q and R, respectively.

Considering the limitations of the above tests, the results clearly confirm the validity of the high frequency battery heating model of FIG. 5 and validate the use of high frequency currents to heat the battery from the inside. Within the range of currents used in the tests (30 A to 55 A); equation (10) is a good predicator of the heating rate for the flooded lead acid battery.

As an example of the presented high frequency heating method to Li-ion batteries, a single 18650 Li-ion battery cell was heated from different low temperatures to 20° C. using a high frequency AC heating circuitry.

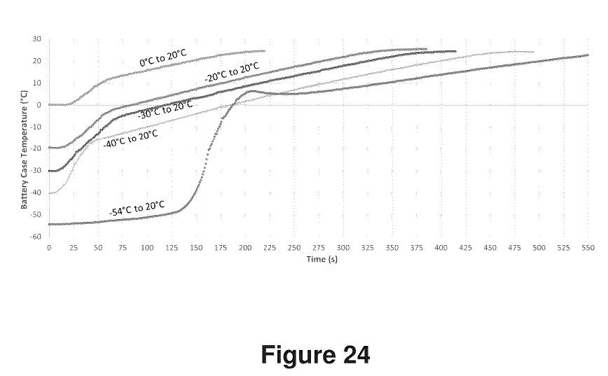

The battery was wrapped in a layer of 0.25″ thick ceramic Fiberfrax insulation and kept in an environmental chamber, which was kept at the selected low temperature level during the test. Two thermocouples were used to measure the surface temperature of the battery during the test. The test set-up is shown in FIG. 23. The peak AC heating current was kept at 14 A and at a frequency of 10 KHz. It is noted that even the AC voltage of the high frequency signal used for heating the electrolyte can be significantly higher than the rated voltage of the battery.

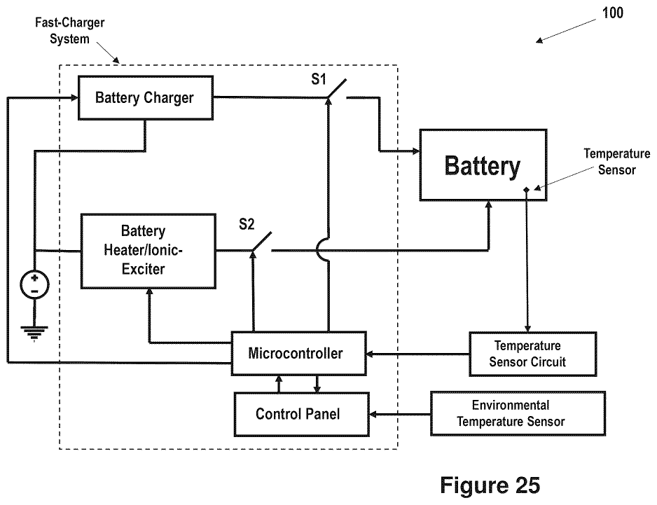

The plots of electrolyte heating as measured by the battery surface temperature as a function of time are shown in FIG. 24.

The methods and devices for direct and rapid heating of battery electrolyte at low temperatures and maintaining the battery temperature at its optimal performance level has been extensively tested on a wide range of primary and secondary batteries at temperatures as low as −54 deg. C. without causing any damage to the batteries. The technology is applicable to almost all primary and secondary batteries, such as Lithium-ion, Lithium-polymer, NiMH and lead-acid batteries. The technology is also applicable to super-capacitors and has been used to rapidly heat super-capacitors at temperatures as low as −54 deg. C. without any damage.

The technology is based primarily on the identified frequency dependence of the response of batteries to AC current. Based on the findings of the above studies, a more representative model of batteries that are subjected to high frequency current has been developed and validated experimentally. Similar tests that are presented for a lead-acid battery has also been performed on Li-ion batteries with similar results, confirming that the source of the frequency dependent “resistance” shown in the developed model should be the ionic oscillatory motion in the electrolyte.

The present highly innovative high-frequency AC current direct electrolyte heating technology is based on in-depth studies that were carried by the inventor of the highly nonlinear dynamic behavior of the battery electrolyte components when subjected to a high-frequency electric field, which results in generation of heat in the battery electrolyte. Based on the results of these studies, a model is developed that describes battery electrolyte heating rate, i.e., the high-frequency direct heating of a battery electrolyte, as a function of the electrolyte temperature, AC current (RMS) magnitude, and frequency. The model is also applicable to high-frequency AC current heating of supercapacitors. It is noted that the applied AC current of the is generally desired to be symmetric, i.e., have no or negligible DC component.

In the present direct electrolyte heating technology, the applied high-frequency AC currents are generally in the range of 50-120 KHz for Lithium-ion and Lithium-Polymer and 10-50 KHz for Lead-Acid batteries, similarly high for other rechargeable and primary batteries, including thermal reserve and liquid reserve batteries, and 1-2 MHz for super-capacitors.

It is appreciated by those skilled in the art that the use of AC heating signals of up to around 1 KHz has been referred to as “high-frequency” in some battery heating discussions found in the published literature. In the present direct electrolyte heating technology, the term “high-frequency” refers to frequencies that are well above frequencies (around 1 KHz) that have been used and analyzed using linear electrical models to determine the maximum resistive battery heating rates. Historically, there has been considerable interest in the electrical properties of batteries around 1 kHz. Around this range of frequencies, the battery appears inductive above and capacitive below some resonance frequency. These frequency dependent effects are characterized by the modified Randles equivalent battery circuit model (see for example: Randles, J. E. B. (1947). “Kinetics of rapid electrode reactions”. Discussions of the Faraday Society. 1: 11. doi:10.1039/df9470100011. ISSN 0366-9033, and A. Lasia, A., Electrochemical impedance spectroscopy and its applications. In: Modern Aspects of Electrochemistry. Volume 32. Kluwer Academic/Plenum Pub. 1999, Ch. 2, p. 143), which is valid for frequencies of up to around 1 kHz. The model is not valid at higher frequencies used in the present technology since it does not include the components related to the highly nonlinear dynamic behavior of the battery electrolyte, which is related to the highly nonlinear dynamic behavior of ionic oscillatory motions in the battery electrolyte. As it is described later in this disclosure, the high-frequency ionic oscillatory motion inside the battery electrolyte results in a high rate of the battery electrolyte heating, which at a given temperature and AC current level, increases with frequency to a peak level and begins to drop with increased frequency. At these high AC current frequencies, the heating rate is shown to be nearly proportional to the square of the applied RMS current.

As an example, in the disclosed direct electrolyte heating technology, at room temperature, the applied high-frequency AC currents are in the range of 50-120 KHz for Lithium-ion and Lithium-Polymer and 10-50 KHz for Lead-Acid batteries, and 1-2 MHz for super-capacitors.

It is also appreciated by those skilled in the art that the aforementioned commonly used linear electric circuit battery models would indicate negligible and close to zero net battery heating power at frequencies above around 1 KHz due to close to the resulting around 90 degrees phase shift between the applied current and voltage that such models would indicate.

It is also appreciated by those skilled in the art that some heating is inevitable due to low frequency (up to around the resonant frequency of around 1-2 KHz for most rechargeable batterie) and DC current flow through the internal resistance indicated by the aforementioned linear battery circuit models during charging and discharging as with the application of the so-called “mutual pulse heating”. The resultant heating processes due to such current flows are unavoidable, but their magnitudes are minimal as compared to the present high-frequency AC current heating, since batteries are designed to exhibit minimal internal resistance, particularly for use in cold environments.

The high-frequency electrolyte heating technology heats the battery electrolyte directly and uniformly with the least amount of electrical energy as compared to other currently available technologies, i.e., by external heating pads or blankets or the so-called “mutual pulse heating”, and by the provision of internal heating elements. The heating pads and blankets consume the most amount of energy since they must heat the entire battery mass, while overcoming heat loss from their outer surfaces. The heating pads and blankets are also thermodynamically inefficient as well as consuming the most amount of energy since they must heat the entire battery mass, while overcoming heat loss from their outer surfaces. The heating process is also slow since heat must be conducted into the battery core. The internally provided electrical heating members consume less energy than heating pads and blanket, but are relatively slow, since they also rely on heat conduction, and at very low temperatures, they require higher current rates, which could damage the battery due to hot spots. Batteries with internal heating members are more costly to produce and do not currently have enough market for large volume production.

The disclosed high-frequency AC current direct battery electrolyte heating technology may use either an external source of power or the battery's internal power to rapidly bring the electrolyte temperature to its optimal temperature and to maintain that temperature for the best possible battery charging and discharging performance and its cycle life. For instance, by operating Li-ion batteries within their optimal temperature range of 20-30° C., the battery cycling life is significantly improved, and maximum amount of stored energy and current becomes available for powering electrical equipment.

The technology has been extensively tested on Li-ion, Li-polymer, Lead-Acid, NiMH, and many other battery chemistries, and super-capacitors without causing any damage. The technology is implemented without making any modifications to the battery and can bring batteries to their optimal operating and charging temperatures at environmental temperatures that could be as low as −60° C. without any damage.

The disclosed high-frequency AC current direct electrolyte heating technology is inherently highly efficient and safe and can be readily integrated into any battery safety and protection circuitry and readily integrated into battery chargers. The following are some of the main characteristics of the proposed technology:
It requires no modification to the battery.
The basic physics of the process and extensive tests clearly show that the high-frequency direct electrolyte heating would not damage or reduce battery life cycle. In fact, by using and charging batteries at their optimal temperature, their cycle life is significantly increased, and maximum amount of stored energy and current becomes available.
The high-frequency electrolyte heating circuit may either be powered by external sources or use the battery power for self-heating to maintain its core temperature at the optimal level.
The battery pack protection electronic units, such as those for Lithium-ion and Lithium-polymer batteries, can be readily modified to ensure continuous high-performance charging and operation at low temperatures.
The battery electrolyte is directly and uniformly heated, therefore bringing a very cold battery to its optimal operating temperature very rapidly and minimizing heat loss from the battery.
Direct electrolyte heating requires significantly less electrical energy than external heating with heating pads or blankets or by internally provided electrical heating members.
Standard sized Li-ion or Li-polymer batteries can be used instead of thin and flat battery stack packaging to accelerate external heating via heating blankets or the like.
The technology is simple, uses commonly used electronic components, can be packaged in small volumes, and is low-cost.

The performance of all batteries is degraded significantly at low temperatures. This is the case for both primary and rechargeable batteries. In addition, current Lithium-ion and Lithium-polymer battery technology does not allow battery charging at temperatures below 0° C. and charging at temperatures below their optimal level has been shown to reduce battery life cycle. In very cold environments in which the temperature could fall to −10° C., −20° C., and at times as low as −40° C. even lower, batteries can only provide a very small percentage of their stored energy and current, sometimes less than 5-10 percent and in some cases effectively none. For rechargeable batteries, particularly for high energy density batteries of interest in most applications, such as Li-ion and Li-polymer batteries, battery charging as well as operation at low and particularly at very low temperatures raises issues that if unsolved would prevent their use for powering many systems of interest.

Some of the main issues limiting the use of any chemical battery, particularly high-density rechargeable batteries, such as Li-ion or Li-polymer batteries, are briefly reviewed below, followed a description of currently available or under development technologies to address these issues and their shortcomings, followed by the description of how the disclosed high-frequency AC current direct battery electrolyte heating technology would address all the indicated issues for operating various battery-operated devices in cold and even extreme cold environments.

### a) Decreased Discharge Capacity of Li-ion Batteries at Low Temperature

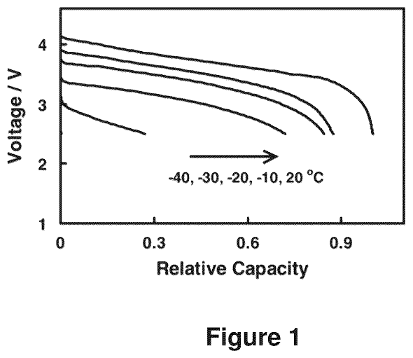

The discharge performance of Lithium-ion batteries is significantly decreased as the temperature falls below −10° C., as shown in FIG. 1. For example, at −40° C., commercial 18650 Li-ion batteries can only deliver 5% of the energy density, and 1.25% of the power density than at 20° C. (G. Nagasubramanian, “Electrical characteristics of 18650 Li-ion cells at low temperatures,” Journal of Applied Electrochemistry, vol. 31, pp. 99-104, 2001). This also applies to Li-polymer and other similarly designed batteries. The decrease in the ionic conductivity of the electrolyte and the solid electrolyte interface (SEI) layer; and the limited diffusivity of Lithium ions within the graphite anode electrodes are not the only contributors to the poor low temperature performance. In fact, when the temperature falls below −10° C., the dominant component is the slow kinetics of the battery reactions (S. S. Zhang, K. Xu and T. R. Jow, “The low temperature performance of Li-ion batteries,” Journal of Power Sources, vol. 115, pp. 137-140, 2003). Therefore, solutions that call for the use of more ionically conductive electrolytes, or additives to improve the anode electrode conductivity to improve low temperature performance are not good enough solutions at very low temperatures. The thermodynamics of the Lithium ions intercalation/de-intercalation process and the kinetics of the redox reactions ultimately determine the maximum possible discharge capacity of a lithium-ion battery at low temperatures.

### b) Low Temperature Charging

Charging a standard Li-ion and Li-polymer and other similar batteries below 0° C. must always be avoided. During the charging process, the low temperature causes the negative electrode's lattice to contract, leaving insufficient space for lithium ions to intercalate. In addition, the charge transfer and solid-phase diffusion processes slow down significantly at low temperatures. This results in the formation of lithium metal deposits (e.g., Lithium plating) on the surface of the negative electrode. The formation of lithium metal deposits causes irreversible loss of battery capacity since this fixed lithium is not available any longer during the discharge step. The larger the charging current, the more severe the damage to the electrode structure, and the faster the battery loses irreversible capacity. Further, the non-homogeneous growth of lithium metal deposits can easily form lithium dendrites that can grow large enough to puncture through the polymeric separator and short the battery, causing internal hot spots and potential for a fire or explosion of the battery.

c) Accelerated Aging when Li-ion Batteries are Cycled in Low Temperature Conditions

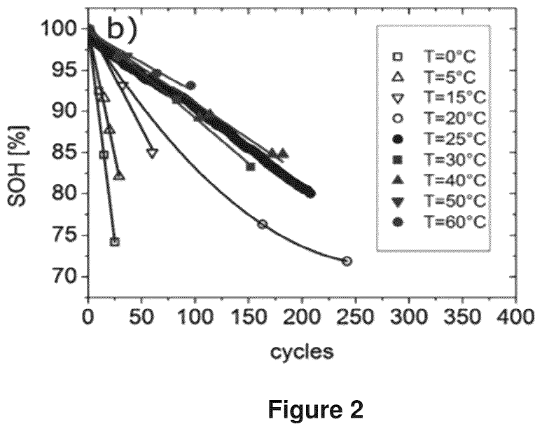

It has been widely reported (for example, Waldman, T, M. Kasper, M. Wilka, M. Fleischammer and M. Wohlfahrt, “Temperature dependent aging mechanisms in Lithium-ion batteries—A Post-Mortem study,” Journal of Power Sources, vol. 262, pp. 129-135, 2014), that commercial 18650-type Li-ion batteries age significantly faster when they are operated in low temperature conditions. FIG. 2 illustrates the effect of temperature on the number of charge/discharge cycles before the state of health (SOH) of the battery drops below 80%. The aging rate increases exponentially (Arrhenius dependency) with a drop in temperature. For example, if a battery is continuously operated at 5° C., the number of cycles before it reaches an 80% SOH is only 10% than if the battery is operated at 25° C.

### d) Electrolyte Freezing at Ultra Low Temperature

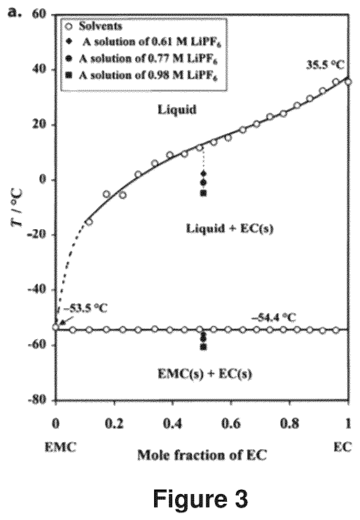

The standard Li-ion battery electrolyte comprises mixtures of two liquid organic carbonates (e.g., 50% mol fraction of ethylene carbonate EC, 50% mol fraction of ethyl methyl carbonate, EMC), and a Lithium salt (e.g., Lithium hexafluoro phosphate, LiPF₆). On their own, EC and EMC freeze at 35.5° C., and at −53.5° C., respectively. FIG. 3 shows the liquidus point of mixtures of EC+EMC (M. S. Ding, X. Kang and R. Jow, “Liquid-Solid Phase Diagrams of Binary Carbonates for Lithium Batteries,” Journal of the Electrochemical Society, vol. 147, no. 5, pp. 1688-1694, 2000). The liquidus point of a 50% vol. EC/EMC mixture is around 10° C. The addition of 1M LiPF₆ Lithium salt depresses the liquidus point down to −10° C. In fact, this is the recommended low temperature usable range of lithium-ion batteries, because if the temperature is dropped below the liquidus point, the first solids of electrolyte start to appear. As the temperature is further decreased, more and more solids form until the entire electrolyte volume freezes solid below −60° C. If the temperature is increased, battery capacity is recovered as the electrolyte remelts. However, small amounts of the Lithium salt LiPF₆ might remain undissolved in the liquid electrolyte. Thus, with every freezing-thawing cycle, the battery loses some capacity as more and more LiFP6 salt remains undissolved. Therefore, if a battery is regularly exposed to very low temperatures, even without being used, it will eventually lose all capacity.

The currently available or under development technologies to address the above issues and their shortcomings are described below.

### Review of Currently Available Battery Heating Technology

The only currently available technology for heating batteries in cold temperature environments so that they can be charged without battery damage and be conditioned to effectively provide their stored energy and current to power various battery-operated devices in cold environments are: (1) “self-internal heating”, in which the hattery is heated through internal resistance of the battery. The so-called “mutual pulse heating” is also in this category since it also heats the battery through its internal resistance, even though the heating current is supplied by the paired batteries; (2) heating batteries by externally generated heat, such as by heating pads or heating blankets, or convective heating by blowing heated air through the battery pack or the like; (3) heating batteries via internally provided electrical heating members, which are powered by either external sources or by the battery power.

### Shortcomings of Currently Available Battery Heating Methods for Cold Environments

The above basic categories of battery heating methods have shortcomings that make them impractical and/or undesirable for a wide range of systems and devices for operation in cold environments, in particular operation in extreme cold environments. These shortcomings may be described briefly as follows:

### 1) Self-Internal Heating:

In these methods, the battery is heated through internal resistance of the battery. In operation in cold and particularly in extreme cold environments, even when the load is using the maximum available current, the amount of generated heat is not enough to keep the battery warm, and its temperature would rapidly drop as the battery temperature drops followed by available current drop in a vicious cycle that would quickly lead to the lack of enough current to power the intended device. The only general option for heating through internal resistance would then be the use of the so-called “mutual pulse heating”, which for the very cold and extreme cold environment operation would require the application of very high (effectively DC) currents (using DC-DC converters) through the battery, which would damage the battery.

### 2) Heating by Externally Generated Heat:

In this method, heat is generated by externally positioned heating elements such as resistive heating coils, and used to heat the battery through conduction, for example by heating pads or blankets, or through convection, by blowing a hot medium such as air over the batteries. The power to generate heat may be from external sources or from the battery itself. Heat conduction inside the battery pack becomes the limiting factor due to the thickness of the battery cell and the insulating nature of the outer battery layers. This leads to a large temperature gradient inside the battery. As a result, these heating methods are not energy efficient and have slow heating rates. In addition, the heating pads and blankets and other heating components significantly increase the total occupied power source volume, and thereby also the amount of energy needed to keep the battery warm and compensate for the increased heat loss through the increased outside surfaces of the power source. In short, these methods are impractical and undesirable for a wide range of systems and device powering for cold environments and particularly for extreme cold environments.

### 3) Heating by Internally Provided Electrical Heating Members:

This method heats up the battery, by Joule heating, through the addition of internally provided electrical resistance heating elements within the battery. The heating power may be supplied by external sources or some of the internal battery power may be diverted through the resistance elements. However, for rapid heating rates that are required for operation in very cold environments, high current heating rates are required, which would create high overpotential. Therefore, heating during the charging step should be avoided to prevent plating of Li metal. Large temperature gradients and hot spots are possible, which can cause high temperature electrolyte degradation, off-gassing, and ultimately fire and explosion hazards.

### High-Frequency Battery Heating for Cold and Extreme Cold Environments

The disclosed developed model of a typical battery that represents the dynamic behavior of its electrolyte when subjected to high-frequency AC current was presented in FIG. 5. The process of battery electrolyte heating with the applied high-frequency AC current and its basic physics were also described. The battery heating rate, equation (9), was then derived through the formulation of the heating process using the battery model of FIG. 5, equations (1)-(6).

Here, another example of the application of high-frequency battery electrolyte heating is presented for a Li-ion battery. Actual tests performed to validate the developed model and the method used to determine the parameters of the model for a selected small Lithium-ion battery are then presented. Actual test results of the selected Lithium-ion battery heating at temperatures as low as −58° C. is also presented. The results of self-heating tests for keeping battery core temperature at room temperature in a −60° C. environment is also provided.

In this example, the high-frequency circuit model for battery heating of FIG. 5 and the derived heating rate equation (9) were validated again as described below using a Li-ion battery model RCR123A. This is a 3.7 V (800 mAh) cylindrical cell, which is 17 mm in diameter and 34.5 mm in length.

### Determining the Model Parameters

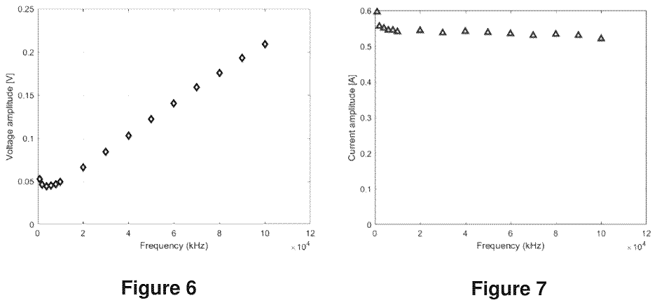

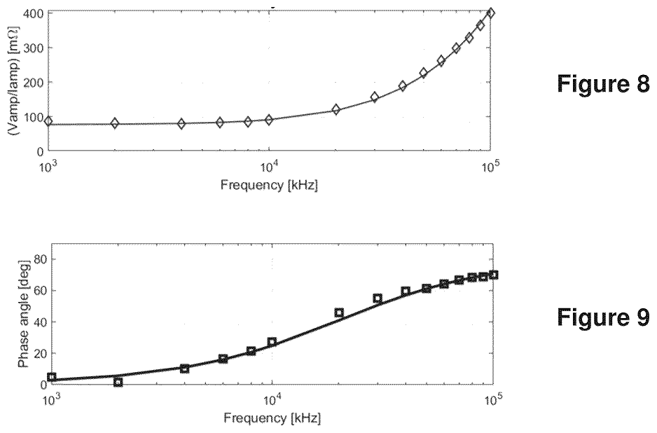

The frequency response of the above test battery at room temperature (20° C.) was characterized over a range of frequencies from 1 kHz to 100 kHz by driving the battery with a low amplitude AC sinusoidal current signal. Both the applied AC current and the corresponding AC voltage were measured at the applied frequency. The voltage and current data from the entire frequency scan was processed as was previously described to extract the ratio of the voltage to current amplitudes and the phase shift between the voltage and current waveforms. FIGS. 6 and 7 show the measured voltage and current amplitudes across the above frequency sweep, respectively.

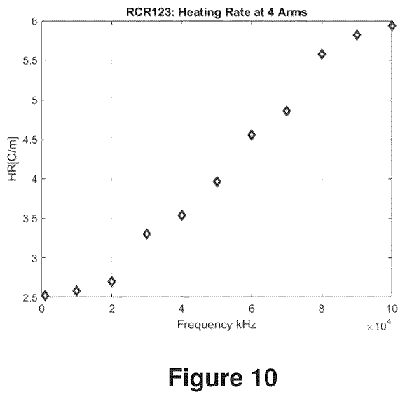

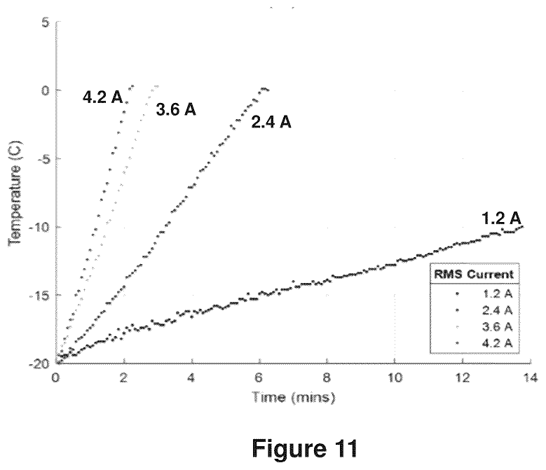

The voltage and current data of the plots of FIGS. 6 and 7 are then combined to extract the amplitude ratio of the voltage and current, which is plotted in FIG. 8. The phase angle (leading) between the voltage and current waveforms of FIG. 9 was extracted directly from voltage and current waveforms.

As can be seen in the plots of FIGS. 8 and 9, as the frequency is increased, the phase shift is increased and approaches 90 degrees, which means that the battery is exhibiting the characteristics of an equivalent non-ideal inductive element. This is exactly the behavior predicted by equations (4) and (5), which include an equivalent frequency dependent heating element R(f) and an ideal reactive inductance X(f) (=2πfL).

The data in FIGS. 8 and 9 is then combined to extract data of the corresponding R(f) and X(f). Using the corresponding models expressed in equation (2), unknown model coefficients P₀ and P₁ are extracted by fitting to R(f) data and coefficient P₂ is obtained by fitting to X(f) data. Subsequently, the unknown coefficients are found to be P₀=77.5 mΩ, P₁=5.863×10⁻⁴ mΩ/Hz and P₂=3.9×10⁻³ mΩ/Hz for the tested battery. The solid lines in FIGS. 8 and 9 show the fitted curves obtained using these parameters in equations (4) and (5). It is appreciated that the above parameters are for the battery at room temperature.

### Determining the Heat Rate HR(I,f)

At a given temperature, the frequency and current dependent heat rate equation (9) is then obtained for the tested RCR123 Li-ion battery by using the above model coefficients, combined with the knowledge of the physical characteristics of the tested battery. In the case of the tested RCR123A Li-ion, the mass m=0.018 kg and the specific heat capacity is Cₚ=800 J/(kg° C.). Using these values, the battery dependent parameter β, equation (8), becomes

$$β = {mC}_{P} = ( 0.0 \; 18 kg ) ( 800 {Jkg}_{\cdot }^{- 1 o} {C}^{- 1} ) = 14.4 J . {°C}^{- 1} \qquad ( 10 )$$

It should be noted that the value Cₚ is an approximation, based on range of values (700 to 900 J/(kg° C.)) found in the literature. Now substituting the values of P₀, P₁ and B into equation (9), the heating rate for the tested battery (RCR123) at room temperature is given as

$$HR ( f , I ) = 6.95 \times {10}^{- 5} [ 77.5 + 0.586 \times {10}^{- 3} f ] {I}^{2} [ °C . / s ] \qquad ( 11 )$$

where f is in Hz and I is the RMS current in A.

### Test Results for the RCR123A Battery

The experimental data reported below was acquired using the following facilities and equipment. All low temperatures tests were performed in the Test Equity Temperature Chamber Model #115A, AC battery current was measured using a Rogowski current probe (PEMUK CWT/15/B), and AC battery voltage was measured using a Keysight differential voltage probe (#N2791A). Battery temperature was measured using a J-Type thermocouple (#SRTC-TT-K-20-36) and the temperature profile recorded using a DigiSense logger (#20250-03). As it was not possible to mount a thermocouple inside the test battery (RCR123A), it was mounted on the outer surface of the battery, midway along its length and insulated from the ambient convection heat transfer with a 3 mm thick patch of FiberFrax 3 mm sheet (produced by Unifrax Corporation).

The heating rate equation (11) was validated by performing measurements on Li-ion test battery RCR123A, which has a voltage of 3.7 V and capacity of 800 mAh. Other presented battery heating tests were also performed with the same type of battery.

At a given battery temperature, the heating rate equation (11) is proportional to both the square of the RMS value and the frequency of the AC heating current. These two dependencies were evaluated independently as described below.

### Heating Rate as a Function of the AC Current Frequency

To verify the frequency dependence of the heating rate as described by equation (11), measurements were performed on one of the aforementioned RCR123A batteries placed in the open room environment. AC heating current over a range of frequencies from 1 kHz to 100 kHz was injected into the battery at an RMS amplitude of 4 A at all frequencies. The battery temperature was measured before and after injecting the AC heating current for 90 s. The heating rate HR (° C./min) was obtained from the temperature difference at the start and end of the heating duration.

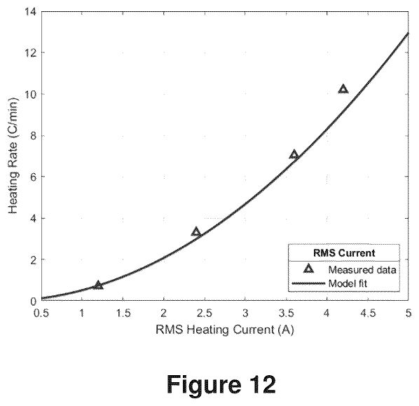

FIG. 10 shows a plot of the heating rate at room temperature of a RCR123A Li-ion battery as a function of the AC heating current frequency at a constant RMS value of 4 A.

FIG. 10 confirms that the heat generated by high-frequency AC currents in the battery electrolyte increases rapidly with increasing frequency. The heat generated due to the ion-ion and ion and electrolyte medium interactions, is a non-linear phenomenon, which reaches a peak value at some high frequency, and beyond that frequency the heat generation is seen to begin to decrease. This phenomenon has not been studied in electrolytes and is expected to be due to the “gaps” generated between the ions and their charges and the electrolyte medium at high frequencies as the ions undergo oscillatory motion. The presence of a heating rate peak frequency is also shown in Lead-acid heating rate measurements as a function of frequency presented later in this disclosure.

For the RCR123 Li-ion batteries tested, this optimal heating frequency was around 80 kHz, whereas the measurements with 12 V Lead-acid batteries show an optimal heating frequency of ~40 kHz. The Lead-acid data is presented later in this disclosure.

The measured heating rate is close to 3.9° C./min, which is close to the estimated heating rate of around 5° C./min (7° C./min minus the measured heat loss rate of 2° C./min).

### Validation of the Developed Heating Rate Model:

For this test, the battery was wrapped in a FiberFrax 3 mm sheet insulation and placed in an insulated box and placed in the environment test chamber. This testing arrangement minimized heat loss from the battery during heating. The heating rate test was then performed at a frequency of 80 KHz and at four different RMS AC current levels.

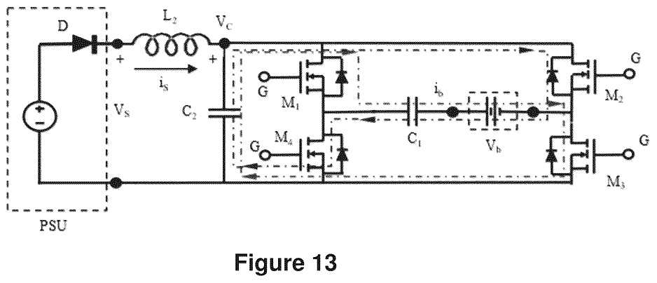

For each current level, the environment temperature was set to −20° C. and the battery was heated until the battery temperature reached 0° C. As the heating rate is nearly constant over the temperature of 0° C. to 20° C., the model parameters measured at room temperature could be used for the present model validation purposes. FIG. 11 shows the temperature profiles of the battery electrolyte temperature as a function of time for the four AC current amplitudes. The heating rates were calculated from the nearly linear heating profiles of FIG. 11.

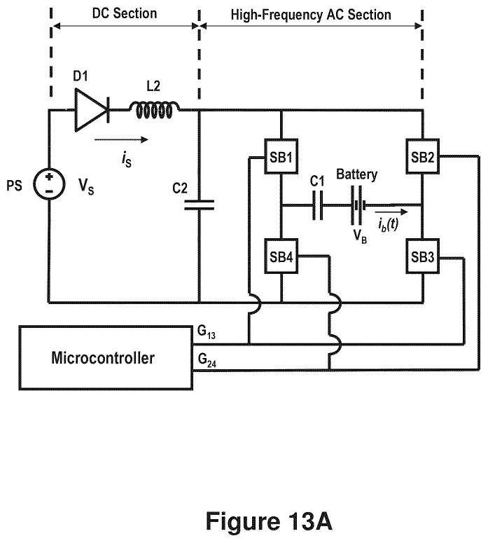

The heating rate data (symbols) as well as the heating rate calculated from the model (solid line), equation (11), are shown in the plot of FIG. 12. The measured data (symbols) is observed to show very good agreement with the predicted (solid line) heating rate described by equation (11).

### High-Frequency Direct Battery Electrolyte Heating Device Powered by an External Power Source

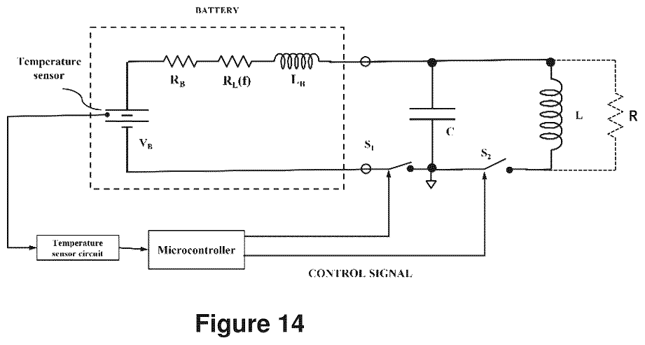

FIG. 13A shows a block diagram of a high-frequency current heating device, which is powered by an external single polarity DC power source. The circuit diagram of the device is shown in FIG. 13. This device is used for heating batteries, such as the present single cell RCR123A 3.7 V (800 mAh) Li-ion batteries as well as 36 V (850 Ah) Lead-acid batteries weighing 928 kg. It is noted that as it is described below, the high-frequency current being passed through the battery for electrolyte heating is symmetric, i.e., it has no net DC component.

The high-frequency heating current device of block diagram of FIG. 13A is powered by a DC power source PS. The flow of oscillatory high-frequency heating currents through the battery is provided by the MOSFET switch banks SB1, SB2, SB3 and SB4, which are controlled by the microcontroller.

Once the heating system is turned on, the current flows through the diode D1 and inductor L2 and charges the capacitor C2. The diode D1 and the inductor L2 are provided to prevent backflow of DC and high-frequency current into the power source. The high-frequency current is generated by the sequential opening and closing of the MOSFET switch banks SB1, SB2, SB3 and SB4 by the microcontroller as follows. By opening the switch banks SB2 and SB4, and closing the switch banks SB1 and SB3, the current i_{b}(t) flows from the capacitor C2 through the battery in the direction of the arrow shown in FIG. 13A. The microcontroller would then close the switch banks SB1 and SB3 and close the switch banks SB2 and SB4, thereby passing the current i_{b}(t) through the battery in the opposite direction. The DC link capacitor C2 is appropriately sized to meet the peak current demand of the high frequency heating circuit. The capacitor C1 is provided to achieve AC coupling with the battery and can be provided to have low capacitance.

The MOSFETs can be switched OFF/ON at or close to the zero crossings of the high frequency AC battery current. This would minimize their switching losses. Further improvements in circuit efficiency may be attained by using a parallel array of low ESR AC coupling capacitors (not shown).

A typical circuit diagram of the high-frequency current battery heating device with the block diagram of FIG. 13A is shown in FIG. 13. In the circuit of FIG. 13, the MOSFET switches M1, M3 and M2 and M4 correspond to the MOSFET switch banks SB1, SB2, SB3 and SB4, respectively. The wirings of the MOSFET switches M1, M3 and M2 and M4 and the microcontrollers are not shown for the sake of clarity. The high-frequency current battery heating device operates as it was described in the block diagram of FIG. 13A.

### High-Frequency Heating Circuit Powered by the Battery for “Self-Heating”

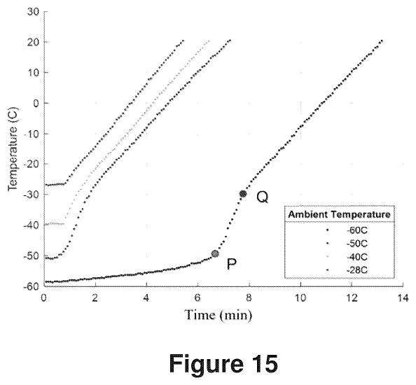

FIG. 14 shows the schematic of the novel basic high-frequency battery electrolyte self-heating circuit, which is used to describe the method of designing such novel high-frequency battery electrolyte heating devices that are powered by the battery itself. This circuit has been fabricated and used for self-heating battery electrolytes on many Li-ion and Lead-acid batteries, examples of these tests are provided below.

The high-frequency battery electrolyte self-heating circuit of FIG. 14 operates as follows. The “temperature sensor circuit” is used to monitor the battery temperature and provides the information to the system microcontroller, FIG. 14. Such temperature sensors are well known in the art. Then when the battery temperature reaches a prescribed threshold, which is usually set at different levels depending on the type, size, and operating conditions of the battery, then the microcontroller is programmed to start the process of heating the battery electrolyte.

Normally, the switches S1 and S₂, which are usually made with well-known MOSFET switch banks, are open. The electrolyte heating process is then started by the system microcontroller by closing the switch S1 and leaving the switch S2 open. During this phase, a series RLC circuit is formed by the internal equivalent electric circuit components of the previously described high-frequency model of the battery (in enclosed dashed lines) and the external capacitance C. The RLC circuit oscillates until the capacitor C reaches the battery voltage and the current flow ceases. The resulting oscillating high-frequency current passing through the battery, i.e., through the frequency dependent battery resistances R_{B} and R_{L}(f), produces heat in the battery electrolyte. Selection of the external capacitance is a trade-off between the peak current amplitude and the required resonant heating frequency. The former is proportional to the square root of the capacitance while the latter is inversely proportional to the square root of C. In some cases, an external inductor is required to be provided in series with the battery to satisfy the dual requirements of the peak current and the heating frequency.

To restart the heating cycle, the charged capacitor C must be discharged rapidly. Normally, this discharge can be performed by converting the energy by an external load resistor, such as the resistor R, FIG. 14, which is shown with dashed lines and can be provided in place of the inductor L and converting it to heat. However, wasted battery energy in the resistor R can be mostly recovered and used for battery heating using the following method.

In this method, to recover the wasted battery energy that is converted to heat by the resistor R, the energy is momentarily stored in another medium, in this case the inductor L, FIG. 14, and then used to excite the aforementioned RLC circuit and pass the indicated oscillatory high-frequency current through the battery. This is achieved as follows. Once the capacitor C reaches the battery voltage and the current flow ceases following closing the switch S₁ (switch S₂ being open), the system microcontroller, FIG. 14, closes the electronic switch S₂ and opens the electronic switch S₁. The electrical energy stored in the capacitor C is thereby allowed to oscillate between the capacitor C and the inductor L for one half cycle, when the inductor has returned the stored energy back to the capacitor C, but with opposite polarity, the electronic switch S₂ is closed and the electronic switch S₁ is opened by the microcontroller. The aforementioned RLC circuit would then oscillate until the capacitor C reaches the battery voltage and the current flow ceases. The resulting oscillating high-frequency current passing through the battery, i.e., through the frequency dependent battery resistances R_{B} and R_{L}(f), produces heat in the battery electrolyte.

### Examples of High-Frequency Li-Ion CR123 Battery in Various Cold Temperature Environments

In the following examples, the results of tests on the aforementioned Li-ion CR123 batteries using the high-frequency AC current battery heating circuits, FIGS. 13A, 13B, and 14 are presented. The tests are performed to confirm the efficacy of the present high-frequency AC current direct heating of battery electrolytes in cold as well as extreme cold environments. The batteries are placed in an environment chamber that was set to the desired low temperature and was left in the chamber for several hours to ensure that the entire battery body is at the set chamber temperature. The batteries were then heated with each one of the above circuits until their surface temperature was measured to be at room temperature level of 20° C.

### High-Frequency Heating of a Li-Ion CR123 Battery Using an External Power Source

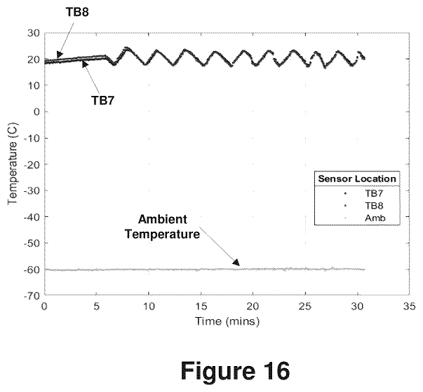

In these tests, a Li-ion CR123 battery was heated by high-frequency AC current, which is powered by an external source emulating the high-frequency heating circuit presented in FIGS. 13A and 13B, from the selected low temperatures until its surface temperature reached the room temperature level of 20° C. The tests were performed at starting environment chamber temperatures of −30° C., −40° C., −50° C., and −60° C. In each case, the battery was heated continuously using a high-frequency system comprising of a function generator, a linear amplifier, a step-down transformer, and a DC blocking capacitor until the battery electrolyte temperature reached 20° C. The temperature profile plots are shown in FIG. 15 and show very similar temperature response for all initial cold temperatures. At the extreme temperature environment of −60° C., the initial rise in battery temperature is slow until it reaches the point P, most likely due to the “frozen” electrolyte. Subsequently, following a “phase change” around −50° C. (P), the battery temperature begins to rise rapidly like the other three profiles. It is appreciated that in the latter case of the −60° C. initial battery temperature, the heating rate was limited by the ability of the heating circuit to source the required load current demand, which can be solved by allowing simple modification of the circuit to provide higher voltage levels until the battery temperature has reached around −50° C., i.e., point P. Beyond the point Q, the high frequency heating circuit would again operate in the current limit mode, sourcing ~4A.

### Maintaining a Li-Ion CR123 Battery at Room Temperature in a −60° C. Extreme Cold Environment

In this test, the test Li-ion CR123 battery was wrapped loosely with the aforementioned FiberFrax 3 mm sheet to eliminate convective heat transfer and placed in the temperature environment. The environmental temperature was dropped to −60° C. and the battery was heated periodically to maintain its core temperature between 18° C. and 20° C. using the same high-frequency battery heating method described for the heating rate tests of FIG. 15. To keep the battery temperature within the indicated 18° C. and 20° C. range, an average of around 92 J/minute was measured to have been supplied by the external power source.

### Maintaining the Battery Core at Room Temperature Using High-Frequency Self-Heating in Extreme Cold Environment of −60° C.

The self-heating feasibility test was performed on a serial connection of two CR123 Li-ion batteries, with an open circuit voltage of 8.3 V. During this test, the two batteries were connected in series for two reasons: (1) to demonstrate that battery heating is homogeneous even when the batteries are distributed, and (2) to enable the use of a self-heating test circuit developed for a 12 V battery. The two batteries were loosely insulated by wrapping them in a FiberFrax 3 mm sheet material and the self-heating test circuit. To determine the battery energy consumed in keeping the battery at a temperature of 20° C.±2° C., while the environment chamber was kept at −60° C., the two batteries were mounted in a holder and placed inside the environment chamber. Two separate thermocouples (marked as TB7 and TB8) were mounted on the surface of the two batteries to measure the temperature of each battery.

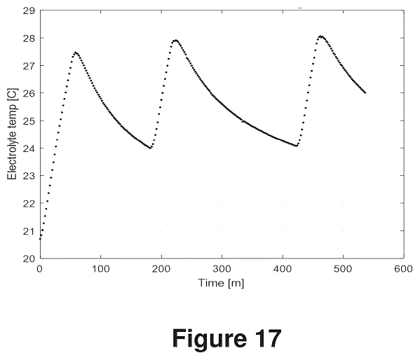

After installation in the environment chamber, the heating circuit described for the heating rate tests of FIG. 15 with externally provided power was used to keep the battery at 20° C. as the chamber temperature dropped to −60° C. Once the environment temperature reached the set point of −60° C., the externally powered heating was stopped, and the self-heating circuit of FIG. 14 was enabled (heat ON) at a battery temperature of 18° C. and disabled at a battery temperature of 22° C. FIG. 16 shows that the self-heating circuit was holding the battery temperature at 20° C.+/−2° C. FIG. 16 also shows that the output of the two battery temperature sensors (TB7 and TB8) are very close to each other, confirming that the two physically separated batteries are heated uniformly at the same rate.

This test clearly illustrates the capability of the disclosed embodiment to provide a simple self-heating circuit to keep battery core temperature at room temperature or any other appropriate temperature in a very cold environment. In the present test, the batteries were initially fully charged and after self-heating for 25 minutes, the batteries were taken out of the environment chamber and were allowed to warm up to room temperature. The remaining battery capacity was then measured under load at the standard discharge current of 800 mA to 3.0 V. Calculations then showed that the battery temperature could have been maintained at 20° C.+/−2° C. for around two hours via self-heating.

The above disclosed developed model of high-frequency current heating of battery electrolyte applies to all primary and rechargeable batteries, including thermal and liquid reserve batteries, and super-capacitors. The developed model was also validated experimentally. The model parameters are also shown to be readily determined from the experimental results for a given battery type and size. The results clearly shows that the developed high-frequency AC current direct electrolyte heating technology is fully capable of providing the means of keeping a battery temperature warm and within its optimal range to provide its maximum operating current and stored energy without any drop even at extremely low environmental temperatures that may reach −60° C. The power for the high-frequency heating circuit may be provided from external sources or from the battery itself.

The following are the main characteristics and advantages of using the developed high-frequency AC current technology for direct heating of battery electrolytes, particularly for integration into various systems, and for use in almost any environment in which the temperature drops below the battery optimal operation and charging for rechargeable batteries, for example, below around 17° C. for Li-ion and Li-polymer and the like batteries, and particularly operation in cold and extreme cold environments:
The high-frequency AC heating method acts directly on the electrolyte's ions, enabling fast heating of the entire liquid electrolyte volume inside the battery. The liquid electrolyte can then efficiently transfer heat to the rest of the internal battery components, such as electrodes, polymeric separator, and current collectors by thermal conduction. In this way, the heating occurs internally to the battery and very uniformly since the liquid electrolyte is everywhere, wetting all the internal elements of the battery. The result is a very uniform heating profile inside the battery with no hot spots or large thermal gradients, that could otherwise damage the liquid electrolyte or even start the thermal runway of the cathode electrodes.
The heating method does not require the modification or replacement of any internal components of the batteries, such as special low temperature electrolytes, new anode electrode materials, or others since it is implemented just through the addition of the external high AC frequency circuitry. Therefore, it is universally applicable to any existing primary and rechargeable battery, including Li-ion, Li-polymer, and so-called solid-state batteries and super-capacitors, any battery format and size as they are used in any existing system and device.
In extreme cold environments, wherein the electrolyte could completely freeze solid below −60° C., the imposed high frequency back-and-forth movement of the ions helps to completely redissolve the Lithium supporting salts back in the liquid electrolyte during the melting process. This will enable the batteries to be able to sustain multiple freezing-thawing cycles without losing discharge capacity.
The high frequency AC heating method is very energy efficient since almost all applied energy is used to heat up the electrolyte directly. Therefore, the amount of energy used from the battery to accomplish self-heating is minimum and only a small fraction of the battery capacity is used up in the process.
Internal temperature uniformity during heat up enables fast and precise feedback control with accurate temperature setpoint control. Controlling both charge and discharge temperature within an optimum narrow window maximizes battery cycle life.
The basic physics of the process and extensive tests clearly show that the high-frequency direct electrolyte heating would not damage or reduce battery life cycle. In fact, by using and charging batteries at their optimal temperature, their cycle life is significantly increased, and maximum amount of stored energy and current becomes available.
The high-frequency electrolyte heating circuit may either be powered by external sources or use the battery power for self-heating to maintain its core temperature at the optimal level.
The battery pack protection and management electronic units, such as the Battery Management Systems (BMS) for Lithium-ion and Lithium-polymer batteries, are generally not affected by the application of the high-frequency current, and can be readily modified to ensure continuous high-performance charging and operation at low temperatures.
Direct electrolyte heating requires significantly less electrical energy than external heating with heating pads or blankets or by internally provided electrical heating members.
Standard sized Li-ion or Li-polymer batteries can be used instead of thin and flat battery stack packaging to accelerate external heating via heating blankets or the like.
The technology is simple, uses commonly used electronic components, can be packaged in small volumes, and is low-cost.

In addition to the previously provided battery high-frequency AC current direct battery electrolyte heating test results, mainly on small CR123 LI-ion batteries for model validation and presentation of the method to determine model parameters through experimental measurement, two other results of tests of the applications of the high-frequency AC current direct battery electrolyte heating technology on a large Li-ion battery pack and a 928 kg Lead-acid battery pack used on lift trucks for operation in freezers at −25° C. are provided below.

### High-Frequency Heating of a Lead-Acid Battery (GNB M2701812515B) Used in Lift Trucks

A high-frequency AC current direct battery electrolyte heating circuit with the design shown in FIGS. 13A and 13B using an external DC power source is used to heat and maintain the battery electrolyte temperature in the range of 24° C. to 28° C. of a lift truck battery operating in a −25° C. freezer facility. The Lead-acid battery is 36 V with an 875 Ah capacity and weighs 928 kg.

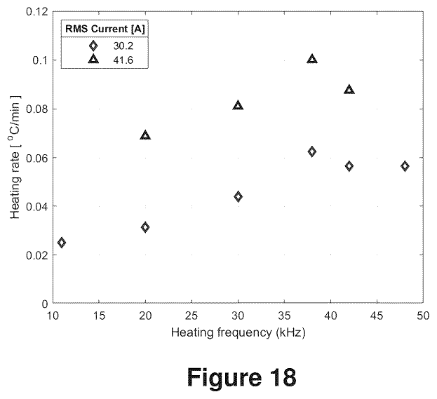

The high-frequency AC current direct battery electrolyte system was operated from a 6 V DC power source and heated at room temperature at a frequency of 30 kHz at an RMS current of 75 A. The heating was enabled when the battery temperature dropped to 24° C., and the heating was turned off when the battery reached 28° C. FIG. 17 shows the battery temperature profile over time. The measured heating rate was ~0.07° C./min.

### High-Frequency Heating of a Lead-Acid AGM Battery (ArmaSafe 6TAGM) Battery

A high-frequency AC current direct battery electrolyte self-heating circuit based on the circuit of FIG. 14 was used to heat a Lead-acid AGM battery (ArmaSafe 6TAGM). The battery was instrumented and together with the self-heating circuit board was placed in the environmental chamber. The battery temperature was maintained at −18° C. in the environment chamber temperature of −40° C. (a U.S. Army requirement for truck battery with the self-heating circuit). The high-frequency AC current direct electrolyte self-heating was used to maintain the battery temperature at −18° C. for 12 hrs. The battery was initially fully charged and after the 12 hrs test, the battery was discharged to determine the percent of the total energy used during the above 12 hr test, which indicated that 25% of the available battery stored energy was used during the 12 hr test. It was then concluded that using 50% of the available stored energy in a fully charged battery, its temperature could be maintained at −18° C. in a −40° C. environment for around 24 hrs.

### Heating Rate of a 12 V Type 29HM Lead Acid Battery at Different AC Current Frequencies

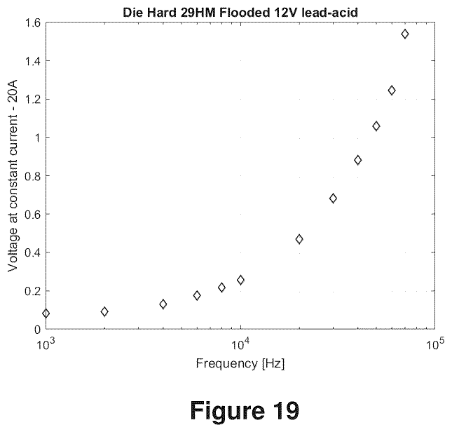

In this experiment, the objective was to verify the expected basic understanding of the physics of interaction between electrolyte ions and the electrolyte medium and between the ions, which is the mechanisms with which heat is generated when the ions are forced into high-frequency oscillatory motions. This heating mechanism suggests that the heating rate would increase with increased frequency—as was shown in the previously experimental results, but there should be a peak frequency for each battery type and size above which the heating rate would begin to drop. The reason for the drop is that above certain frequency, the high speed, and acceleration of the ions would form gaps between ions (similar to vacuum in fluids) and “impact” like interactions between the ions would reduce their number of such “impact” like interactions due to the generated gaps. Since this phenomenon can be seen at lower current frequencies in Lead-acid batteries due to the more liquid electrolyte, a 12 V Type 29HM lead acid battery was tested with constant RMS currents up to a frequency of 50 KHz. The result is shown in the plot of FIG. 18. As can be seen, a peak heating rate is reached around 37 KHz, after which the heating rate begins to drop. The same phenomenon is expected to be present in all battery electrolytes, including Li-ion batteries. Such tests are important for all batteries to determine the peak heating rate heating current frequencies when the heating rate is desired to be maximized.

It is appreciated that currently, one of the main challenges of using rechargeable batteries, such as Lithium-ion, Lithium-polymer, and other similar rechargeable batteries is the amount of relatively long time that it takes to fully charge them. This is particularly the case in Electric Vehicle (EV) and other electrically powered mobile platforms, such as trucks, lift-trucks, cranes, and the like platforms. It is, therefore, highly desirable to have methods and devices that could be used to charge batteries, such as Lithium-ion, Lithium-polymer, and other similar rechargeable batteries, at significantly higher rates that are currently available and are generally below 1C rate, so that the batteries could be charged significantly faster that is currently possible without damaging the battery and significantly reducing their cycle life.

To this end, it is highly desirable that such fast-charging methods and systems be capable of charging rechargeable batteries, such as Li-ion, Li-polymer, the so-called solid-state batteries, at rates that of over 2C-3C and even higher, without damage to the battery and reducing its cycle life. Such an innovative methods and systems are disclosed below.

In almost all rechargeable battery applications, there is a high demand for faster and faster charging rates, such as for Li-ion and other similar batteries and particularly for electric vehicles, trucks, buses, lift-trucks, and the like applications. The main problem with fast-charging, particularly at rates above 1C-3C, is lithium plating.

Research in various laboratories (e.g., Marco-Tulio F. Rodrigues et al., “Fast Charging of Li-Ion Cells: Part IV. Temperature Effects and “Safe Lines” to Avoid Lithium Plating,” 2020 J. Electrochem. Soc. 167 130508) have shown that by heating Li-ion batteries to a temperature that prevents lithium plating while limiting the growth of solid electrolyte interphase (SEI) that occurs at elevated temperatures would allow fast charging at rates that exceed 2C-3C and even up to 6C. One chosen battery charging temperature is 60° C. (140° F.), in which the battery is heated by heating elements for the duration of the charge and then cooled to about 24° C. (75° F.) with the onboard cooling system to limit the time the battery dwells at high heat. This process has been shown to enable charging of Li-ion battery at a C-rate of 6C to 80% SoC in 10 minutes.

It is appreciated that the effect of increasing the temperature of the battery electrolyte is to increase its ionic oscillatory kinetic energy. This increase in the ionic kinetic energy is responsible for the reduction in the probability of the ions to settle and collect on the surface of the battery anode under the applied DC current, i.e., to cause metal plating (in the case of Li-ion batteries, Lithium plating), which causes damage to the battery. The same oscillatory kinetic energy may be provided to the electrolyte ions, for example, the Lithium ions in the case of Li-ion batteries, by the application of the present high-frequency electric-field (i.e., the disclosed high-frequency current for battery electrolyte heating). As a result, batteries could be charged at very fast rates as was described for the case of heated batteries (for example to temperatures of around 60° C. (140° F.) for the case of Li-ion batteries), without causing battery damage (Lithium plating for the case of Li-ion batteries). In addition, damage due to the required heating of the battery to high temperatures (around 60° C. (140° F.) for the case of Li-ion batteries) and related safety issues are addressed.

It is appreciated that as it was previously described, the application of high-frequency currents to a battery causes heating of its electrolyte as expressed by equation (9). For the purpose of fast charging at high rates, the frequency of the applied current is generally selected such that the battery electrolyte temperature is not heated very rapidly, for example by selecting either lower frequencies with heating rates that would not raise the electrolyte temperature above a certain threshold while fast-charging, or by selecting significantly higher frequencies beyond the maximum heating rates, at which the heating rate would drop to an acceptable rate (as was previously described) as the battery being fast-charged. In general, fast-charging at high rates, e.g., at 3C-6C, brings the battery to 80% SoC in the order of around 10 minutes, a period of time that is not long enough to significantly increase the battery core temperature.

Thus, by integrating the disclosed high-frequency electric-field application capability (i.e., the disclosed high-frequency current for battery electrolyte heating) into the battery charger device, and superimposing a high-frequency current over the charging DC current, allows for fast-charging at high rates without battery damage due to plating (Lithium plating in the case of Li-ion batteries) similar fast-charging at high battery temperatures (e.g., around 60° C. (140° F.) for the case of Li-ion batteries), but without the damaging effects of high battery temperatures. Such integrated system embodiments of chargers with superimposing high-frequency current capability for fast-charging batteries at high rates are disclosed below.

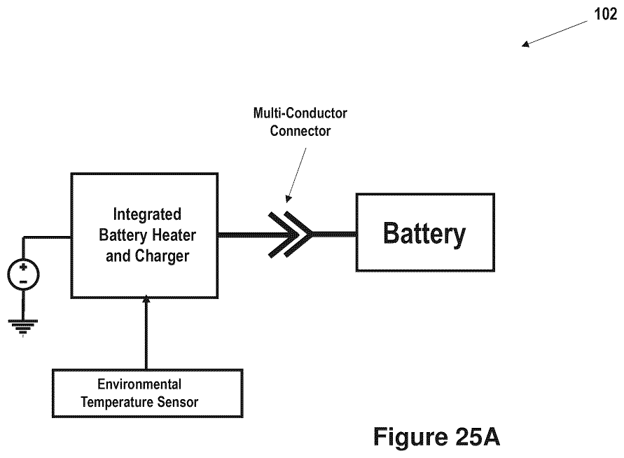

A block diagram of a rapid battery charging and high-frequency current battery electrolyte heating device system (hereinafter also referred to as the “Fast-Charger System”) embodiment 100 is shown in FIG. 25. The “Fast-Charger System” embodiment 100 of FIG. 25 is seen to be powered by an external power source. The “Fast-Charger System”) embodiment 100 of FIG. 25 is configured to charge batteries at a prescribed rate, including at very high-rates in any environmental temperatures that the battery may be used, including in cold temperatures.

The “Fast-Charger System” embodiment 100 of FIG. 25 comprises a “Battery Charger” component and a “Battery Heater/Ionic-Exciter” component, which are drawn as separate units in this illustration for the ease of system operation description but can be constructed as a single unit. The battery charger component is configured and constructed like any of the currently available high current chargers with the well-known safety and current, voltage, temperature, etc., controls. The “Battery Heater/Ionic-Exciter” component is of the previously disclosed high-frequency current battery electrolyte heating type, such the one shown in FIGS. 13A and 13.

It is appreciated that as it was previously described, for a given battery, the heating rate is increased with increased frequency of the applied current until it reaches a peak, and as the current frequency is increased further, the heating rate of the battery begins to drop. In the present “Fast-Charger System” embodiment 100 of FIG. 25, the “Battery Heater/Ionic-Exciter” component of the system is intended to operate in the following two different modes, a primarily heating mode, in which the current frequency is set at or close to its maximum heating rate, and a primarily ionic-excitation mode, in which the current frequency is generally set significantly above its maximum heating rate, when the primary purpose of the applied high-frequency current is to generate “ionic-excitation” of the electrolyte ions, thereby as was previously indicated, prevent damage to the battery by plating (e.g., Li plating in Li-ion batteries) with the application of high charging currents, such as 2C-3C or even higher.

It is appreciated by those skilled in the art that operation of the “Battery Heater/Ionic-Exciter” component in both of the above modes results in the battery electrolyte heating and generate ionic-excitation, which is the main source of battery electrolyte heating as was previously described. However, in the aforementioned battery heating mode (hereinafter referred to as “Battery Heating Mode”), the heating rate of the battery electrolyte is attempted to be maximized, while in the aforementioned “ionic excitation” mode (hereinafter referred to as “Battery Ionic-Excitation Mode”), the battery electrolyte heating rate is attempted to be minimized.

The operation of the fast-charger system 100 is controlled by a processor, such as a programmable microcontroller. The temperature of the battery being charged is measured by a provided temperature sensor, such as a well-known thermocouple or thermistor or the like, the output of which is provided to the microcontroller via an appropriate “temperature sensor circuit” shown in FIG. 25. A temperature sensor is also provided for measuring environmental temperature of the battery and provide the information to the system controller for setting an optimal process for the required battery charging and heating as described below. The system “Control Panel” provides the means for the user to turn the system on and off and set the operational requirements of the system, such as the operating temperature and its range, heating and charging rates, etc., examples of which are provided later in this disclosure.

The “Fast-Charger System” embodiment 100 of FIG. 25 operates as follows. When the system is turned on for the first time, the user will use the provided system means described below, to set the system parameters and select the provided operational options. The parameters to be provided include the battery type, size, and all other pertinent characteristic information; heating temperature threshold and its acceptable range; acceptable heating and charging rate ranges; desired charging rate according to the time of day and weekdays; the option of charging without heating (which may, for example, be selected in warm months of the year) or heating without charging (which, may be selected when heating is required to keep a charged battery warm when needed). It is appreciated that many or even all these parameters and options may be set by the equipment manufacturer or seller, particularly if it is purchased together with the equipment in which the battery is installed. In some applications, the system may be provided with a limited number of set of parameters preset options, for example for overnight charging and keeping or bringing the battery at its optimal temperature and fully charged by certain time in the morning for optimal operational performance and to maximize the battery life.

It is also appreciated by those skilled in the art that both of the above methods and means to input the required and desired charging and heating parameters and operational options (i.e., initializing the system) are well known in the art. Other well-known methods, such as factory setting of all the parameters and options for the user and providing minimal user input, usually buttons and/or switches, for the user interaction with the “Fast-Charger System”, such as on/off switch, emergency shut-down button, “Battery Heater/Ionic-Exciter” on/off switch, etc., may also be provided on the system control panel, FIG. 25.

It is appreciated that in the block diagram of FIG. 25, the switches S1 and S2 are intended to indicate the means with which the “Fast-Charger System” controller would connect/disconnect the “Battery Charger” and “Battery Heater/Ionic-Exciter” components, respectively, to/from the battery. It is appreciated by those skilled in the art that depending on the application and the size of the battery, the system designer may provide this capability by, e.g., terminating power supply to the “Battery Charger” and “Battery Heater/Ionic-Exciter” components, or provide the said switching actions within these component circuits.

Once the “Fast-Charger System” is initiated by setting all the required parameters and options as is described above, the user can turn the system on.

Once the “Fast-Charger System” is turned on, the software driven system microcontroller collects data as to the battery temperature and the battery environment temperature. The system controller is programmed to perform the following functions:
1—If the battery temperature is below a threshold that is safe for the battery to be charged, even with an applied system high-frequency current (as usually determined by the battery manufacturer), then the system controller would turn the “Battery Heater/Ionic-Exciter” on (in its “Battery Heating Mode”, when provided to the system) and keep the “Battery Charger” off. The battery temperature is then raised to the prescribed charging temperature threshold, and then the battery charger is turned on for charging at a prescribed high rate, while the “Battery Heater/Ionic-Exciter” is switched to its “Battery Ionic-Excitation Mode”.
2—The “Fast-Charger System” controller can be programmed to determine the optimal battery charging rate depending on the prescribed amount of time available for the battery to be fully (or partially) charged.
3—Once the battery is charged to the prescribed level, if the optimal temperature maintenance option has been selected by the user, the system controller would monitor the battery temperature and would turn the “Battery Heater/Ionic-Exciter” on in its “Battery Heating Mode” when the battery temperature drops below the prescribed threshold and turns it off when the battery temperature reaches its prescribed upper limit threshold.

In the above charging process, the described fast-charging protocol comprises passing a high-frequency current through the battery while performing fast-charging. Then if the battery temperature gets to a prescribed threshold level, then the high-frequency current is turned off, and the battery is charged at a low rate and if necessary, the charging is stopped until the battery has cooled down the prescribed temperature threshold. As the temperature goes up, the amplitude of high-frequency current may be reduced to reduce heating rate.

It is appreciated by those skilled in the art that the “Fast-Charger System” embodiment 100 of FIG. 25 may also operate in a slow charging mode, i.e., well below the charging rate of 1C, for example at a rate of 0.2C, when charging time is not an issue, for example when the battery is to be charged overnight. In such slow charging modes, the “Battery Heating Mode” is also used when the battery temperature is below its optimal charging temperature, to bring the charged battery temperature to its optimal operating temperature at the prescribed time for the user, and to minimize battery life reduction by charging the battery at its optimal charging temperature. In addition, the “Battery Heater/Ionic-Exciter” may also be used in its “Battery Ionic-Excitation Mode” to reduce/eliminate any potential plating damage to the battery.

It is appreciated that as it was indicated previously, the applied high-frequency current allows for battery charging at high-rates that may be over 2C-3C at lower temperatures without causing damage (plating), such as Lithium plating in Li-ion batteries.

It is appreciated by those skilled in the art that in many applications, it is highly desirable to have a fully integrated “Fast-Charger System”, in which all components of the “Fast-Charger System” embodiment 100 of FIG. 25, including its “Battery Charger”, “Battery Heater/Ionic Exciter”, “microcontroller”, and battery and environmental temperature sensory electronics, are assembled into a single unit with a single “control Panel” for input and operation by the system user interface, that is connected and disconnected to the intended battery powered system or battery-based power storage system or the like via a provided connector and wiring. Such a fully integrated “Fast-Charger System” embodiment 102 is shown in the schematic of FIG. 25A.

In the fully integrated “Fast-Charger System” embodiment 102 (hereinafter referred to as the “Integrated Fast-Charger”) is shown in the schematic of FIG. 25A, all the components of the “Fast-Charger System”, FIG. 25, as indicated by the enclosed dashed lines, together with the battery “Temperature Sensor Circuit” (unless it is provided in the battery, usually a battery pack, itself) are provided in a single housing, as marked as the “integrated Battery Heater and Charger”, with its input connection to the external power source, and input ports for the “environmental Temperature Sensor” and other communication, computer connection, software update, etc., as would be required for each specific application. The “Integrated Fast-Charger” is then connected to the “Battery” by a multi-conductor connector, which would provide connection to all provided electrical and electronic connections inside the battery pack, such as the battery temperature sensor, and controls, such as the Battery Management System (BMS) used in Li-ion battery packs. The “Control” Panel” on the “Integrated Fast-Charger” housing would also provide the same functions that was described for the embodiment 100 of FIG. 25.

It is appreciated by those skilled in the art that an advantage of integrating the components of the “Fast-Charger System” embodiment 100 of FIG. 25 into a single “Integrated Battery Heater and Charger”, FIG. 25A, is that it would significantly reduce the required number of electrical and electronic components. In general, the overall size and cost of the system are also reduced. Otherwise, the “Integrated Fast-Charger” embodiment of FIG. 25A is operated and performs its functions as was described for the “Fast-Charger System” embodiment 100 of FIG. 25.

It is appreciated by those skilled in the art that the blocks indicated as “Battery” in FIGS. 25 and 25A and all previously described and those that are described in the remainder of this disclosure are not intended to indicate only a single battery cell, but also battery packs that are customarily fabricated by parallel and in-series connection of single cell batteries to provide the required voltage and current to the intended load.

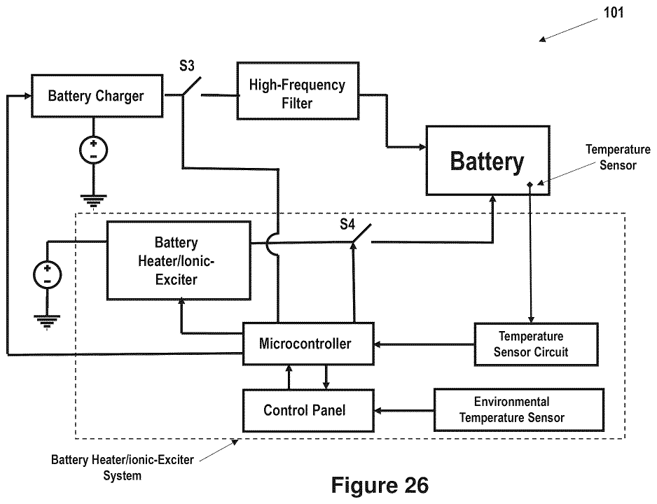

It is appreciated that a very large number of battery chargers already exists and are being used to charge various rechargeable batteries, including Li-ion, of various devices and platforms, such as electric vehicles, trucks, lift-trucks, construction, material handling equipment, and the like, which can use the disclosed fast charging technology to significantly increase the performance and market for such devices and platforms due to the challenges posed by the relatively long periods of time that it takes to charge their batteries. It is therefore highly desirable to develop methods to “convert” existing battery chargers to “fast-chargers” capable of charging batteries at high rates, such as at rates that are at or over 2C-3C. Such a method and a typical resulting “converted” “fast-charger system” embodiment 101, hereinafter referred to as the “Converted Fast-Charger System”, is described below using the block diagram of FIG. 26.

The “Converted Fast-Charger System” embodiment 101 of FIG. 26 comprises a currently available and regularly used “Battery Charger” component and a “Battery Heater/Ionic-Exciter System” component, shown in FIG. 26 with dashed lines. The “Battery Heater/Ionic-Exciter System” component comprises the “Battery Heater/Ionic-Exciter” member, which was previously disclosed and is designed to provide high-frequency heating current to the battery electrolyte, such the embodiment of FIGS. 13A and 13, and the system microcontroller which is provided inside a control unit enclosure (not shown) with a control panel shown in FIG. 26. An environmental temperature sensor, which may be positioned inside the control unit enclosure as shown in FIG. 26 or outside and close to the battery, provides information as to the temperature of the environment within which the battery is located. Both “Battery Charger” and the “Battery Heater/Ionic-Exciter System” components are externally powered.

It is appreciated by those skilled in the art that since most currently used battery chargers are not generally designed to filter high frequency currents from passing into its internal circuits, it is usually necessary to provide a “High-Frequency Filter”, FIG. 26, at the output of the battery charger to prevent high-frequency current generated by the “Battery Heater/Ionic Exciter System” from interfering with the operation of the battery charger electronics. Such “High-Frequency Filter” elements are well known in the art and are used in many battery chargers, and usually comprises a properly sized inductor element to lower the amplitude of the input high-frequency current to an acceptable level for the operation of the battery charger.

In the “Converted Fast-Charger System” embodiment 101 of FIG. 26, similar to the “Fast-Charger System” embodiment 100 of FIG. 25, the “Battery Heater/Ionic-Exciter” member operates in the two different modes, a “Battery Heating Mode”, in which the current frequency is set at or close to its maximum heating rate, and a “Battery Ionic-Excitation Mode”, in which the current frequency is generally set significantly above its maximum heating rate, when the primary purpose of the applied high-frequency current is to generate “ionic-excitation” of the electrolyte ions, thereby as was previously indicated, prevent damage to the battery by plating (e.g., Li plating in Li-ion batteries) with the application of high charging currents, such as 2C-3C or even higher.

It is appreciated by those skilled in the art that operation of the “Battery Heater/Ionic-Exciter” component in both above modes would result in the battery electrolyte heating and generate ionic-excitation, which is the main source of battery electrolyte heating as was previously described. However, in the “Battery Heating Mode”, the heating rate of the battery electrolyte is maximized, while in the “Battery Ionic-Excitation Mode”, the battery electrolyte heating rate is attempted to be minimized.

The operation of the “Converted Fast-Charger System” embodiment 101 of FIG. 26 is controlled by the provided programmable microcontroller. The temperature of the battery being charged is measured by a provided temperature sensor, such as a well-known thermocouple or thermistor or the like, the output of which is provided to the microcontroller via an appropriate “temperature sensor circuit” shown in FIG. 26. A temperature sensor is also provided for measuring environmental temperature of the battery and provide the information to the system controller for setting an optimal process for the required battery charging and heating as previously described. The system “Control Panel” provides the means for the user to turn the system on and off and set the operational requirements of the system, such as the operating temperature and its range, heating and charging rates, etc., examples of which are provided later in this disclosure.

The “Converted Fast-Charger System” embodiment 101 of FIG. 26 operates as follows. When the system is turned on for the first time, the user will use the provided system means described below, to set the system parameters and select the provided operational options. The parameters to be provided include the battery type, size, and all other pertinent characteristic information; heating temperature threshold and its acceptable range; acceptable heating and charging rate ranges; desired charging rate according to the time of day and weekdays; the option of charging without heating or heating without charging (which, may be selected when heating is required to keep a charged battery warm when needed). It is appreciated that many or even all these parameters and options may be set by the equipment manufacturer or seller, particularly if it is purchased together with the equipment in which the battery is installed. In some applications, the system may be provided with a limited number of set of parameters preset options, for example for overnight charging and keeping or bringing the battery at its optimal temperature and fully charged by certain time in the morning for optimal operational performance and to maximize the battery life.

It is also appreciated by those skilled in the art that both of the above methods and means to input the required and desired charging and heating parameters and operational options (i.e., initializing the system) are well known in the art. Other well-known methods, such as factory setting of all the parameters and options for the user and providing minimal user input, usually buttons and/or switches, for the user interaction with the “Converted Fast-Charger System”, such as on/off switch, emergency shut-down button, “Battery Heater/Ionic-Exciter” on/off switch, etc., may also be provided on the system control panel, FIG. 26.

It is appreciated that in the block diagram of FIG. 26, the switches S3 and S4 are intended to indicate the means with which the “Converted Fast-Charger System” controller would connect/disconnect the “Battery Charger” and “Battery Heater/Ionic-Exciter” components, respectively, to/from the battery. It is appreciated by those skilled in the art that depending on the application and the size of the battery, the system designer may provide this capability by, e.g., terminating power supply to the “Battery Charger” and “Battery Heater/Ionic-Exciter” components, or provide the said switching actions within these component circuits.

Once the “Converted Fast-Charger System” embodiment 101 of FIG. 26 is initiated by setting all the required parameters and options as is described above, the user can turn the system on. Once the “Converted Fast-Charger System” is turned on, the software driven system microcontroller collects data as to the battery and battery environment temperatures and charge the battery as it was previously described for the “Fast-Charger System” embodiment 100 of FIG. 25.

The “Converted Fast-Charger System” controller can also be programmed to determine the optimal battery charging rate depending on the prescribed amount of time available for the battery to be fully (or partially) charged.

Once the battery is charged to the prescribed level, if the optimal temperature maintenance option has been selected by the user, the system controller would monitor the battery temperature and would turn the “Battery Heater/Ionic-Exciter” on in its “Battery Heating Mode” when the battery temperature drops below the prescribed threshold and turns it off when the battery temperature reaches its prescribed upper limit threshold, as for example, shown in the plot of FIG. 16.

In the above charging process, the described fast-charging protocol comprises passing a high-frequency current through the battery while performing fast-charging. Then if the battery temperature gets to a prescribed threshold level, then the high-frequency current is turned off, and the battery is charged at a low rate and if necessary, the charging is stopped until the battery has cooled down the prescribed temperature threshold. As the temperature goes up, the amplitude of high-frequency current may be reduced to reduce heating rate.

It is appreciated by those skilled in the art that the “Fast-Charger System” embodiment 101 of FIG. 26 may also operate in a slow charging mode, i.e., well below the charging rate of 1C, for example at a rate of 0.2C, when charging time is not an issue, for example when the battery is to be charged overnight. In such slow charging modes, the “Battery Heating Mode” is also used when the battery temperature is below its optimal charging temperature, to bring the charged battery temperature to its optimal operating temperature at the prescribed time for the user, and to minimize battery life reduction by charging the battery at its optimal charging temperature. In addition, the “Battery Heater/Ionic-Exciter” may also be used in its “Battery Ionic-Excitation Mode” to reduce/eliminate any potential plating damage to the battery.

It is appreciated that as it was indicated previously, the applied high-frequency current allows for battery charging at high-rates that may be over 2C-3C at lower temperatures without causing damage (plating), such as Lithium plating in Li-ion batteries.

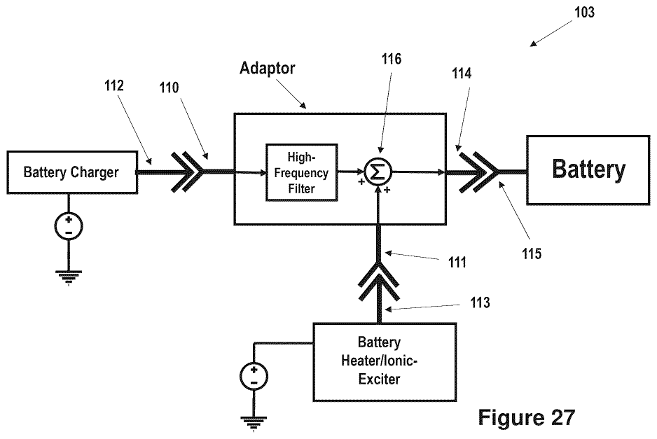

It is appreciated that there is also a need for users who already have an existing battery charger to be able to use a “Battery Heater/Ionic Exciter” unit to form a “Fast-Charger System” similar to the “Fast-Charger System” embodiment 100 of FIG. 25, for charging batteries at high rates as well as for direct heating of the battery electrolyte at low temperatures for optimal charging and operation as was previously described for the “Fast-Charger System” embodiments 100 and 101 of FIGS. 25 and 26, respectively. To achieve this goal, a properly designed “Adaptor” is needed that would allow for “in-parallel” connection of a battery charger to a “Battery Heater/Ionic Exciter” unit and then connect the adapter to the “Battery”, i.e., to the battery (usually battery pack) of the device or platform, such as an electric vehicle, truck, or the like. Such an “Adaptor” and its connection arrangements with the “Battery Charger” and “Battery Heater/Ionic Exciter” and the “Battery” is shown in the block diagram of FIG. 27.

The “Fast-Charger System” formed with the provider “Adaptor” that functions similar to the “Fast-Charger System” embodiment 100 of FIG. 25 is shown in FIG. 27 and is indicated as the embodiment 103 and is hereinafter referred to as the “Adapter-based Fast-Charger System”. The “Adaptor” is shown to be provided with two input multi-conductor connectors 110 and 111, to which the “Battery Charger” and “Battery Heater/Ionic Exciter” units are connected via their mating multi-conductor connectors 112 and 113, respectively. It is appreciated that as can be seen in the block diagram of FIG. 27, both “Battery Charger” and “Battery Heater/Ionic Exciter” units are powered by external power sources. The “Adaptor” is also provided with an output cable with a multi-conductor connector, the assembly of which is indicated by the numeral 114 in FIG. 27. The output multi-conductor connector of the “Adaptor” is then connected to the mating multi-conductor connector 115 of the “Battery” that is provided on the device, platform, vehicle, and the like that is to be charged.

It is appreciated by those skilled in the art that in general, the above “Adaptor” connectors and connector that connects the “Adaptor” to the “Battery” are needed to by multi-connector type to allow input from the battery temperature sensor to be provided to both the “Battery Charger” and the “Battery Heater/Ionic Exciter” unit controls and to connect all other existing “Battery” electronic and electrical sensory and control wirings, such as “Battery Management System” (BMS) wirings to the “Battery Charger” and the “Battery Heater/Ionic-Exciter” units.

It is appreciated by those skilled in the art that since most currently used battery chargers are not generally designed to filter high-frequency currents from passing into its internal circuits, the “Adaptor” is provided with a “High-Frequency Filter”, FIG. 27, at its “Battery Charger” input 110, the output of which is connected with the input 111 from the “Battery Heater/Ionic-Exciter” in the junction 116, in which the high-frequency AC current output of the “Battery Heater/Ionic-Exciter” is superimposed over the DC battery charging current of the “Battery Charger”. Such a “High-Frequency Filter” is generally required in the present configured system of FIG. 27 to prevent high-frequency current generated by the “Battery Heater/Ionic Exciter System” from interfering with the operation of the “Battery Charger” electronics. Such “High-Frequency Filter” elements are well known in the art and are used in many similar applications and usually comprises a properly sized inductor element to lower the amplitude of the input high-frequency current to an acceptable level for the operation of the related devices, in this case the electronics of the “Battery Charger”.

An environmental temperature sensor, which may be positioned inside the “Adaptor” unit housing (not shown), FIG. 27, is also usually provided and is used by the “Battery Heater/Ionic-Exciter System” for their proper operation as was previously described for the operation of the “Fast-Charger System” embodiment 100 of FIG. 25.

It is appreciated by those skilled in the art that as it was previously described for the “Fast-Charger System” embodiment 100 of FIG. 25, the operation of the “Battery Heater/Ionic-Exciter” component in both its modes, i.e., in its “Battery Heating Mode” and “Battery Ionic-Excitation Mode” would result in the battery electrolyte heating and generate ionic-excitation, which the latter is the main source of battery electrolyte heating as was previously described. However, as it was previously described for the embodiments of FIGS. 25 and 26, in the “Battery Heating Mode”, the heating rate of the battery electrolyte is maximized, while in the “Battery Ionic-Excitation Mode”, the battery electrolyte heating rate is attempted to be minimized.

This means that in the “Adapter-based Fast-Charger System” embodiment 103 of FIG. 27, similar to the embodiment 100 and 101 of FIGS. 25 and 26, respectively, the current frequency of the “Battery Heater/Ionic-Exciter” member is programmed to operate in its “Battery Heating Mode” when it is needed for battery electrolyte heating, in which case the current frequency is set at or close to its maximum heating rate. Then when the primary purpose of the applied high-frequency current is to generate “ionic-excitation” of the electrolyte ions, the “Battery Heater/Ionic-Exciter” is set to its “Battery Ionic-Excitation Mode”, in which the current frequency is generally set significantly above or below its maximum heating rate to reduce battery heating rate while increasing ionic excitation in the battery electrolyte, thereby as was previously indicated, prevent damage to the battery by plating (e.g., Li plating in Li-ion batteries) with the application of high charging currents, such as 2C-3C or even higher.

The operation of the “Adapter-based Fast-Charger System” embodiment 103 of FIG. 27 is also controlled by the provided, generally programmable, “Battery Charger” control unit, and the programmable microcontroller of the “Batter Heater/Ionic-Exciter System”, FIG. 26. The temperature of the battery being charged is measured by a provided temperature sensor, such as a well-known thermocouple or thermistor or the like, the output of which is provided to the microcontroller of the “Batter Heater/Ionic-Exciter System”. A temperature sensor is also provided (not shown), such as in the “Battery Heater/Ionic-Exciter” or the “Adaptor”, FIG. 27 as was previously indicated for measuring environmental temperature of the battery and provide the information to the “Battery Heater/Ionic-Exciter System” microcontroller for setting an optimal process for the required battery charging and heating as previously described for the embodiment 101 of FIG. 26. The “Control Panels” (not shown) of the “Battery Charger” and “Battery Heater/Ionic-Exciter” units would provide the means for the user to turn the system on and off and set the operational requirements of the system, such as the operating temperature and its range, heating and charging rates, etc., as was previously described.

It is appreciated by those skilled in the art that in general, the “Adaptor” in a passive component of the “Adapter-based Fast-Charger System” embodiment 103 of FIG. 27. However, in certain applications, the “Adaptor” may be desired to provide control over the “Battery Charger” and/or “Battery Heater/Ionic Exciter” operations. In such cases, the “Adaptor” may be provided with a programmable microcontroller (not shown) and be used to direct the operation of the “Battery Charger” and/or “Battery Heater/Ionic Exciter” units by appropriately setting the parameters controlling the operation of their programmed microcontrollers. Power for the operation of the “Adaptor” microcontroller and the related electrical and electronics can be provided by the “Battery Heater/Ionic Exciter” unit, but the “Adaptor” may also be provided with its own (possibly rechargeable) batteries since it would only require a low level of electrical power to operate its components.

The “Adapter-based Fast-Charger System” embodiment 103 of FIG. 27 operates as follows. When the system is turned on for the first time, the user will use the provided system means described below, to set the system parameters and select the provided operational options for both the “Battery Charger” and for the “Battery Heater/Ionic Exciter”. The parameters to be provided include the battery type, size, and all other pertinent characteristic information; heating temperature threshold and its acceptable range; acceptable heating and charging rate ranges; desired charging rate according to the time of day and weekdays; the option of charging without heating or heating without charging (which, may be selected when heating is required to keep a charged battery warm when needed). It is appreciated that many or even all these parameters and options may be set by the equipment manufacturer or seller, particularly if it is purchased together with the equipment in which the battery is installed. In some applications, the system may be provided with a limited number of set of parameters preset options, for example for overnight charging and keeping or bringing the battery at its optimal temperature and fully charged by certain time in the morning for optimal operational performance and to maximize the battery life.

It is also appreciated by those skilled in the art that both of the above methods and means to input the required and desired charging and heating parameters and operational options (i.e., initializing the system) are well known in the art. Other well-known methods, such as factory setting of all the parameters and options for the user and providing minimal user input, usually buttons and/or switches, for the user interaction with the “Battery Charger” and for the “Battery Heater/Ionic Exciter”, such as on/off switch, emergency shut-down button, “Battery Heater/Ionic-Exciter” on/off switches, etc., may also be provided on the system component control panels.

Once the “Adapter-based Fast-Charger System” embodiment 103 of FIG. 27 is initiated by setting all the required parameters and options as is described above, the user can turn the system, i.e., the “Battery Charger” and the “Battery Heater/Ionic Exciter” on. Once the “Adapter-based Fast-Charger System” is turned on, the software driven “Battery Charger” and the “Battery Heater/Ionic Exciter” microcontrollers collects data as to the battery and battery environment temperatures and charge the battery as it was previously described for the embodiment 101 of FIG. 26. The “Adapter-based Fast-Charger System” controls can also be programmed to determine the optimal battery charging rate depending on the prescribed amount of time available for the battery to be fully (or partially) charged.

Once the battery is charged to the prescribed level, if the optimal temperature maintenance option has been selected by the user, the “Battery Heater/Ionic Exciter” controller would monitor the battery temperature and would turn the “Battery Heater/Ionic-Exciter” on in its “Battery Heating Mode” when the battery temperature drops below the prescribed threshold and turns it off when the battery temperature reaches its prescribed upper limit threshold, as for example, shown in the plot of FIG. 16.

In the above charging process, the described fast-charging protocol comprises passing a high-frequency current through the battery while performing fast-charging. Then if the battery temperature gets to a prescribed threshold level, then the high-frequency current is turned off, and the battery is charged at a low rate and if necessary, the charging is stopped until the battery has cooled down the prescribed temperature threshold. As the temperature goes up, the amplitude of high-frequency current may be reduced to reduce heating rate.

It is appreciated by those skilled in the art that the “Adapter-based Fast-Charger System” embodiment 103 of FIG. 27 may also operate in a slow charging mode, i.e., well below the charging rate of 1C, for example at a rate of 0.2C, when charging time is not an issue, for example when the battery is to be charged overnight. In such slow charging modes, the “Battery Heating Mode” is also used when the battery temperature is below its optimal charging temperature, to bring the charged battery temperature to its optimal operating temperature at the prescribed time for the user, and to minimize battery life reduction by charging the battery at its optimal charging temperature. In addition, the “Battery Heater/Ionic-Exciter” may also be used in its “Battery Ionic-Excitation Mode” to reduce/eliminate any potential plating damage to the battery.

It is appreciated that as it was indicated previously, the applied high-frequency current allows for battery charging at high-rates that may be over 2C-3C at lower temperatures without causing damage (plating), such as Lithium plating in Li-ion batteries.

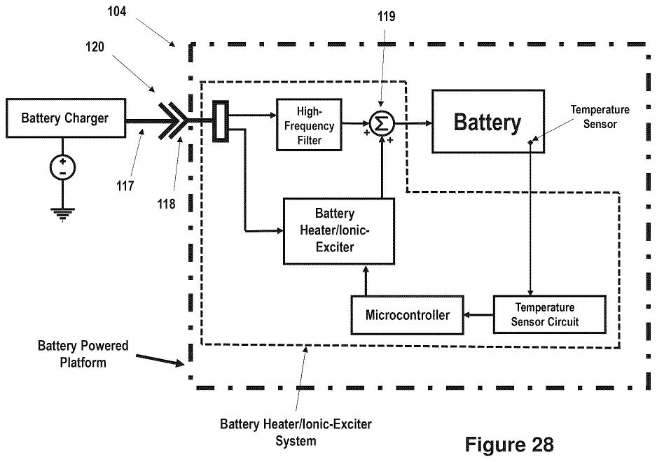

It is appreciated that in certain applications, such as in electric vehicles, trucks, various mobile and fixed platforms, and the like, hereinafter referred to collectively as the “Battery Powered Platforms”, it is highly desirable to have the disclosed high-frequency direct battery electrolyte heating capability be incorporated into these platforms so that their batteries could be charged at any desired rate, including fast rates, using available chargers. To this end, the “Battery Heater/Ionic Exciter” unit, FIGS. 26 and 26, and its related components are positioned inside the intended “Battery Powered Platforms” as shown in the block diagram of FIG. 28. The resulting charging system, hereinafter referred to as the “Platform Integrated Fast-Charging System”, is indicated as embodiment 104.

In the block diagram of FIG. 28, the “Platform Integrated Fast-Charging System” embodiment 104 is shown inside the “Battery Powered Platform”, such as an electric powered vehicle, truck, other mobile or fixed platforms, and the like, which is shown by the enclosing dash-dot enclosing lines. The “Platform Integrated Fast-Charging System” can be seen to comprise the “Battery Heater/Ionic-Exciter System”, which is enclosed by dashed lines. The battery (battery pack) is also shown inside the “Battery Powered Platform”. In this system, the “Battery Charger” is powered by an external source, FIG. 28, and is provided with an output cable 117 with a multi-conductor connector for connection to the mating connector 118 of the “Battery Powered Platform”.

As can be seen in the block diagram of FIG. 28, the “Battery Heater/Ionic-Exciter System” comprises the previously described “Battery Heater/Ionic-Exciter” unit, FIGS. 25 and 26, and related microcontroller. In addition, depending on the type of temperature sensor used for measuring the battery temperature, an appropriate “Temperature Sensor Circuit” might have to be provided to input the measured temperature level to the microcontroller. The “Battery Heater/Ionic-Exciter” unit is also powered by the DC current provided by the “Battery Charger” via the multi-conductor connector 120 with mating parts 117 and 118.

It is appreciated by those skilled in the art that since most currently used battery chargers are not generally designed to filter high-frequency currents from passing into its internal circuits, a “High-Frequency Filter” is provided in the “Battery Heater/Ionic-Exciter System” before the junction 119, FIG. 28, in which the high-frequency AC current output of the “Battery Heater/Ionic-Exciter” is superimposed over the DC battery charging current of the “Battery Charger” and being supplied to the “Battery”. Such a “High-Frequency Filter” is generally required in the present configured system of FIG. 28 to prevent high-frequency current generated by the “Battery Heater/Ionic Exciter System” from interfering with the operation of the “Battery Charger” electronics. Such “High-Frequency Filter” elements are well known in the art and are used in many similar applications and usually comprises a properly sized inductor element to lower the amplitude of the input high-frequency current to an acceptable level for the operation of the related devices, in this case the electronics of the “Battery Charger”.

It is appreciated by those skilled in the art that in general, the connector 120 needs to be of multi-connector type to allow input from the battery temperature sensor to be provided to both the “Battery Charger” and the “Battery Heater/Ionic Exciter” unit controls and to connect all other existing “Battery” electronic and electrical sensory and control wirings, such as “Battery Management System” (BMS) wirings to the “Battery Charger” and the “Battery Heater/Ionic-Exciter” units.

An environmental temperature sensor (not shown), which may be positioned inside the “Battery Heater/Ionic-Exciter System”, FIG. 28, is also usually provided and is used by the “Battery Heater/Ionic-Exciter System” for their proper operation as was previously described for the operation of the “Fast-Charger System” embodiment 100 of FIG. 25.

It is appreciated by those skilled in the art that as it was previously described for the “Fast-Charger System” embodiment 100 of FIG. 25, in the “Platform Integrated Fast-Charging System” embodiment 104 of FIG. 28, the operation of the “Battery Heater/Ionic-Exciter” component in both its modes, i.e., in its “Battery Heating Mode” and “Battery Ionic-Excitation Mode” would result in the battery electrolyte heating and generate ionic-excitation, in which the latter is the main source of battery electrolyte heating as was previously described. However, as it was previously described for the embodiments of FIGS. 25 and 26, in the “Battery Heating Mode”, the heating rate of the battery electrolyte is maximized, while in the “Battery Ionic-Excitation Mode”, the battery electrolyte heating rate is attempted to be minimized.

This means that in the “Platform Integrated Fast-Charging System” embodiment 104, similar to the embodiment 100 and 101 of FIGS. 25 and 26, respectively, the current frequency of the “Battery Heater/Ionic-Exciter” member is programmed to operate in its “Battery Heating Mode” when it is needed for battery electrolyte heating, in which case the current frequency is set at or close to its maximum heating rate. Then when the primary purpose of the applied high-frequency current is to generate “ionic-excitation” of the electrolyte ions, the “Battery Heater/Ionic-Exciter” is set to its “Battery Ionic-Excitation Mode”, in which the current frequency is generally set significantly above or below its maximum heating rate to reduce battery heating rate while increasing ionic excitation in the battery electrolyte, thereby as was previously indicated, prevent damage to the battery by plating (e.g., Li plating in Li-ion batteries) with the application of high charging currents, such as 2C-3C or even higher.

The operation of the “Platform Integrated Fast-Charging System” embodiment 104 of FIG. 28 is also controlled by the provided, generally programmable, “Battery Charger” control unit, and the programmable microcontroller of the “Batter Heater/Ionic-Exciter System”, FIG. 28. The temperature of the battery is measured by the provided temperature sensor, such as a well-known thermocouple or thermistor or the like, the output of which is provided to the microcontroller of the “Batter Heater/Ionic-Exciter System”. A temperature sensor is also provided (not shown), such as in the “Battery Heater/Ionic-Exciter System” as was previously indicated for measuring environmental temperature of the battery and provide the information to the “Battery Heater/Ionic-Exciter System” microcontroller for setting an optimal process for the required battery charging and heating as previously described for the embodiment 101 of FIG. 26. The “Control Panel” (not shown) of the “Battery Charger” would provide the means for the user to turn it on and off and select its operational parameters. The operational parameters of the “Battery Heater/Ionic-Exciter” unit are usually set by the platform and/or the “Battery” and/or the battery control electronic (e.g., BMS for Li-ion and the like batteries) manufacturer.

The “Platform Integrated Fast-Charging System” embodiment 104 of FIG. 28 operates as follows. When the system is turned on for the first time, the user will use the provided system means described below, to set the system parameters and select the provided operational options for the “Battery Charger” and for the “Battery Heater/Ionic Exciter System” if they are not set by the manufacturer, but certain charging and heating options may be provided for the user to select. For the “Battery Charger”, the parameters to be provided include the battery type, size, and all other pertinent characteristic information; heating temperature threshold and its acceptable range; acceptable heating and charging rate ranges; the desired charging rate according to the time of day and weekdays; etc. It is appreciated that many or even all these parameters and options for the “Battery Charger” may be set by the equipment manufacturer or seller, particularly if it is purchased together with the equipment in which the battery is installed. In some applications, the system may be provided with a limited number of set of parameters preset options, for example for overnight charging and keeping or bringing the battery at its optimal temperature and fully charged by certain time in the morning for optimal operational performance and to maximize the battery life.

It is also appreciated by those skilled in the art that the above methods and means to input the required and desired charging and heating parameters and operational options (i.e., initializing the system) are well known in the art. Other well-known methods, such as factory setting of all the parameters and options for the user and providing minimal user input, usually buttons and/or switches, for the user interaction with the “Battery Charger” and for the “Battery Heater/Ionic Exciter System”, such as on/off switch, emergency shut-down button, “Battery Heater/Ionic-Exciter” on/off switches, etc., may also be provided.

Once the “Platform Integrated Fast-Charging System” embodiment 104 of FIG. 28 is initiated by setting all the required parameters and options as is described above, the user can engage the multi-conductor connector 120 and turn the “Battery Charger” on. Once the system is turned on, the software driven “Battery Charger” and the “Battery Heater/Ionic Exciter System” microcontrollers collect data as to the battery and battery environment temperatures and charge the battery as it was previously described for the embodiment 101 of FIG. 26. The “Platform Integrated Fast-Charging System” controls can also be programmed to determine the optimal battery charging rate depending on the prescribed amount of time available for the battery to be fully (or partially) charged.

In the above charging process, the described fast-charging protocol comprises passing a high-frequency current through the battery while performing fast-charging. Then if the battery temperature gets to a prescribed threshold level, then the high-frequency current is turned off, and the battery is charged at a low rate and if necessary, the charging is stopped until the battery has cooled down the prescribed temperature threshold. As the temperature goes up, the amplitude of high-frequency current may be reduced to reduce heating rate.

It is appreciated by those skilled in the art that the “Platform Integrated Fast-Charging System” embodiment 104 of FIG. 28 may also operate in a slow charging mode, i.e., well below the charging rate of 1C, for example at a rate of 0.2C, when charging time is not an issue, for example when the battery is to be charged overnight. In such slow charging modes, the “Battery Heating Mode” is also used when the battery temperature is below its optimal charging temperature, to bring the charged battery temperature to its optimal operating temperature at the prescribed time for the user, and to minimize battery life reduction by charging the battery at its optimal charging temperature. In addition, the “Battery Heater/Ionic-Exciter” may also be used in its “Battery Ionic-Excitation Mode” to reduce/eliminate any potential plating damage to the battery.

It is appreciated that as it was indicated previously, the applied high-frequency current allows for battery charging at high-rates that may be over 2C-3C at lower temperatures without causing damage (plating), such as Lithium plating in Li-ion batteries.

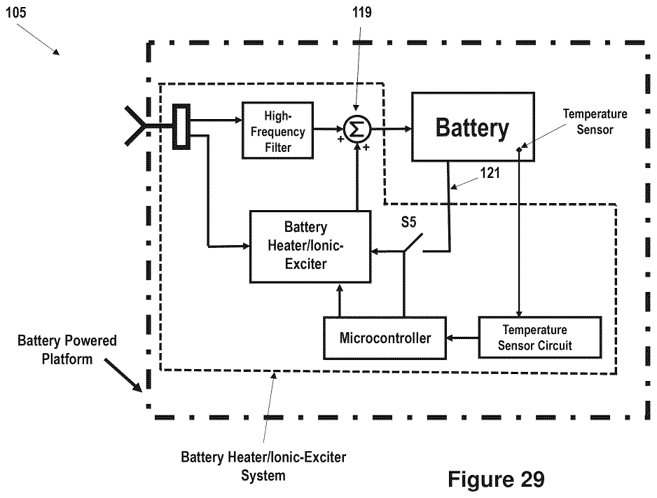

It is appreciated that in certain applications, such as in electric vehicles, trucks, various mobile and fixed platforms, and the like, i.e., the aforementioned “Battery Powered Platforms”, it is highly desirable to have the “Platform Integrated Fast-Charging System” embodiment 104 of FIG. 28 be provided with the capability of keeping the “Battery” at or close to its optimum operating temperature once the “Battery” is charged to the prescribed level and the “Battery Charger” has been disconnected from the “Battery Powered Platform”. To this end, “Platform Integrated Fast-Charging System” embodiment 104 of FIG. 28 can be modified as shown in the block diagram of FIG. 29, identified as embodiment 105, to provide this capability as described below.

In the modified “Platform Integrated Fast-Charging System” embodiment 105 of FIG. 29, the “Battery Heater/Ionic-Exciter” unit and the system microcontroller are powered by the battery via the line 121 and through the on/off switch S5. All other components of the modified “Platform Integrated Fast-Charging System” embodiment 105 are identical to those of the “Platform Integrated Fast-Charging System” embodiment 104 of FIG. 28. The “Battery Heater/Ionic-Exciter” unit may be provided with two high-frequency current generating circuits; one of the types shown in the block diagram of FIG. 13A and circuit of FIG. 13, and the other of the type shown in the circuit of FIG. 14.

Alternatively, particularly if a relatively low battery electrolyte heating rates are required, for example, when the charging rate does not have to be high and/or the environmental temperature is not very low or the “Battery” is provided with a very effective thermal insulation, then the “Battery Heater/Ionic-Exciter” unit may be provided with only the heating circuit of the type shown in FIG. 14, which would then be powered by the “Battery Charger” when the “Battery” is being charged and by the “Battery” itself when the battery is not being charged.

In the modified “Platform Integrated Fast-Charging System” embodiment 105 of FIG. 29, similar to the embodiment 100 and 101 of FIGS. 25 and 26, respectively, the current frequency of the “Battery Heater/Ionic-Exciter” member is programmed to operate in its “Battery Heating Mode” when it is needed for battery electrolyte heating, in which case the current frequency is set at or close to its maximum heating rate. Then when the primary purpose of the applied high-frequency current is to generate “ionic-excitation” of the electrolyte ions, the “Battery Heater/Ionic-Exciter” is set to its “Battery Ionic-Excitation Mode”, in which the current frequency is generally set significantly above or below its maximum heating rate to reduce battery heating rate while increasing ionic excitation in the battery electrolyte, thereby as was previously indicated, prevent damage to the battery by plating (e.g., Li plating in Li-ion batteries) with the application of high charging currents, such as 2C-3C or even higher.

The operation of the modified “Platform Integrated Fast-Charging System” embodiment 105 of FIG. 29 is also controlled by the provided, generally programmable, “Battery Charger” control unit, and the programmable microcontroller of the “Batter Heater/Ionic-Exciter System”, FIG. 29. The temperature of the battery is measured by the provided temperature sensor, such as a well-known thermocouple or thermistor or the like, the output of which is provided to the microcontroller of the “Batter Heater/Ionic-Exciter System”. A temperature sensor is also provided (not shown), such as in the “Battery Heater/Ionic-Exciter System” as was previously indicated for measuring environmental temperature of the battery and provide the information to the “Battery Heater/Ionic-Exciter System” microcontroller for setting an optimal process for the required battery charging and heating as previously described for the embodiment 101 of FIG. 26. The operational parameters of the “Battery Heater/Ionic-Exciter” unit are usually set by the platform and/or the “Battery” and/or the battery control electronic (e.g., BMS for Li-ion and the like batteries) manufacturer.

The modified “Platform Integrated Fast-Charging System” embodiment 105 of FIG. 29 operates as follows. When the system is turned on for the first time, the user will use the provided system means described below, to set the system parameters and select the provided operational options for the “Battery Charger” and for the “Battery Heater/Ionic Exciter System” if they are not set by the manufacturer, but certain charging and heating options may be provided for the user to select. For the “Battery Charger”, the parameters to be provided include the battery type, size, and all other pertinent characteristic information; heating temperature threshold and its acceptable range; acceptable heating and charging rate ranges; the desired charging rate according to the time of day and weekdays; etc. In some applications, the system may be provided with a limited number of set of parameters preset options, for example for overnight charging and keeping or bringing the battery at its optimal temperature and fully charged by certain time in the morning for optimal operational performance and to maximize the battery life.

It is also appreciated by those skilled in the art that the above methods and means to input the required and desired charging and heating parameters and operational options (i.e., initializing the system) are well known in the art. Other well-known methods, such as factory setting of all the parameters and options for the user and providing minimal user input, usually buttons and/or switches, for the user interaction with the “Battery Charger” and for the “Battery Heater/Ionic Exciter System”, such as on/off switch, emergency shut-down button, “Battery Heater/Ionic-Exciter” on/off switches, etc., may also be provided.

Once the modified “Platform Integrated Fast-Charging System” embodiment 105 is initiated (or it has been initiated with the “Battery Charger” configuration of FIG. 28), then when the “Battery Charger” is disconnected from the platform by disconnecting the multi-contact connector 120, FIG. 28, and if the platform connected “Battery Charger” is turned off, then the switch S5, FIG. 29, is closed by the command received from the microcontroller and the “Battery Heater/Ionic-Exciter” is powered by the battery via the line 121 and is set to its “Battery Heating Mode”. Then the “Battery Heater/Ionic Exciter System” microcontrollers collect data as to the battery and battery environment temperatures and begin to heat the battery electrolyte if the battery temperature is below its prescribed low temperature threshold until the battery temperature reaches it upper temperature threshold, at which point, the microcontroller would terminate battery heating. As a result, the battery temperature is kept within a prescribed temperature range.

It is appreciated by those skilled in the art that as it is customary in all battery powered equipment, the microcontroller, FIG. 29, would be programmed to monitor the battery state of charge, and if it falls below a prescribed threshold, it would terminate the above temperature maintenance process, i.e., it would terminate the above battery electrolyte heating process and allow the battery temperature to drop below its prescribed low limit. This feature is usually required to protect the battery from low charge level damage or due to certain operational requirements of the platform.

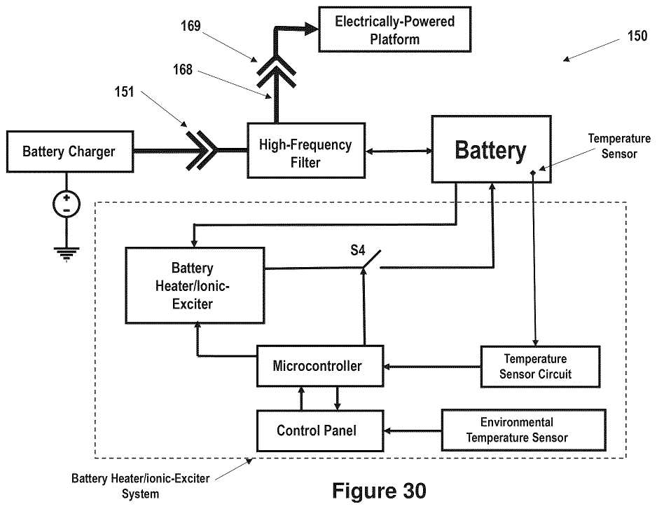

It is noted that in the embodiment 101 of FIG. 26, whether it is used for the described “fast charging” of batteries or for charging batteries at significantly lower rates that is usually recommended by the battery manufacturer, the “Battery Heater/Ionic-Exciter” component of the embodiment is powered by an external power source. However, in an alternative design of embodiment 150 shown in the block diagram of FIG. 30, the “Battery Heater/Ionic-Exciter” component is seen to be powered directly by the battery, in which the “Battery Heater/Ionic-Exciter” operates in a previously described in FIG. 14 or its equivalent, i.e., in the previously described self-heating mode.

It is also appreciated that the system configuration of the embodiment 150 of FIG. 30 is designed to allow for “fast-charging” rates with minimal battery electrolyte heating as well as for direct battery electrolyte heating when the battery temperature is below its optimal charging temperature before (and during) charging and maintaining its temperature at its optimal level during charging and after charging, while the battery is being used to fully or partially power a mobile or stationary platform.

The system of embodiment 150 of FIG. 30 is seen to be comprised of a currently available and regularly used “Battery Charger” component and a “Battery Heater/Ionic-Exciter System” component, shown with dashed lines. The “Battery Heater/Ionic-Exciter System” component comprises the “Battery Heater/Ionic-Exciter” member, which was previously disclosed and is designed to provide high-frequency current to the battery electrolyte and which is powered by the battery, such as the embodiment of FIG. 14. The system microcontroller, which is usually provided inside a control unit enclosure (not shown) with a control panel is also provided for controlling the operation of the system and setting all the required parameters for its operation as described later. An environmental temperature sensor, which may be positioned inside the control unit enclosure as shown in FIG. 30 or outside and close to the battery, provides information as to the temperature of the environment within which the battery is located. The “Battery Charger” is powered by an external source.

It is appreciated by those skilled in the art that since most currently used battery chargers are not generally designed to filter high frequency currents from passing into its internal circuits, it is usually necessary to provide a “High-Frequency Filter”, FIG. 30, at the output of the battery charger to prevent high-frequency current generated by the “Battery Heater/Ionic Exciter System” from interfering with the operation of the battery charger electronics. Such “High-Frequency Filter” elements are well known in the art and are used in many battery chargers, and usually comprises a properly sized inductor and capacitor elements to lower the amplitude of the input high-frequency current to an acceptable level for the operation of the battery charger.

In addition, to prevent the high-frequency current from interfering with the operation of the electrical, electronic and other components of the “Electrically-Powered Platform” that is powered by the battery of the system embodiment 150 of FIG. 30, the battery output to the “Electrically-Powered Platform” is made via the “High-Frequency Filter” through connectors 168 and 169, so that the high-frequency current generated by the “Battery Heater/Ionic-Exciter” is filtered from the input to the “Electrically-Powered Platform”.

Similar to the “Fast-Charger System” embodiment 100 of FIG. 25, the “Battery Heater/Ionic-Exciter” member of the system of embodiment 150 of FIG. 30 operates in two different modes, a “Battery Heating Mode”, in which the current frequency is set at or close to its maximum heating rate, and a “Battery Ionic-Excitation Mode”, in which the current frequency is generally set at significantly lower heating rates, since the primary purpose of the applied high-frequency current is to generate “ionic-excitation” of the electrolyte ions, thereby as was previously indicated, to prevent/minimize damage to the battery (e.g., by Li plating in Li-ion batteries) with the application of high charging currents, such as 2C-3C or even higher.

It is appreciated by those skilled in the art that operation of the “Battery Heater/Ionic-Exciter” component in both above modes would result in the battery electrolyte heating and generate ionic-excitation, which is the main mechanism of battery electrolyte heating as was previously described. However, in the “Battery Heating Mode”, the heating rate of the battery electrolyte is maximized, while in the “Battery Ionic-Excitation Mode”, the battery electrolyte heating rate is attempted to be minimized.

The operation of the system of embodiment 150 of FIG. 30 is controlled by the provided programmable microcontroller. The temperature of the battery being charged is measured by a provided temperature sensor, such as a well-known thermocouple or thermistor or the like, the output of which is provided to the microcontroller via an appropriate “temperature sensor circuit” shown in FIG. 30. A temperature sensor is also provided for measuring environmental temperature of the battery and provide the information to the system controller for setting an optimal process for the required battery charging and heating as previously described. The system “Control Panel” provides the means for the user to turn the system on and off and to set the operational requirements of the system, such as the operating temperature and its range, heating and charging rates, etc., examples of which were provided previously for the other embodiments of the present invention.

The system of embodiment 150 of FIG. 30 operates as follows. When the system is turned on for the first time, the user will use the provided system means described below, to set the system parameters and select the provided operational options. The parameters to be provided include the battery type, size, and all other pertinent characteristic information; heating temperature threshold and its acceptable range; acceptable heating and charging rate ranges; desired charging rate according to the time of day and weekdays; the option of charging without heating or heating without charging (which, may be selected when heating is required to keep a charged battery warm when needed). It is appreciated that many or even all these parameters and options may be set by the equipment manufacturer or seller, particularly if it is purchased together with the equipment in which the battery is installed. In some applications, the system may be provided with a limited number of set of parameters preset options, for example for overnight charging and keeping or bringing the battery at its optimal temperature and fully charged by certain time in the morning for optimal operational performance and to maximize the battery life.

It is also appreciated by those skilled in the art that both of the above methods and means to input the required and desired charging and heating parameters and operational options (i.e., initializing the system) are well known in the art. Other well-known methods, such as factory setting of all the parameters and options for the user and providing minimal user input, usually buttons and/or switches, for the user interaction with the embodiment 150 system, such as on/off switch, emergency shut-down button, “Battery Heater/Ionic-Exciter” on/off switch, etc., may also be provided on the system control panel, FIG. 30.

It is appreciated that in the block diagram of FIG. 30, the switch S4 is intended to indicate the means with which the system controller would activate/deactivate the “Battery Heater/Ionic-Exciter” component to supply high-frequency current to the battery as it was previously described. It is appreciated that as it was previously indicated, the “Battery Heater/Ionic-Exciter” component is powered by the battery. In addition, in the block diagram of FIG. 30, the “Battery Charger” is considered to be connected/disconnected to the system “High-Frequency Filter” by the user via the connectors 151.

Once the embodiment 150 system of FIG. 30 is initiated by setting all the required parameters and options as is described above, the user can turn the system on. Once the system is turned on, the software driven system microcontroller collects data as to the battery and battery environment temperatures and charges the battery as it was previously described for the “Fast-Charger System” embodiment 100 of FIG. 25.

Once the battery is charged to the prescribed level, if the optimal temperature maintenance option has been selected by the user, the system controller would monitor the battery temperature and would turn the “Battery Heater/Ionic-Exciter” on in its “Battery Heating Mode” when the battery temperature drops below the prescribed threshold and turns it off when the battery temperature reaches its prescribed upper limit threshold, as for example, shown in the plot of FIG. 16.

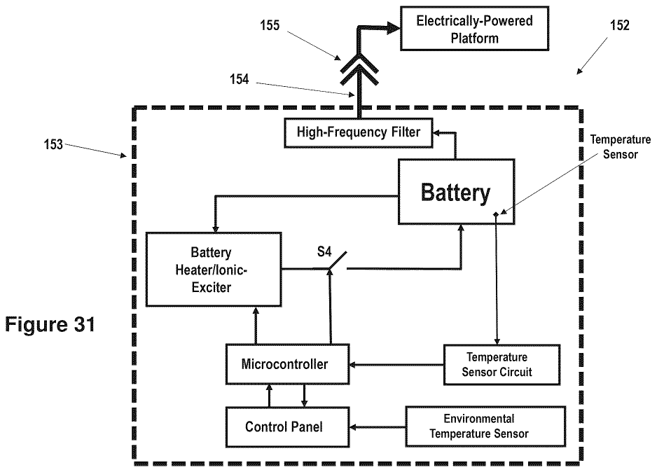

It is appreciated that in certain applications, such as in electric vehicles, trucks, various mobile platforms, and the like, it is highly desirable to have the high-frequency direct battery electrolyte heating capability disclosed previously to be integrated into the battery or battery packs to eliminate the need for the electrically powered platform user having to go through the process of making the proper connections and having to ensure that the added components and their wiring are properly protected from damage during platform operation, and also in many cases, avoid the need for the user to properly attach temperature sensors and the like to the battery and test for their proper operation, etc. With such battery and battery pack integrated high-frequency direct battery electrolyte heating capability, the user only needs to install the battery as it has usually been done. FIG. 31 illustrates the block diagram of such a battery or battery pack with integrated battery-powered (self-heating mode of operation) high-frequency battery electrolyte heating capability and is hereinafter referred to as the embodiment 152 of the present invention.

It is appreciated that in all the above and following embodiments of the present invention, the reference to a battery is also intended to reference to any assembled and packaged, so-called battery pack.

It is appreciated that the battery and battery pack system embodiment 152 of FIG. 31 with integrated high-frequency electrolyte heating capability is designed for powering electrically powered platforms during service while maintaining the battery temperature at or close to its optimal operating temperature range so that the battery and battery pack can provide its peak power to the fully or partially powered mobile or stationary platform.

The system of embodiment 152 of FIG. 31 is seen to be comprised of a “Battery Heater/Ionic-Exciter” member, which was previously disclosed and is designed to provide high-frequency current to the battery electrolyte and which is powered by the battery, such as the embodiment of FIG. 14. The system microcontroller, which is usually provided inside a control unit enclosure with a control panel, is also provided for controlling the operation of the system and setting all the required parameters for its operation. An environmental temperature sensor, which may be positioned inside the integrated battery/battery-pack system housing but preferably positioned (for example attached to the housing wall), is also provided to monitor the ambient temperature within which the battery is located.

It is appreciated by those skilled in the art that since most currently electrically powered mobile and stationary platforms and devices that use batteries as their source of electricity are generally not designed to filter high-frequency and relatively high currents generated by the “Battery Heater/Ionic Exciter” of the system of embodiment 152 of FIG. 31. In many such electrically powered platforms and devices, the applied high-frequency current may affect or interfere with the operation of their electronic, electrical and other systems. For this reason, it is usually necessary to provide a “High-Frequency Filter” (Low-pass filter), FIG. 31, at the output of the battery to prevent high-frequency current generated by the “Battery Heater/Ionic Exciter System” from being passed to the “Electrically Powered Platform”. Such “High-Frequency Filter” elements are well known in the art and are used in many battery chargers and usually comprises a properly sized inductor and capacitor elements to lower the amplitude of the input high-frequency current to an acceptable level for the operation of the battery charger.

The operation of the system of embodiment 152 of FIG. 31 is controlled by the provided programmable microcontroller. The temperature of the battery being charged is measured by a provided temperature sensor, such as a well-known thermocouple or thermistor or the like, the output of which is provided to the microcontroller via an appropriate “temperature sensor circuit” shown in FIG. 31. The environmental temperature as measured by the indicated temperature sensor is also provided (usually via “Control Panel—if the sensor temperature sensor is located outside the battery housing, or as direct input to the microcontroller if the sensor is positioned inside the battery housing) and is used for setting an optimal process for the required battery heating as previously described. The system “Control Panel” provides the means for the user to turn the high frequency “Battery Heater/Ionic Exciter” system on and off and to set the operational requirements of the system, such as the operating temperature and its range, heating and charging rates, etc., examples of which were provided previously for the other embodiments of the present invention.

The system of embodiment 152 of FIG. 31 operates as follows. When the system is turned on for the first time, the user will use the provided system means described below, to set the applicable system parameters and select the provided operational options. The parameters to be provided may include the battery type, size, and all other pertinent characteristic information; heating temperature threshold and its acceptable range; acceptable heating and charging rate ranges; desired charging rate according to the time of day and weekdays; the option of charging without heating or heating without charging (which, may be selected when heating is required to keep a charged battery warm when needed), and any other applicable parameters and settings. It is appreciated that many or even all these parameters and options may be set by the equipment manufacturer or seller, particularly if it is purchased together with the equipment in which the battery is installed. In some applications, the system may be provided with a limited number of set of parameters preset options, for example for overnight charging and keeping or bringing the battery at its optimal temperature and fully charged by certain time in the morning for optimal operational performance and to maximize the battery life.

It is also appreciated by those skilled in the art that the above methods and means to input the required and desired heating parameters and operational options (i.e., initializing the system) are well known in the art. Other well-known methods, such as factory setting of all the parameters and options for the user and providing minimal user input, usually buttons and/or switches, for the user interaction with the embodiment 152 system, such as on/off switch, emergency shut-down button, “Battery Heater/Ionic-Exciter” on/off switch, etc., may also be provided on the system control panel, FIG. 31.

It is appreciated that in the block diagram of FIG. 31, the switch S4 is intended to indicate the means with which the system controller would activate/deactivate the “Battery Heater/Ionic-Exciter” component to supply high-frequency current to the battery as it was previously described. It is appreciated that as it was previously indicated, the “Battery Heater/Ionic-Exciter” component is powered by the battery.

Once the embodiment 152 system of FIG. 31 is initiated by setting all the required parameters and options as is described above, the user can turn the system on. Once the system is turned on, the software driven system microcontroller collects data as to the battery and battery environment temperatures and would close the switch S4 to activate the battery powered “Battery Heater/Ionic Exciter” to bring the battery temperature to the set temperature in cold temperatures and maintain it within the prescribed temperature limit as it was previously described.

It is appreciated that in certain applications, such as in electric vehicles, trucks, various mobile platforms, and the like, it is highly desirable to have the high-frequency direct battery electrolyte heating capability disclosed previously to be integrated into the battery or battery packs to eliminate the need for the electrically powered platform user having to go through the process of making the proper connections and having to ensure that the added components and their wiring are properly protected from damage during platform operation, and also in many cases, avoid the need for the user to properly attach temperature sensors and the like to the battery and test for their proper operation, etc. With such battery and battery pack integrated high-frequency direct battery electrolyte heating capability, the user only needs to install the battery as it has usually been done. For this reason, the battery/battery pack and all above-described components of embodiment 152 are packaged in a single housing 153 shown with dashed line in FIG. 31, hereinafter referred to as the “Integrated Self-Heating Battery”. The “Integrated Self-Heating Battery” would then have its terminals 154, which can be readily connected to the “Electrically Powered Platform” that it is intended to power via connectors 155 or through direct wiring or any other means known in the art.

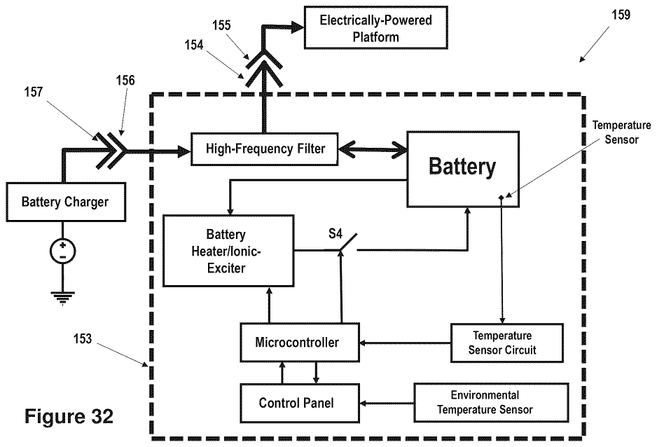

It is appreciated by those skilled in the art that in certain applications, particularly in heavy electrically powered equipment using large batteries, to charge the equipment battery, its connector 154, FIG. 31, connecting the battery to the platform connector 155 is disengaged and the charger connector is directly connected to the battery connector (154 in FIG. 31) for charging. However, in many applications, the battery stays connected to the “Electrically Powered Platform” as shown in the block diagram of FIG. 31, and the user only needs to connect the charger to the battery when it needs to bae charged. In such applications, the battery needs to be provided with the means of connecting it to the charger during its charging. The block diagram of such a configuration of the “Integrated Self-Heating Battery” of FIG. 31 is shown in FIG. 32, in which it is shown to be provided with a connection connector 156 for receiving the “Battery Charger” connector 157 and is indicated as the embodiment 159 of the present invention. It is appreciated that the charger is connected to the battery via the “High-Frequency Filter” so that the high-frequency heating current from the “Battery Heater/Ionic Exciter” would not interfere with the operation of the charger.

It is appreciated by those skilled in the art that in the block diagrams of FIG. 32 the connection of the “Integrated Self-Heating Battery” embodiment 159 to the “Electrically-Powered Platform” is usually done through direct wiring without the use of connectors 154 and 154, which are usually costly, occupy a relatively large volume and are prone to loss of corrosion and degradation of the current transmission, and in fact not usually necessary since the “Integrated Self-Heating Battery” components are only replaced when they have lost their operational effectiveness, which may happen after several years of platform service.

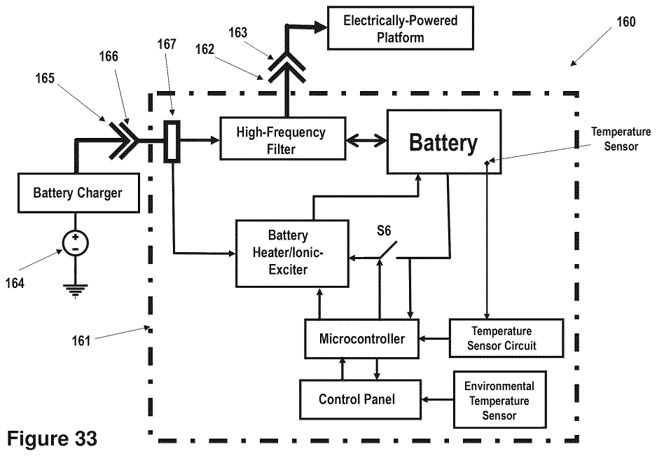

The “Battery Heater/Ionic Exciter” component of the “Integrated Self-Heating Battery” of FIG. 32 is seen to be powered directly by the battery. In some applications, however, the “Battery Heater/Ionic Exciter” component is desired to be powered by the external power, preferably via the “Battery Charger” as the charger is connected to the battery for its charging. One example of such applications are hybrid systems in which the platform is powered both electrically and by, for example, an internal combustion engine. Among other applications are platforms that are primarily powered by internal combustion engines or other sources of power but also use battery power to power many electrical and electronic components of the platform and which are provided by onboard internal combustion engine driven generators that keep the battery charged. FIG. 33 illustrates the block diagram of such a battery or battery pack with integrated externally powered high-frequency “Battery Heater/Ionic-Exciter”, which is hereinafter referred to as embodiment 160 of the present invention.

It is noted that in the battery with integrated “Battery Heater/Ionic Exciter” embodiment 159 of FIG. 32, whether it is used for the described “fast charging” of batteries or for charging batteries at significantly lower rates that is usually recommended by the battery manufacturer, the “Battery Heater/Ionic-Exciter” component of the embodiment is powered by the battery and not by an external power source. However, in an alternative design of embodiment 160 shown in the block diagram of FIG. 33, which is indicated as the “Battery with Integrated High-Frequency Electrolyte Heater” and as the embodiment 160 of the present invention, the “Battery Heater/Ionic-Exciter” component is shown to be capable of being powered by an external source, in this case provided by the battery charger connection, as well as the system battery. It is appreciated that in the block diagram of FIG. 33, the external power source of the “Battery Charger” may be line power, power from a generator of a vehicle or stationary internal combustion engine, power from solar or wind powered sources, etc.

It is appreciated that in the “Battery with Integrated High-Frequency Electrolyte Heater” embodiment 160 of FIG. 33, the “Battery Heater/Ionic Exciter” component is designed with effectively two separate circuits, one for operation with the external power source (when available), and one for being powered by the battery. The external source input may be designed for external source being an AC current (e.g., regular power line) or a DC current, for example, supplied by the “Battery Charger”, or other DC sources. It is appreciated that such circuits and their selection activation (usually performed by switching from system controller or the like) are well known in the art.

It is also appreciated that the system configuration of the embodiment 160 of FIG. 33 is designed to allow for “fast-charging” rates with minimal battery electrolyte heating as well as for direct battery electrolyte heating when the battery temperature is below its optimal charging temperature before (and during) charging and maintaining its temperature at its optimal level during charging and after charging, while the battery is being used to fully or partially power a mobile or stationary platform.

The battery system with high-frequency heating capability of embodiment 160 of FIG. 33 is seen to be comprised of a “Battery Heater/Ionic-Exciter” component, which was previously disclosed, is powered by externally provided power, in the block diagram configuration of FIG. 33 via the “Battery Charger” line, usually by an appropriate DC current. The system microcontroller, which is usually provided inside a control unit enclosure (not shown) with a control panel is also provided for controlling the operation of the system and setting all the required parameters for its operation as described later. An environmental temperature sensor, which may be positioned inside the battery enclosure (housing) 161, provides information as to the temperature of the environment within which the battery is located. The “Battery Charger” is powered by an external source.

It is appreciated by those skilled in the art that since most currently used battery chargers are not generally designed to filter high frequency currents from passing into their internal circuits, it is usually necessary to provide a “High-Frequency Filter” (a low-pass filter) as shown in FIG. 33 to prevent high-frequency current generated by the “Battery Heater/Ionic Exciter System” from interfering with the operation of the battery charger electronics and the “Electrically-Powered Platform” electrical, electronic and other electrically powered components. Such “High-Frequency Filter” elements are well known in the art and are used in many battery chargers and other systems and devices and usually comprise of properly sized inductor and capacitor elements to lower the amplitude of the input high-frequency current to an acceptable level for the operation of the powered battery, devices and platforms.

Similar to the “Fast-Charger System” embodiment 100 of FIG. 25, the “Battery Heater/Ionic-Exciter” member of the system of embodiment 160 of FIG. 33 operates in two different modes, a “Battery Heating Mode”, in which the current frequency is set at or close to its maximum heating rate, and a “Battery Ionic-Excitation Mode”, in which the current frequency is generally set at significantly lower heating rates, since the primary purpose of the applied high-frequency current is to generate “ionic-excitation” of the electrolyte ions, thereby as was previously indicated, to prevent/minimize damage to the battery (e.g., by Li plating in Li-ion batteries) with the application of high charging currents, such as 2C-3C or even higher.

It is appreciated by those skilled in the art that operation of the “Battery Heater/Ionic-Exciter” component in both above modes would result in the battery electrolyte heating and generate ionic-excitation, which is the main mechanism of battery electrolyte heating as was previously described. However, in the “Battery Heating Mode”, the heating rate of the battery electrolyte is maximized, while in the “Battery Ionic-Excitation Mode”, the battery electrolyte heating rate is attempted to be minimized.

The operation of the system of embodiment 160 of FIG. 33 is controlled by the provided programmable microcontroller. The temperature of the battery being charged is measured by a provided temperature sensor, such as a well-known thermocouple or thermistor or the like, the output of which is provided to the microcontroller via an appropriate “temperature sensor circuit” shown in FIG. 33. A temperature sensor is also provided for measuring environmental temperature of the battery and provide the information to the system controller for setting an optimal process for the required battery charging and heating as previously described. The system “Control Panel” provides the means for the user to turn the heating/ionic-exciter system on and off and to set the operational requirements of the system, such as the operating temperature and its range, heating rates, etc., examples of which were provided previously for the other embodiments of the present invention.

The system of embodiment 160 of FIG. 33 operates as follows. When the system is turned on for the first time, the user will use the provided system means described below, to set the system parameters and select the provided operational options. The parameters to be provided include the battery type, size, and all other pertinent characteristic information; heating temperature threshold and its acceptable range; acceptable heating and charging rate ranges; desired charging rate according to the time of day and weekdays; the option of charging without heating or heating without charging (which, may be selected when heating is required to keep a charged battery warm when needed). It is appreciated that many or even all these parameters and options may be set by the equipment manufacturer or seller, particularly if it is purchased together with the equipment (electrically powered platform or device) in which the battery is installed. In some applications, the system may be provided with a limited number of set of parameters preset options, for example for overnight charging and keeping or bringing the battery at its optimal temperature and fully charged by certain time in the morning for optimal operational performance and to maximize the battery life.

It is also appreciated by those skilled in the art that the above methods and means to input the required and desired charging and heating parameters and operational options (i.e., initializing the system) are well known in the art. Other well-known methods, such as factory setting of all the parameters and options for the user and providing minimal user input, usually buttons and/or switches, for the user interaction with the embodiment 160 system, such as on/off switch, emergency shut-down button, “Battery Heater/Ionic-Exciter” on/off switch, etc., may also be provided on the system control panel, FIG. 33.

It is appreciated that in the block diagram of FIG. 33, the microcontroller is powered by the system battery. The “Battery Charger” is powered by external power source 164 and gets connected by the user to the battery system embodiment 160 via connectors 165 and 166 of the charger and battery system, respectively. Element 167 in the battery system of embodiment 160 and those in the embodiments of FIGS. 28 and 29 are intended to show an electrical connection junction for supplying power to the “Battery Heater/Ionic-Exciter” component of the battery systems. Element 167 may also be provided with a microprocessor activated switch (not shown), which could be used by the control system to turn the “Battery Charger” on and off for optimal operation of the overall system.

The “Battery Heater/Ionic Exciter” is powered by external power when the “Battery Charger” is connected to the system as shown in FIG. 33. When the “Battery Charger” is not charging the battery, then the microcontroller closes the switch S6 to power the “Battery Heater/Ionic Exciter” when it is required to perform its function.

The output terminal of the battery system with high-frequency heating capability of embodiment 160 of FIG. 33 is connected to the battery via the provided “High-Frequency Filter” to prevent the high-frequency current generated by the “Battery Heater/Ionic-Exciter” from interfering with the electrical, electronic and other electrically powered components of the “Electrically-Powered Platform”. The “Electrically-Powered Platform” may be connected to the battery system embodiment 160 by direct wiring or via connector with components 162 and 163 on the battery system and platform sides, respectively.

Once the embodiment 160 system of FIG. 33 is initiated by setting all the required parameters and options as is described above, the user can turn the system on. Once the system is turned on, the software driven system microcontroller collects data as to the battery and battery environment temperatures, brings the battery temperature to its optimal charging temperature, and charges the battery as it was previously described for the “Fast-Charger System” embodiment 100 of FIG. 25 or at a lower rate specified by the battery manufacturer. It is appreciated that the high-frequency ionic-excitation of the “Battery Heater/Ionic-Exciter” may also be used with low rate charging to increase the life cycle of the battery.

Once the battery is charged to the prescribed level, if the optimal temperature maintenance option has been selected by the user, the system controller would monitor the battery temperature and would turn the “Battery Heater/Ionic-Exciter” on in its “Battery Heating Mode” when the battery temperature drops below the prescribed threshold and turns it off when the battery temperature reaches its prescribed upper limit threshold, as for example, shown in the plot of FIG. 16.

As it was previously indicated, “Battery Capacity” is a measure of the charge stored by the battery and is usually indicated in Amp-hr (Ah). The battery capacity represents the maximum amount of energy that can be extracted from the battery under certain specified conditions. However, the actual energy storage capabilities of the battery can vary significantly from the “nominal” rated capacity, as the battery capacity depends strongly on the age, past history of usage, charging and discharging rates of the battery and the temperature.

The charging/discharging rates affect the rated battery capacity. If the battery is discharged very rapidly, i.e., if the battery discharge current is high, then the amount of energy that can be extracted from the battery is reduced and the battery capacity would be lower. The actual mechanisms that contribute to this capacity reduction is not well known, but it can be said that in general, it occurs since the components that are required for the required reactions to occur do not necessarily have enough time and/or energy to their required positions. Therefore, only a fraction of the total reactants is converted to other forms, and therefore the energy that becomes available is reduced. Alternately, if the battery is discharged/charged at a very slow rate using a low current, more energy can be extracted from the battery and the battery capacity is higher.

The temperature of a battery will also affect the energy that can be extracted from it. At higher temperatures, the battery capacity is typically higher than at lower temperatures. However, intentionally elevating battery temperature is not an effective method to increase battery capacity as this also decreases battery lifetime.

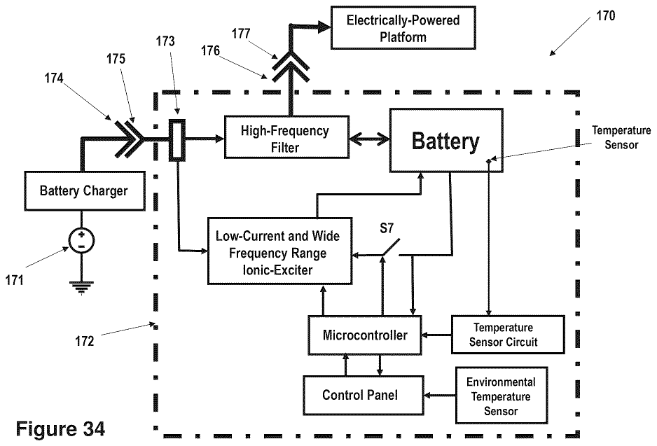

It is therefore highly desirable to have methods and systems that can be used to reduce the level of battery capacity reduction due to higher charge and discharge rates. FIG. 34 illustrates the block diagram of a battery or battery pack that describes the method and means of reducing battery capacity loss due to higher rates of battery charge and discharge. This embodiment is identified as embodiment 170 of the present invention.

The battery system embodiment 170 of FIG. 34 is seen to be comprised of a “Low-Current and Wide Frequency Range Ionic-Exciter” component, which is either powered by an external power source, in the block diagram configuration of FIG. 34 via the “Battery Charger” line, usually by an appropriate DC current. The system microcontroller, which is usually provided inside a control unit enclosure (not shown) with a control panel is also provided for controlling the operation of the system and setting all the required parameters for its operation as described later. An environmental temperature sensor, which may be positioned inside the battery enclosure (housing) 172, provides information as to the temperature of the environment within which the battery is located. The “Battery Charger” is powered by an external source 171.

In the battery system embodiment 170 of FIG. 34, the “Low-Current and Wide Frequency Range Ionic-Exciter” component may be fabricated in three different design options. In all the three design options, the generated high-frequency AC current (with no DC current) is still high enough to effectively “short” the capacitance between the battery electrodes to effectively isolate the electrochemical mechanism of the battery as has been previously described. The three design options are different primarily in their source of operating electrical power but are all designed to provide a relatively wide range of high-frequency low amplitude AC current to the system battery. The three “Low-Current and Wide Frequency Range Ionic-Exciter” design options are as follows:
1—OPTION ONE: In this version of embodiment 170 of FIG. 34, the “Low-Current and Wide Frequency Range Ionic-Exciter” is designed to operate with external power, which is usually provided through the “Battery Charger” connection member 173. The “Low-Current and Wide Frequency Range Ionic-Exciter” may be designed as shown in FIGS. 13 and 13A or other similar circuitry, except that the circuit must be provided with the means that would allow the system microcontroller to vary the frequency of the generated high-frequency AC current and its amplitude to minimize the generated battery heating level while providing the required frequency of the electrolyte ionic excitation level. Methods to design such capabilities in such circuits are well known in the art. It is appreciated that since the required frequency of the high-frequency AC current and its amplitude would be dependent on the size and type of the battery and its construction, their proper optimal range is generally determined experimentally. In addition, with this option, the switch S7 is no longer required. It is appreciated that the external power source may supply AC current (e.g., from the line power) or DC current (e.g., from the “Battery Charger”) as previously described.
   It is appreciated by those skilled in the art that an embodiment 170 with the above “OPTION ONE” “Low-Current and Wide Frequency Range Ionic-Exciter” would not have the capability of providing the generated high-frequency AC current to the battery without the external power, i.e., most of the time while it is in service and powering a mobile or stationary “Electrically-Powered Platform”, which would generally have the benefits of providing higher battery capacity and increased battery life cycle.
      a. Then, while charging the battery, the microprocessor turns on the “Low-Current and Wide Frequency Range Ionic-Exciter” to:
         i. Reduce the level of reduction in the battery cycle life at any charging rate;
         ii. Reduce the level of reduction in the battery cycle life at higher charging rates;
         iii. Reduce the level of reduction in the battery cycle life even if the battery temperature is significantly lower than its optimal level;
         iv. Allow for higher charging rates with less reduction in the battery capacity.
2. OPTION TWO: In this version of embodiment 170 of FIG. 34, the “Low-Current and Wide Frequency Range Ionic-Exciter” is designed to operate with battery power (in a self-powered mode for the embodiment). The “Low-Current and Wide Frequency Range Ionic-Exciter” does not therefore require connection to the junction box 173 to receive power from the external source. The “Low-Current and Wide Frequency Range Ionic-Exciter” may be designed as shown in FIG. 14 or other similar circuitry, except that the circuit must be provided with the means that would allow the system microcontroller to vary the frequency of the generated high-frequency AC current and its amplitude to minimize the generated battery heating level while providing the required frequency of the electrolyte ionic excitation level. Methods to design such capabilities in such circuits are well known in the art. It is appreciated that since the required frequency of the high-frequency AC current and its amplitude would be dependent on the size and type of the battery and its construction, their proper optimal range is generally determined experimentally. One shortcoming of this option is that the battery must have enough power initially to operate the “Low-Current and Wide Frequency Range Ionic-Exciter” when it is turned on.
   a. Then, while charging the battery and/or while the battery is powering the “Electrically-Powered Platform” (no charging), the microprocessor turns on the “Low-Current and Wide Frequency Range Ionic-Exciter” by closing the switch S7 and allowing it to generate the prescribed high-frequency and AC current to:
      i. Reduce the level of reduction in the battery cycle life at any charging and discharging rates;
      ii. Reduce the level of reduction in the battery cycle life at higher charging and discharging rates;
      iii. Reduce the level of reduction in the battery cycle life even if the battery temperature is significantly lower than its optimal level as it is charged or discharged;
      iv. Allow for higher charging and discharging rates with less reduction in the battery capacity.
3. OPTION THREE: In this version of embodiment 170, the “Low-Current and Wide Frequency Range Ionic-Exciter” is designed to operate with either external power (when available) or with battery power. In this option, the “Low-Current and Wide Frequency Range Ionic-Exciter” is designed as a combination of two separate circuits, one for operation with externally provided power as described for OPTION ONE above, and one for operation with battery power as described for OPTION TWO above. The microprocessor would then select external powering option when available, otherwise would close switch S7 to power the “Low-Current and Wide Frequency Range Ionic-Exciter” by the battery. Methods to design such capabilities in such circuits are well known in the art. It is appreciated that since the required frequency of the high-frequency AC current and its amplitude would be dependent on the size and type of the battery and its construction, their proper optimal range is generally determined experimentally. The advantage of the embodiment 170 that is constructed with this option is that the battery can be charged with the active “Low-Current and Wide Frequency Range Ionic-Exciter” using external power and while the system is powering the “Electrically-Powered Platform” and external power (line power or onboard charger power) is not available, the “Low-Current and Wide Frequency Range Ionic-Exciter” would still provide the high-frequency AC current to the battery using battery power. It is appreciated that this is achieved at the expense of having two high-frequency AC current generator circuits for each mode of its operation (i.e., external powered and battery powered modes).
   a. Then, while charging the battery and/or while the battery is powering the “Electrically-Powered Platform” (no charging), the microprocessor turns on the “Low-Current and Wide Frequency Range Ionic-Exciter” as described above and allow it to generate the prescribed high-frequency and AC current to:
      i. Reduce the level of reduction in the battery cycle life at any charging and discharging rates;
      ii. Reduce the level of reduction in the battery cycle life at higher charging and discharging rates;
      iii. Reduce the level of reduction in the battery cycle life even if the battery temperature is significantly lower than its optimal level as it is charged or discharged;
      iv. Allow for higher charging and discharging rates with less reduction in the battery capacity

It is appreciated by those skilled in the art that since most currently used battery chargers are not generally designed to filter high frequency currents from passing into their internal circuits, it is usually necessary to provide a “High-Frequency Filter” (a low-pass filter) as shown in FIG. 34 to prevent high-frequency current generated by the “Low-Current and Wide Frequency Range Ionic-Exciter” from interfering with the operation of the battery charger electronics and the “Electrically-Powered Platform” electrical, electronic and other electrically powered components. Such “High-Frequency Filter” elements are well known in the art and are used in many battery chargers and other systems and devices, and usually comprise of properly sized inductor and capacitor elements to lower the amplitude of the input high-frequency current to an acceptable level for the operation of the powered battery, devices and platforms.

The operation of the system of embodiment 170 of FIG. 34 is controlled by the provided programmable microcontroller. The temperature of the battery being charged is measured by a provided temperature sensor, such as a well-known thermocouple or thermistor or the like, the output of which is provided to the microcontroller via an appropriate “temperature sensor circuit” shown in FIG. 34. A temperature sensor is also provided for measuring environmental temperature of the battery and provide the information to the system controller for setting an optimal process for the required battery charging. The system “Control Panel” provides the means for the user to turn the “Low-Current and Wide Frequency Range Ionic-Exciter” on and off and to set the operational requirements of the system as is described later.

The system of embodiment 170 of FIG. 34 operates as follows. When the system is turned on for the first time, the user will use the provided system means described below, to set the system parameters and select the provided operational options. The parameters to be provided include the battery type, size, and all other pertinent characteristic information. It is appreciated that many or even all these parameters and options may be set by the equipment manufacturer or seller, particularly if it is purchased together with the equipment (electrically powered platform or device) in which the battery is installed. In some applications, the system may be provided with a limited number of set of parameters preset options, for example for overnight charging and keeping or bringing the battery at its optimal temperature and fully charged by certain time in the morning for optimal operational performance and to maximize the battery life.

It is also appreciated by those skilled in the art that the above methods and means to input the required and desired charging and heating parameters and operational options (i.e., initializing the system) are well known in the art. Other well-known methods, such as factory setting of all the parameters and options for the user and providing minimal user input, usually buttons and/or switches, for the user interaction with the embodiment 170 system, such as on/off switch, emergency shut-down button, “Low-Current and Wide Frequency Range Ionic-Exciter” on/off switch, etc., may also be provided on the system control panel, FIG. 34.

It is appreciated that in the block diagram of FIG. 34, the microcontroller is powered by the system battery. The “Battery Charger” is powered by external power source 171 and gets connected by the user to the battery system embodiment 170 via connectors 174 and 175 of the charger and battery system, respectively. Element 173 in the battery system is intended to show an electrical connection junction for supplying power to the “Low-Current and Wide Frequency Range Ionic-Exciter” component of the battery systems. Element 173 may also be provided with a microprocessor activated switch (not shown), which could be used by the control system to turn the “Battery Charger” on and off for optimal operation of the overall system.

The “Low-Current and Wide Frequency Range Ionic-Exciter” component of the system of embodiment 170 of FIG. 34 is powered by external power when the “Battery Charger” is connected to the system as shown in FIG. 34. When the “Battery Charger” is not charging the battery, then the microcontroller closes the switch S7 to power the “Low-Current and Wide Frequency Range Ionic-Exciter” when it is required to perform its function.

The output terminal of the battery system embodiment 170 of FIG. 34 is connected to the battery via the provided “High-Frequency Filter” to prevent the high-frequency current generated by the “Low-Current and Wide Frequency Range Ionic-Exciter” from interfering with the electrical, electronic and other electrically powered components of the “Electrically-Powered Platform” and the “Battery Charger”. The “Electrically-Powered Platform” may be connected to the battery system embodiment 170 by direct wiring or via connector with components 176 and 177 on the battery system and platform sides, respectively.

With the embodiment 170 system of FIG. 34 equipped with aforementioned “OPTION ONE” of “Low-Current and Wide Frequency Range Ionic-Exciter”, following setting of all the required parameters and options as is described above, the user can turn the system on to charge the battery fully or to a prescribed level. Once the system is turned on, the software driven system microcontroller collects data as to the battery and battery environment temperatures, activate the “Low-Current and Wide Frequency Range Ionic-Exciter” to begin to supply the prescribed high-frequency and relatively low amplitude AC current to the battery. The “Battery Charger” would then charge the battery to the prescribed level, at which time the system microprocessor would stop the “Low-Current and Wide Frequency Range Ionic-Exciter” from generating the above high-frequency low amplitude AC current.

With the embodiment 170 system of FIG. 34 equipped with aforementioned “OPTION TWO” of “Low-Current and Wide Frequency Range Ionic-Exciter”, following setting of all the required parameters and options as is described above, the user can turn the system on to charge the battery fully or to a prescribed level or to apply high-frequency AC current to the battery. Once the system is turned on, the software driven system microcontroller collects data as to the battery and battery environment temperatures, closes the switch S7 and activate the “Low-Current and Wide Frequency Range Ionic-Exciter” to begin to supply the prescribed high-frequency and relatively low amplitude AC current to the battery. Then, if the only purpose is to charge the battery, the “Battery Charger” is activated to charge the battery to the prescribed level, at which time the system microprocessor would stop the “Low-Current and Wide Frequency Range Ionic-Exciter” from generating the above high-frequency low amplitude AC current. If the system is used only for powering the “Electrically-Powered Platform”, then the system microprocessor activates the “Low-Current and Wide Frequency Range Ionic-Exciter” to begin to supply the prescribed high-frequency and relatively low amplitude AC current to the battery as the platform begins to draw power from the battery. If the system is used for charging the battery as well as powering the “Electrically-Powered Platform”, then the system microprocessor activates the “Low-Current and Wide Frequency Range Ionic-Exciter” to begin to supply the prescribed high-frequency and relatively low amplitude AC current to the battery when the charger is in the process of charging the battery and/or the platform is drawing power from the battery.

With the embodiment 170 system of FIG. 34 equipped with aforementioned “OPTION THREE” of “Low-Current and Wide Frequency Range Ionic-Exciter”, following setting of all the required parameters and options as is described above, the user can turn the system on to charge the battery fully or to a prescribed level or to apply high-frequency AC current to the battery. Once the system is turned on, the software driven system microcontroller collects data as to the battery and battery environment temperatures, and selects external powering option when available, otherwise closes switch S7 to power the “Low-Current and Wide Frequency Range Ionic-Exciter” by the battery to begin to supply the prescribed high-frequency and relatively low amplitude AC current to the battery. Then, if the only purpose is to charge the battery, the “Battery Charger” is activated to charge the battery to the prescribed level, at which time the system microprocessor would stop the “Low-Current and Wide Frequency Range Ionic-Exciter” from generating the above high-frequency low amplitude AC current. If the system is used only for powering the “Electrically-Powered Platform”, then the system microprocessor activates the “Low-Current and Wide Frequency Range Ionic-Exciter” to begin to supply the prescribed high-frequency and relatively low amplitude AC current to the battery as the platform begins to draw power from the battery. If the system is used for charging the battery as well as powering the “Electrically-Powered Platform”, then the system microprocessor activates the “Low-Current and Wide Frequency Range Ionic-Exciter” to begin to supply the prescribed high-frequency and relatively low amplitude AC current to the battery when the charger is in the process of charging the battery and/or the platform is drawing power from the battery.

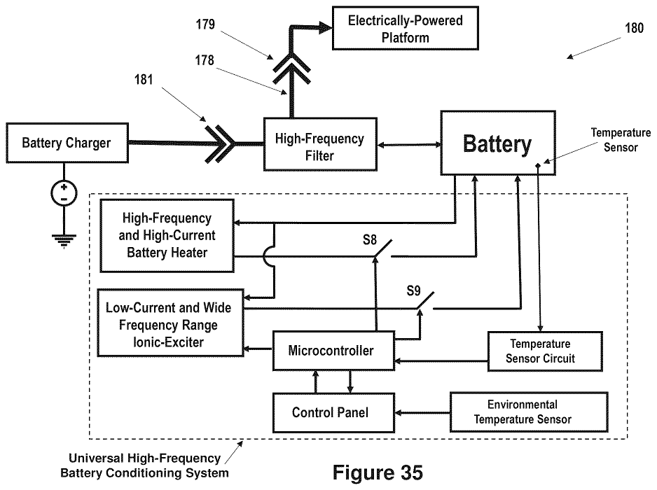

It is also appreciated that it is highly desirable to have systems that would allow charging batteries and battery packs at low temperatures by providing the means of heating the batteries to their optimal charging temperature range and then charging them while maintaining their temperature at or close to their optimal charging temperature range, including at high charging rates (fast charging rates), and also provide the means of applying high-frequency with relatively low amplitude AC currents to the batteries and battery packs during charging as well or battery power, for the purpose of increasing battery life and increasing capacity at high charge/discharge rates. The system may be a stand-alone system that is then connected to the platform battery/battery-pack or may be integrated into the battery/battery-pack. FIG. 35 illustrates the block diagram of such a stand-alone system in which the high-frequency AC current generation components are battery powered. The system is hereinafter referred to as the “Universal High-Frequency Battery Conditioning System” embodiment 180 of the present invention.

The “Universal High-Frequency Battery Conditioning System” embodiment 180 of FIG. 35 is seen to be comprised of a currently available and regularly used “Battery Charger” component and a “Universal High-Frequency Battery Conditioning System” component, shown with dashed lines. The “Universal High-Frequency Battery Conditioning System” component comprises the “High-Frequency and High-Current Battery Heater” component, which may be designed as described by FIGS. 13 and 13A, and the “Low-Current and Wide Frequency Range Ionic-Exciter” component, which was previously disclosed and are designed to provide appropriate high-frequency currents to the battery electrolyte and which are powered by the system battery. The system microcontroller, which is usually provided inside a control unit enclosure (not shown) with a control panel, is also provided for controlling the operation of the system and setting all the required parameters for its operation as described later. An environmental temperature sensor, which may be positioned inside the control unit enclosure or the “Universal High-Frequency Battery Conditioning System” enclosure (shown by dashed line) in FIG. 35 or outside of it and close to the battery, provides information as to the temperature of the environment within which the battery is located. The “Battery Charger” is powered by an external source.

It is appreciated by those skilled in the art that since most currently used battery chargers are not generally designed to filter high frequency currents from passing into its internal circuits, it is usually necessary to provide a “High-Frequency Filter”, FIG. 35, at the output of the battery charger to prevent high-frequency current generated by the “Universal High-Frequency Battery Conditioning System” from interfering with the operation of the battery charger electronics. Such “High-Frequency Filter” elements are well known in the art and are used in many battery chargers and usually comprises a properly sized inductor and capacitor elements to lower the amplitude of the input high-frequency current to an acceptable level for the operation of the battery charger.

In addition, to prevent the high-frequency current from interfering with the operation of the electrical, electronic and other components of the “Electrically-Powered Platform” that is powered by the battery of the system embodiment 180 of FIG. 35, the battery output to the “Electrically-Powered Platform” is made via the “High-Frequency Filter” through connectors 178 and 179, so that the high-frequency current generated by the “High-Frequency and High-Current Battery Heater” and the “Low-Current and Wide Frequency Range Ionic-Exciter” components are filtered from the input to the “Electrically-Powered Platform”.

Similar to the embodiment 170 of FIG. 34, the “Low-Current and Wide Frequency Range Ionic-Exciter” component of the embodiment 180 of FIG. 35 is designed to generate AC current at relatively low levels and at frequencies that may be significantly lower than those used for battery heating, since the primary purpose of the applied high-frequency current is to generate “ionic-excitation” of the battery electrolyte ions, thereby as was previously indicated, to prevent/minimize damage to the battery, i.e., increase battery cycle life, and to increase battery capacity in charge/discharge at relatively high rates. In the system of embodiment 180 of FIG. 35, the “Low-Current and Wide Frequency Range Ionic-Exciter” component is designed with the capability of its generated high-frequency AC current frequency and peak value to be adjustable by the programable microcontroller.

In addition, similar to the “Fast-Charger System” embodiment 100 of FIG. 25, the “High-Frequency and High-Current Battery Heater” component of the system of embodiment 180 of FIG. 35 may be designed as shown in the schematic of FIG. 14, is powered by the battery, and is designed to provide high-frequency current for heating the battery at high rates, in which the current level and frequency are usually set to achieve maximum or close to maximum heating rate. In the system of embodiment 180, the “High-Frequency and High-Current Battery Heater” is usually designed to provide an adjustable range of high-frequency current but at a single (or at most a very few” preset peak current levels) to greatly simplify its design and its operational efficiency.

It is appreciated that in the “Universal High-Frequency Battery Conditioning System” embodiment 180 of FIG. 35, the “High-Frequency and High-Current Battery Heater” and the “Low-Current and Wide Frequency Range Ionic-Exciter” components of the system are still designed to operate at high enough frequencies that would effectively “short” the capacitance between the battery electrodes to effectively isolate the electrochemical mechanism of the battery as has been previously described.

It is appreciated by those skilled in the art that operation of the “Low-Current and Wide Frequency Range Ionic-Exciter” component would result in a certain amount low-rate battery heating, which must be considered, particularly for operation in environments with temperatures that are significantly above room temperature.

The operation of the system of embodiment 180 of FIG. 35 is controlled by the provided programmable microcontroller. The temperature of the battery being charged is measured by a provided temperature sensor, such as a well-known thermocouple or thermistor or the like, the output of which is provided to the microcontroller via an appropriate “temperature sensor circuit” shown in FIG. 35. A temperature sensor is also provided for measuring environmental temperature of the battery and provide the information to the system controller for setting an optimal process for the required battery charging, heating and ionic excitation as previously described. The system “Control Panel” provides the means for the user to turn the system on and off and to set the operational requirements of the system, such as the operating temperature and its range, heating and charging rates, charge/discharge rates, etc., examples of which were provided previously for the other embodiments of the present invention.

The system of embodiment 180 of FIG. 35 operates as follows. When the system is turned on for the first time, the user will use the provided system means described below, to set the system parameters and select the provided operational options. The parameters to be provided include the battery type, size, and all other pertinent characteristic information; heating temperature threshold and its acceptable range; acceptable heating and charging rate ranges; desired charging rate according to the time of day and weekdays; the option of charging without heating or heating without charging (which, may be selected when heating is required to keep a charged battery warm when needed). It is appreciated that many or even all these parameters and options may be set by the equipment manufacturer or seller, particularly if it is purchased together with the equipment in which the battery is installed. In some applications, the system may be provided with a limited number of set of parameters preset options, for example for overnight charging and keeping or bringing the battery at its optimal temperature and fully charged by certain time in the morning for optimal operational performance and to maximize the battery life.

It is also appreciated by those skilled in the art that both the above methods and means to input the required and desired charging and heating parameters and operational options (i.e., initializing the system) are well known in the art. Other well-known methods, such as factory setting of all the parameters and options for the user and providing minimal user input, usually buttons and/or switches, for the user interaction with the embodiment 180 system, such as on/off switch, emergency shut-down button, “High-Frequency and High-Current Battery Heater” and “Low-Current and Wide Frequency Range Ionic-Exciter” on/off switch, etc., may also be provided on the system control panel, FIG. 35. In addition, all or part of such parameter and operational settings may be set through a wireless connection using provided apps.

It is appreciated that in the block diagram of FIG. 35, the switches S8 and S9 are intended to indicate the means with which the system controller residing in the microcontroller would activate/deactivate the “High-Frequency and High-Current Battery Heater” and “Low-Current and Wide Frequency Range Ionic-Exciter” components, respectively, to supply high-frequency current to the battery as it was previously described. It is appreciated that as it was previously indicated, the “High-Frequency and High-Current Battery Heater” and “Low-Current and Wide Frequency Range Ionic-Exciter” components are powered by the battery. In addition, in the block diagram of FIG. 35, the “Battery Charger” is considered to be connected/disconnected to the system “High-Frequency Filter” by the user via the connectors 181. It is appreciated that in applications in which the platform is provided with other electrical power generator types, for example by solar powered generators or an internal combustion engine powered generator, etc., then these chargers would similarly be connected to the system through the connector 181.

Once the embodiment 180 system of FIG. 35 is initiated by setting all the required parameters and options as is described above, the user can turn the system on. Once the system is turned on, the software driven system microcontroller collects data as to the battery and battery environment temperatures and:
If the battery temperature is below its optimal charging range, it would close the switch S8 and start the process of heating the battery to its optimal charging temperature range,
Microcontroller will then open the switch S8 and close switch S9 and activate the “Battery Charger” to begin to charge the battery, while the high-frequency and low-current AC generated by the “Low-Current and Wide Frequency Range Ionic-Exciter” helps to increase battery capacity as well as improve the battery cycle life. Then once the battery is charged fully or to the prescribed level, the “Battery Charger” is turned off. Then:
   If the battery is or is about to power the “Electrically-Powered Platform”, then the switch S9 is left closed and the “Low-Current and Wide Frequency Range Ionic-Exciter” continues to supply its generated high-frequency and low-current AC to the battery to increase the battery capacity and improve the battery cycle life, particularly if the rate of discharge is relatively high.
   If the battery is not going to power the “Electrically-Powered Platform”, then the microcontroller would open the switch S9 and end the supply of high-frequency and low-current AC to the battery.

It is appreciated that with the battery partially or fully charged, the system of embodiment 180 of FIG. 35 can be activated at any time, upon which the microcontroller is usually programmed to close the switch S9 to allow the “Low-Current and Wide Frequency Range Ionic-Exciter” to generate high-frequency and low-current AC and supply it to the battery to increase the battery capacity and improve the battery cycle life, particularly if the rate of discharge is relatively high, unless the user has turn this feature of the system off.

Once the battery is charged to the prescribed level, if the optimal temperature maintenance option has been selected by the user, the system controller would monitor the battery temperature and would turn the “High-Frequency and High-Current Battery Heater” on when the battery temperature drops below the prescribed threshold and turns it off when the battery temperature reaches its prescribed upper limit threshold, as for example, shown in the plot of FIG. 16.

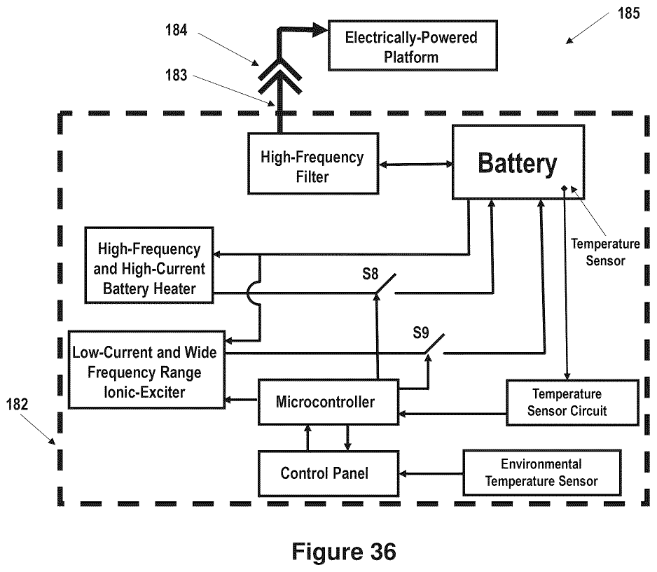

It is appreciated that in certain applications, such as in electric vehicles, trucks, various mobile platforms, and the like, it is highly desirable to have the high-frequency direct battery electrolyte heating capability disclosed previously to be integrated into the battery or battery packs to eliminate the need for the electrically powered platform user having to go through the process of making the proper connections and having to ensure that the added components and their wiring are properly protected from damage during platform operation, and also in many cases, avoid the need for the user to properly attach temperature sensors and the like to the battery and test for their proper operation, etc. With such battery and battery pack integrated high-frequency direct battery electrolyte heating capability, the user only needs to install the battery as it has usually been done. FIG. 36 illustrates the block diagram of such a battery or battery pack with integrated system of the embodiment 180 of FIG. 35 and is hereinafter referred to as the embodiment 185 of the present invention, which is hereinafter referred to as the “Battery with Integrated Universal Conditioner”.

It is appreciated that the battery and battery pack system embodiment 185 of FIG. 36 with integrated high-frequency battery conditioning component capabilities is designed for powering electrically powered platforms during service, i.e., when it is not being charged by an externally powered “Battery Charger”, FIG. 35, and while maintaining the battery temperature at or close to its optimal operating temperature range so that the battery and battery pack can provide its peak power to the fully or partially powered mobile or stationary platform and also supply high-frequency and relatively low AC current to increase battery capacity and cycle life, particularly during relatively fast discharge. It is appreciated that in applications in which the platform is provided with other electrical power generators, for example by solar powered generators or an internal combustion engine powered generator, etc., then these chargers would continue to charge the battery while the system of embodiment 180 maintain battery temperature within its prescribed operational temperature range.

The “Battery with Integrated Universal Conditioner” system of embodiment 185 of FIG. 36 is seen to be comprised of the “High-Frequency and High-Current Battery Heater” component, which may be designed as described by FIGS. 13 and 13A, and the “Low-Current and Wide Frequency Range Ionic-Exciter” component, which was previously disclosed and are designed to provide appropriate high-frequency currents to the battery electrolyte and which are powered by the system battery. The system microcontroller, which is usually provided inside a control unit enclosure (not shown) with a control panel, is also provided for controlling the operation of the system and setting all the required parameters for its operation as described later. An environmental temperature sensor, which may be positioned inside the control unit enclosure (not shown) or the “Battery with Integrated Universal Conditioner” enclosure 182 (shown by dashed line) or outside of it, provides information as to the temperature of the environment within which the “Battery with Integrated Universal Conditioner” system is located.

It is appreciated by those skilled in the art that since most electrically powered platforms may not be designed to filter high frequency input currents from passing into its internal circuits, it is usually necessary to provide a “High-Frequency Filter”, FIG. 36, at the output of the battery to prevent high-frequency current generated by the “High-Frequency and High-Current Battery Heater” and “Low-Current and Wide Frequency Range Ionic-Exciter” components of the “Battery with Integrated Universal Conditioner” system from interfering with their operation. The “Electrically-Powered Platform” that is powered by the battery of the system embodiment 185 of FIG. 36 is then connected to the system battery via the “High-Frequency Filter” through connectors 183 and 184, FIG. 36, so that “High-Frequency and High-Current Battery Heater” and “Low-Current and Wide Frequency Range Ionic-Exciter” components of the “Battery with Integrated Universal Conditioner” system would not interfere with the operation of the “Electrically-Powered Platform”.

It is appreciated that such “High-Frequency Filter” elements are well known in the art and are used in many battery chargers and usually comprises a properly sized inductor and capacitor elements to lower the amplitude of the input high-frequency current to an acceptable level for the operation of the battery chargers and various electrically powered platforms.

Similar to the embodiment 170 of FIG. 34, the “Low-Current and Wide Frequency Range Ionic-Exciter” component of the embodiment 185 of FIG. 36 is designed to generate AC current at relatively low levels and at frequencies that may be significantly lower than those used for battery heating, since the primary purpose of the applied high-frequency current is to generate “ionic-excitation” of the battery electrolyte ions, thereby as was previously indicated, to prevent/minimize damage to the battery, i.e., increase battery cycle life, and to increase battery capacity in charge/discharge at relatively high rates. In the system of embodiment 185 of FIG. 36, the “Low-Current and Wide Frequency Range Ionic-Exciter” component is designed with the capability of its generated high-frequency AC current frequency and peak value to be adjustable by the programable microcontroller.

In addition, similar to the “Fast-Charger System” embodiment 100 of FIG. 25, the “High-Frequency and High-Current Battery Heater” component of the system of embodiment 185 of FIG. 36 may be designed as shown in the schematic of FIG. 14, is powered by the battery, and is designed to provide high-frequency current for heating the battery at high rates, in which the current level and frequency are usually set to achieve maximum or close to maximum heating rate. In the system of embodiment 185, the “High-Frequency and High-Current Battery Heater” is usually designed to provide an adjustable range of high-frequency current but at a single (or at most a very few” preset peak current levels) to greatly simplify its design and its operational efficiency.

It is appreciated that in the “Battery with Integrated Universal Conditioner” system of embodiment 185 of FIG. 36, the “High-Frequency and High-Current Battery Heater” and the “Low-Current and Wide Frequency Range Ionic-Exciter” components of the system are still designed to operate at high enough frequencies that would effectively “short” the capacitance between the battery electrodes to effectively isolate the electrochemical mechanism of the battery as has been previously described.

It is appreciated by those skilled in the art that operation of the “Low-Current and Wide Frequency Range Ionic-Exciter” component would result in a certain amount low-rate battery heating, which must be considered, particularly for operation in environments with temperatures that are significantly above room temperature.

The operation of the system of embodiment 185 of FIG. 36 is controlled by the provided programmable microcontroller. The temperature of the battery being charged is measured by a provided temperature sensor, such as a well-known thermocouple or thermistor or the like, the output of which is provided to the microcontroller via an appropriate “temperature sensor circuit” shown in FIG. 36. A temperature sensor is also provided for measuring environmental temperature of the battery and provide the information to the system controller for setting an optimal process for battery heating and ionic excitation as previously described. The system “Control Panel” provides the means for the user to turn the system on and off and to set the operational requirements of the system, such as the operating temperature and its range, heating rates, discharge rates, etc., examples of which were provided previously for the other embodiments of the present invention.

The system of embodiment 185 of FIG. 36 operates as follows. When the system is turned on for the first time, the user will use the provided system means described below, to set the system parameters and select the provided operational options. The parameters to be provided include the battery type, size, and all other pertinent characteristic information; heating temperature threshold and its acceptable range; acceptable heating and discharging rate ranges; the option of discharging without heating, etc. It is appreciated that many or even all these parameters and options may be set by the equipment manufacturer or seller, particularly if it is purchased together with the equipment in which the battery is installed. In some applications, the system may be provided with a limited number of set of parameters preset options, for setting a certain time at which the battery is to be at its optimal temperature for platform operation.

It is also appreciated by those skilled in the art that both the above methods and means to input the required settings, heating parameters and operational options (i.e., initializing the system) are well known in the art. Other well-known methods, such as factory setting of all the parameters and options for the user and providing minimal user input, usually buttons and/or switches, for the user interaction with the embodiment 185 system, such as on/off switch, emergency shut-down button, “High-Frequency and High-Current Battery Heater” and “Low-Current and Wide Frequency Range Ionic-Exciter” on/off switch, etc., may also be provided on the system control panel, FIG. 36. In addition, all or part of such parameter and operational settings may be set through a wireless connection using provided apps.

It is appreciated that in the block diagram of FIG. 36, the switches S8 and S9 are intended to indicate the means with which the system controller residing in the microcontroller would activate/deactivate the “High-Frequency and High-Current Battery Heater” and “Low-Current and Wide Frequency Range Ionic-Exciter” components, respectively, to supply high-frequency current to the battery as it was previously described. It is appreciated that as it was previously indicated, the “High-Frequency and High-Current Battery Heater” and “Low-Current and Wide Frequency Range Ionic-Exciter” components are powered by the battery.

Once the embodiment 185 system of FIG. 36 is initiated by setting all the required parameters and options as is described above, the user can turn the system on. Once the system is turned on, the software driven system microcontroller collects data as to the battery and battery environment temperatures and:
If the battery temperature is below its optimal operational temperature, then:
   If the battery has enough available electrical energy to heat the battery to its prescribed operating temperature and have enough to then continue its operational mission, then the system controller would close the switch S8 and start the process of heating the battery to its optimal operational temperature; and then
      The system controller will then open the switch S8 and close switch S9 and allow the battery to power the “Electrically-Powered Platform” while the high-frequency and low-current AC generated by the “Low-Current and Wide Frequency Range Ionic-Exciter” helps to increase battery capacity as well as improve the battery cycle life. The above battery heating may be resumed at any time to maintain the battery temperature close to its optimal operational temperature.
   If the battery does not have enough available electrical energy, it would notify the user (via the system control panel or other commonly used methods in the art) that the battery needs to be charged before being used and the consequences of being used without charging, for example, reducing the life of the battery or causing significant battery damage or failure if the battery temperature is too low.
If the battery temperature is within its optimal operational temperature range, then the system controller would close the switch S9 and allow the battery to power the “Electrically-Powered Platform” while the high-frequency and low-current AC generated by the “Low-Current and Wide Frequency Range Ionic-Exciter” helps to increase battery capacity as well as improve the battery cycle life. In the meantime, the aforementioned battery heating process may be initiated by closing the switch S8 at any time to maintain the battery temperature close to its optimal operational temperature.

It is appreciated that with the battery partially or fully charged, the system of embodiment 185 of FIG. 36 may be activated at any time, upon which the microcontroller is usually programmed to close the switch S9 to allow the “Low-Current and Wide Frequency Range Ionic-Exciter” to generate high-frequency and low-current AC and supply it to the battery to increase the battery capacity and improve the battery cycle life, particularly if the rate of discharge is relatively high, unless the user has turn this feature of the system off.

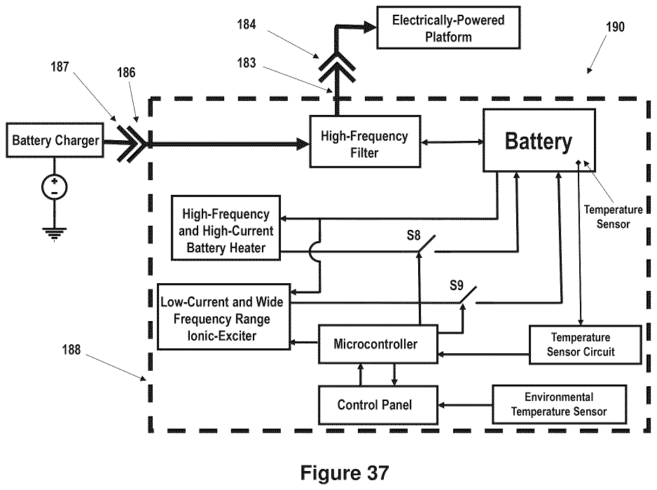

It is appreciated that the battery of the “Battery with Integrated Universal Conditioner” system of embodiment 185 of FIG. 36 has to be charged as its stored electrical energy drops while powering a “Electrically-Powered Platform” and due to natural loss of energy over time due to inevitable leakage. In certain applications, due to various reasons, such as electrical and electronic considerations, safety, logistics, etc. reasons, the “Electrically-Powered Platform” is designed to require the user to disengage the battery (in this case the “Battery with Integrated Universal Conditioner”) by disengaging the connectors 183 and 184, and connecting the “Battery Charger” connector to the connector 183 of the “Electrically-Powered Platform”. In other applications, the output of the battery of the “Battery with Integrated Universal Conditioner” system (located at the connector 183 in FIG. 36) is hard wired to the “Electrically-Powered Platform” or the connectors 183 and 184 are desired not to be disengaged each time that the battery needs to be charges, and therefore a separate input port is desired to be available for charger connection. Such a “Battery with Integrated Universal Conditioner” embodiment is illustrated in the block diagram of FIG. 37 and is hereinafter referred to as embodiment 190 of the present invention.

The “Battery with Integrated Universal Conditioner” system embodiment 190 of FIG. 37 has identical design and components as the embodiment 185 of FIG. 36 above, except for having been provided with a port 186 for battery charger connection via its connector 187. The “High-Frequency and High-Current Battery Heater” and the “Low-Current and Wide Frequency Range Ionic-Exciter” components of the embodiment 190 are also powered by the battery.

With the integrated high-frequency battery conditioning components, the “Battery with Integrated Universal Conditioner” system embodiment 190 of FIG. 37 has the capability to power electrically powered platforms during service and while maintaining the battery temperature at or close to its optimal operating temperature range so that the battery can provide its peak power to the fully or partially powered mobile or stationary platform and also supply high-frequency and relatively low AC current to increase battery capacity and cycle life, particularly during relatively fast charge and discharge. The “Battery with Integrated Universal Conditioner” system can provide the above capabilities even while its battery is being charged.

In the block diagram of FIG. 37, the battery the “Battery with Integrated Universal Conditioner” system is shown to be charged by an externally powered source, such as line power. It is appreciated that in applications in which the platform is provided with other electrical power generators, for example by solar powered generators or an internal combustion engine powered generator, etc., then these chargers would continue to charge the battery while the system of embodiment 190 maintains battery temperature within its prescribed operational temperature range.

The “Battery with Integrated Universal Conditioner” system microcontroller, FIG. 37, which is usually provided inside a control unit enclosure (not shown) with a control panel, is also provided for controlling the operation of the system and setting all the required parameters for its operation as described later. The environmental temperature sensor, which may be positioned inside the control unit enclosure (not shown) or the “Battery with Integrated Universal Conditioner” enclosure 188 (shown by dashed line) or outside of it, provides information as to the temperature of the environment within which the “Battery with Integrated Universal Conditioner” system is located.

It is appreciated by those skilled in the art that since most battery chargers and electrically powered platforms may not be designed to filter high frequency input currents from passing into their internal circuits, it is usually necessary to also provide a “High-Frequency Filter” at the output of the battery as shown in FIG. 37 to prevent high-frequency current generated by the “High-Frequency and High-Current Battery Heater” and “Low-Current and Wide Frequency Range Ionic-Exciter” components of the “Battery with Integrated Universal Conditioner” system from interfering with the operation of the “Battery Charger” and the “Electrically-Powered Platform”. In the block diagram of FIG. 37 the system battery is shown to be connected to the “Electrically-Powered Platform” through the “High-Frequency Filter” via connectors 183 and 184. However, in most applications hard wiring is used in place of connectors 183 and 184. The “Battery Charger” is also connected by connector 187 to connector 186 of the “Battery with Integrated Universal Conditioner” system, FIG. 37.

Similar to the embodiment 170 of FIG. 34, the “Low-Current and Wide Frequency Range Ionic-Exciter” component of the embodiment 190 of FIG. 37 is designed to generate AC current at relatively low levels and at frequencies that may be significantly lower than those used for battery heating, since the primary purpose of the applied high-frequency current is to generate “ionic-excitation” of the battery electrolyte ions, thereby as was previously indicated, to prevent/minimize damage to the battery, i.e., increase battery cycle life, and to increase battery capacity in charge/discharge at relatively high rates. In the system of embodiment 190 of FIG. 37, the “Low-Current and Wide Frequency Range Ionic-Exciter” component is designed with the capability of its generated high-frequency AC current frequency and peak value to be adjustable by the programable microcontroller.

In addition, similar to the “Fast-Charger System” embodiment 100 of FIG. 25, the “High-Frequency and High-Current Battery Heater” component of the system of embodiment 190 of FIG. 37 may be designed as shown in the schematic of FIG. 14, is powered by the battery, and is designed to provide high-frequency current for heating the battery at high rates, in which the current level and frequency are usually set to achieve maximum or close to maximum heating rate. In the system of embodiment 190, the “High-Frequency and High-Current Battery Heater” is usually designed to provide an adjustable range of high-frequency current but at a single (or at most a very few” preset peak current levels) to greatly simplify its design and its operational efficiency.

It is appreciated that in the “Battery with Integrated Universal Conditioner” system of embodiment 190 of FIG. 37, the “High-Frequency and High-Current Battery Heater” and the “Low-Current and Wide Frequency Range Ionic-Exciter” components of the system are still designed to operate at high enough frequencies that would effectively “short” the capacitance between the battery electrodes to effectively isolate the electrochemical mechanism of the battery as has been previously described.

It is appreciated by those skilled in the art that operation of the “Low-Current and Wide Frequency Range Ionic-Exciter” component would result in a certain amount low-rate battery heating, which must be considered, particularly for operation in environments with temperatures that are significantly above room temperature.

The operation of the system of embodiment 190 of FIG. 37 is controlled by the provided programmable microcontroller. The temperature of the battery being charged is measured by a provided temperature sensor, such as a well-known thermocouple or thermistor or the like, the output of which is provided to the microcontroller via an appropriate “temperature sensor circuit”, FIG. 37. A temperature sensor is also provided for measuring environmental temperature of the battery and provide the information to the system controller for setting an optimal process for battery heating and ionic excitation as previously described. The system “Control Panel” provides the means for the user to turn the system on and off and to set the operational requirements of the system, such as the operating temperature and its range, heating rates, discharge rates, etc., examples of which were provided previously for the other embodiments of the present invention.

The system of embodiment 190 of FIG. 37 operates as follows. When the system is turned on for the first time, the user will use the provided system means described below, to set the system parameters and select the provided operational options. The parameters to be provided include the battery type, size, and all other pertinent characteristic information; heating temperature threshold and its acceptable range; acceptable heating and discharging rate ranges; optimal charging temperature range, charging options and rates, the option of discharging without heating, etc. It is appreciated that many or even all these parameters and options may be set by the equipment manufacturer or seller, particularly if it is purchased together with the equipment in which the battery is installed. In some applications, the system may be provided with a limited number of set of parameters preset options, for setting a certain time at which the battery is to be at its optimal temperature for platform operation.

It is also appreciated by those skilled in the art that both the above methods and means to input the required settings, heating parameters and operational options (i.e., initializing the system) are well known in the art. Other well-known methods, such as factory setting of all the parameters and options for the user and requiring minimal user input, usually buttons and/or switches, for the user interaction with the embodiment 190 system, such as on/off switch, emergency shut-down button, “High-Frequency and High-Current Battery Heater” and “Low-Current and Wide Frequency Range Ionic-Exciter” on/off switch, etc., may also be provided on the system control panel, FIG. 37. In addition, all or part of such parameter and operational settings may be set through a wireless connection using provided apps.

It is appreciated that in the block diagram of FIG. 37, the switches S8 and S9 are intended to similarly indicate the means with which the system controller residing in the microcontroller would activate/deactivate the “High-Frequency and High-Current Battery Heater” and “Low-Current and Wide Frequency Range Ionic-Exciter” components, respectively, to supply high-frequency current to the battery as it was previously described. It is appreciated that as it was previously indicated, the “High-Frequency and High-Current Battery Heater” and “Low-Current and Wide Frequency Range Ionic-Exciter” components are powered by the battery.

Now consider the case in which the battery is to be charged. The user would then activate the embodiment 190 system of FIG. 37 after setting all the required parameters and options as is described above. Once the system is turned on, the software driven system microcontroller collects data as to the state of the battery and battery environment temperatures, etc., and:
If the battery temperature is below its optimal operational temperature, then:
   If the battery has enough available electrical energy to heat the battery to its prescribed charging temperature, then the system controller would close the switch S8 and start the process of heating the battery to its optimal operational temperature; and then
      The system controller will open the switch S8 to stop battery heating and initiate battery charging by the “Battery Charger”. It is appreciated by those skilled in the art that the latter process may be readily implemented by programming the “Battery Charger” to only activate the charging process if the battery temperature is within the prescribed optimal battery charging temperature. The above battery heating may be resumed at any time to maintain the battery temperature close to its optimal operational temperature while the battery is being charged.
      The system controller, depending on the selected microcontroller programmed options, may shut the system off completely, or set it on a “stand-by” mode (described below), or if the system is set to begin to power the “Electrically-Powered Platform” after charging, then it would close the switch S9 allow the battery to power the “Electrically-Powered Platform” while the high-frequency and low-current AC generated by the “Low-Current and Wide Frequency Range Ionic-Exciter” helps to increase battery capacity as well as improve the battery cycle life. The above battery heating may be resumed at any time to maintain the battery temperature close to its optimal operational temperature.
      If the system is set to the “stand-by” mode while the battery is still connected to the charger, the controller will keep the battery at a prescribed minimum temperature to conserve energy but such that it could be heated to its optimal operating temperature range by the time that the user has selected for the battery to be ready for “Electrically-Powered Platform” operation. The above battery heating may be resumed at any time to maintain the battery temperature close to its optimal operational temperature.
      If the system is set to the “stand-by” mode while the battery is no longer is connected to the charger, for example while the “Electrically-Powered Platform” is parked in a location away from a charger, then the controller will keep the battery at a prescribed minimum temperature to conserve energy but such that it could be heated to its optimal operating temperature range by the time that the user has selected for the battery to be ready for “Electrically-Powered Platform” operation. The system controller, based on the state of charge of the battery and the temperatures of the battery and the environment, would also calculate an estimation of the battery capacity available by the time that the “Electrically-Operated Platform” is to resume operation and if the platform is a vehicle, the estimated range of the vehicle, or other similar operational time or related information for other types of platforms.
   If the battery does not have enough available electrical energy, it would notify the user (via the system control panel or other commonly used methods in the art) that the battery state of charge is low for heating the battery to its optimal charging temperature and the consequences of being charged at this temperature, for example, reducing the life of the battery some estimated percentage, or causing significant battery damage or failure if the battery temperature is too low. If the battery temperature is not too low (depending on the battery type), then the system controller may close either switch S8 or S9 or both switches (depending on the type of the battery) and begin to heat or cause mostly ionic excitation in the electrolyte while enough battery power is available, and then activate the “Battery Charger”. Then once the state of battery charge has reached the prescribed level, follow the above battery heating and charging process.
If the battery temperature is within its optimal operational temperature range, then the system controller would close the switch S9 and allow the “Battery Charger” to begin to charge the battery to the prescribed level or the prescribed amount of time while the high-frequency and low-current AC generated by the “Low-Current and Wide Frequency Range Ionic-Exciter” helps to increase battery capacity as well as improve the battery cycle life. In the meantime, the aforementioned battery heating process may be initiated by closing the switch S8 at any time to maintain the battery temperature close to its optimal operational temperature.

It is appreciated that with the battery partially or fully charged, the system of embodiment 190 of FIG. 37 may be activated at any time, upon which the microcontroller is usually programmed to close the switch S9 to allow the “Low-Current and Wide Frequency Range Ionic-Exciter” to generate high-frequency and low-current AC and supply it to the battery to increase the battery capacity and improve the battery cycle life, particularly if the rate of discharge is relatively high, unless the user has turn this feature of the system off.

It is noted that in the “Universal High-Frequency Battery Conditioning System” embodiment 180 of FIG. 35 and the “Battery with Integrated Universal Conditioner” system embodiments 185 and 190 of FIGS. 36 and 37, respectively, the “High-Frequency and High-Current Battery Heater” and “Low-Frequency and Wide Frequency Range Ionic-Exciter” components of these systems are powered by the battery. In certain applications, however, it might be desirable for the above two components of the system be powered by external power while the battery is being charged, which would shorten the amount of time that it takes to charge the battery, particularly in cold environments in which a considerable amount of electrical energy is needed to heat the battery to its optimal charging temperature and maintain its temperature in its optimal range. In addition, by powering the “High-Frequency and High-Current Battery Heater” and “Low-Frequency and Wide Frequency Range Ionic-Exciter” components of these systems by external power would avoid the situation in which the battery state of charge falls below the required level that is needed to bring the temperature of the battery close to its optimal level for charging and even to a level that would prevent damage to the battery.

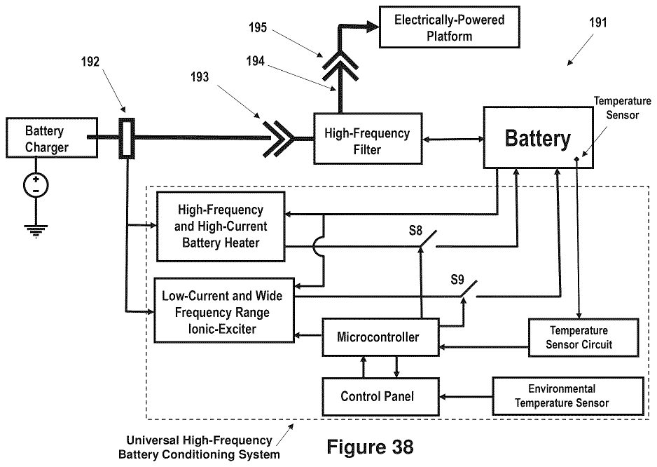

FIG. 38 illustrates the block diagram of such a “Universal High-Frequency Battery Conditioning System” embodiment in which the “High-Frequency and High-Current Battery Heater” and “Low-Frequency and Wide Frequency Range Ionic-Exciter” components of this system may be powered either by an external source (for example while the battery is being charged by an external power source) or by the system battery, which is hereinafter identified as the embodiment 191 of the present invention.

The “Universal High-Frequency Battery Conditioning System” embodiment 191 of FIG. 38, shown with dashed lines, has identical components as the embodiment 180 of FIG. 35, except that “High-Frequency and High-Current Battery Heater” and “Low-Frequency and Wide Frequency Range Ionic-Exciter” components are designed to be powered either by an external source (such as via the “Battery Charger” as shown in FIG. 38) or by the system batteries. In the “Universal High-Frequency Battery Conditioning System” embodiment of FIG. 38, the “High-Frequency and High-Current Battery Heater” component of the system may have two separate circuits, one as, for example, described by FIGS. 13 and 13A, to operate by external power, and one as, for example, described by FIG. 14 to operate by battery power, as commanded by the system controller residing in the system microcontroller. The “Low-Current and Wide Frequency Range Ionic-Exciter” component may be similarly designed with two independent circuits for operation by either external power or by battery power. It is appreciated that such components with two separate circuits that are activated by a system microcontroller command are well known in the art and usually use switching elements to power one or the other circuit. The system microcontroller, which is usually provided inside a control unit enclosure (not shown) with a control panel, is also provided for controlling the operation of the system and setting all the required parameters for its operation as described later. The external power source to “High-Frequency and High-Current Battery Heater” and “Low-Current and Wide-Frequency Range Ionic-Exciter” components may be line power (usually an AC constant voltage line power) or a DC current, which may be provided by the “Battery Charger”.

The “Battery Charger” is powered by an external source. It is, however, appreciated by those skilled in the art that since most currently used battery chargers are not generally designed to filter high frequency currents from passing into its internal circuits, it is usually necessary to provide a “High-Frequency Filter”, FIG. 38, at the output of the battery charger to prevent high-frequency current generated by the “Universal High-Frequency Battery Conditioning System” from interfering with the operation of the battery charger electronics. Such “High-Frequency Filter” elements are well known in the art and are used in many battery chargers and usually comprises a properly sized inductor and capacitor elements to lower the amplitude of the input high-frequency current to an acceptable level for the operation of the battery charger. As can be seen in the block diagram of FIG. 38, the “Battery Charger” is connected to the “High-Frequency Filter” component via connection box 192 via connector 193.

In the block diagram of FIG. 38, junction box 192 is intended to show an electrical connection junction for supplying power to the “High-Frequency and High-Current Battery Heater” and “Low-Frequency and Wide Frequency Range Ionic-Exciter” components of the embodiment 191. The junction box 193 may also be provided with a microprocessor activated switch (not shown), which could be used by the control system to turn the “Battery Charger” on and off for optimal operation of the overall system.

In addition, to prevent the high-frequency current from interfering with the operation of the electrical, electronic and other components of the “Electrically-Powered Platform” that is powered by the battery of the system embodiment 191 of FIG. 38, the battery output to the “Electrically-Powered Platform” is made via the “High-Frequency Filter” through connectors 194 and 195, so that the high-frequency current generated by the “High-Frequency and High-Current Battery Heater” and “Low-Frequency and Wide Frequency Range Ionic-Exciter” components of the “Universal High-Frequency Battery Conditioning System” are filtered from the input to the “Electrically-Powered Platform”.

It is appreciated that in the “Universal High-Frequency Battery Conditioning System” embodiment 191 of FIG. 38, the “High-Frequency and High-Current Battery Heater” and the “Low-Current and Wide Frequency Range Ionic-Exciter” components of the system are still designed to operate at high enough frequencies that would effectively “short” the capacitance between the battery electrodes to effectively isolate the electrochemical mechanism of the battery as has been previously described.

It is appreciated by those skilled in the art that operation of the “Low-Current and Wide Frequency Range Ionic-Exciter” component would result in a certain amount low-rate battery heating, which must be considered, particularly for operation in environments with temperatures that are significantly above room temperature.

The operation of the system of embodiment 191 of FIG. 38 is controlled by the provided programmable microcontroller. The temperature of the battery being charged is measured by a provided temperature sensor, such as a well-known thermocouple or thermistor or the like, the output of which is provided to the microcontroller via an appropriate “temperature sensor circuit” shown in FIG. 38. A temperature sensor is also provided for measuring environmental temperature of the battery and provide the information to the system controller for setting an optimal process for the required battery charging, heating and ionic excitation as previously described. The system “Control Panel” provides the means for the user to turn the system on and off and to set the operational requirements of the system, such as the operating temperature and its range, heating and charging rates, charge/discharge rates, etc., examples of which were provided previously for the other embodiments of the present invention.

The system of embodiment 191 of FIG. 38 operates as follows. When the system is turned on for the first time, the user will use the provided system means described below, to set the system parameters and select the provided operational options. The parameters to be provided include the battery type, size, and all other pertinent characteristic information; heating temperature threshold and its acceptable range; acceptable heating and charging rate ranges; desired charging rate according to the time of day and weekdays; the option of charging without heating or heating without charging (which, may be selected when heating is required to keep a charged battery warm when needed). It is appreciated that many or even all these parameters and options may be set by the equipment manufacturer or seller, particularly if it is purchased together with the equipment in which the battery is installed. In some applications, the system may be provided with a limited number of set of parameters preset options, for example for overnight charging and keeping or bringing the battery at its optimal temperature and fully charged by certain time in the morning for optimal operational performance and to maximize the battery life.

It is also appreciated by those skilled in the art that both the above methods and means to input the required and desired charging and heating parameters and operational options (i.e., initializing the system) are well known in the art. Other well-known methods, such as factory setting of all the parameters and options for the user and providing minimal user input, usually buttons and/or switches, for the user interaction with the embodiment 191 system, such as on/off switch, emergency shut-down button, “High-Frequency and High-Current Battery Heater” and “Low-Current and Wide Frequency Range Ionic-Exciter” on/off switch, etc., may also be provided on the system control panel, FIG. 38. In addition, all or part of such parameter and operational settings may be set through a wireless connection using provided apps.

It is appreciated that in the block diagram of FIG. 38, the switches S8 and S9 are intended to indicate the means with which the system controller residing in the microcontroller would activate/deactivate the proper circuit of the “High-Frequency and High-Current Battery Heater” and “Low-Current and Wide Frequency Range Ionic-Exciter” components, respectively, to supply high-frequency current to the battery as it was previously described. It is appreciated that as it was previously indicated, the “High-Frequency and High-Current Battery Heater” and “Low-Current and Wide Frequency Range Ionic-Exciter” components may either be powered by external power through the lines shown in the block diagram of FIG. 38 or the battery. In addition, in the block diagram of FIG. 38, the “Battery Charger” is considered to be connected/disconnected to the system “High-Frequency Filter” by the user via the connectors 193. It is appreciated that in applications in which the platform is provided with other electrical power generator types, for example by solar powered generators or an internal combustion engine powered generator, etc., then these chargers would similarly be connected to the system through the connector 193.

Once the embodiment 191 system of FIG. 38 is initiated by setting all the required parameters and options as is described above, the user can turn the system on. Here, it is assumed that the “Battery Charger” is connected to the system and is activated to begin the charging process described below. If the “Battery Charger” is not connected to system or if it is connected but is not activated to charge the battery, then the system would essentially operate as it was described for embodiment 185 of FIG. 36. It is also assumed that since external power is available for the operation of the “Battery Charger”, when the charger is connected to the system at the connection point 193, then external power is also available to the “High-Frequency and High-Current Battery Heater” and “Low-Current and Wide Frequency Range Ionic-Exciter” components of the system.

Once the system is turned on, the software driven system microcontroller collects data as to the battery and battery environment temperatures and:
Since the “High-Frequency and High-Current Battery Heater” and “Low-Current and Wide Frequency Range Ionic-Exciter” components are provided with external power, the system controller sets these components for operation with external power circuits.
If the battery temperature is below its optimal charging range, it would close the switch S8 and start the process of heating the battery to its optimal charging temperature range.
Microcontroller will then open the switch S8 and close switch S9 and activate the “Battery Charger” to begin to charge the battery while the high-frequency and low-current AC generated by the “Low-Current and Wide Frequency Range Ionic-Exciter” helps to increase battery capacity as well as improve the battery cycle life. Then once the battery is charged fully or to the prescribed level, the “Battery Charger” is turned off. Then:
   If the battery is/or is about to power the “Electrically-Powered Platform”, then the switch S9 is left closed and the “Low-Current and Wide Frequency Range Ionic-Exciter”continues to supply its generated high-frequency and low-current AC to the battery to increase the battery capacity and improve the battery cycle life, particularly if the rate of discharge is relatively high.
   If the battery is not going to power the “Electrically-Powered Platform”, then the microcontroller would open the switch S9 and end the supply of high-frequency and low-current AC to the battery.

It is appreciated that with the battery partially or fully charged, the system of embodiment 191 of FIG. 38 can be activated at any time, upon which the microcontroller is usually programmed to close the switch S9 to allow the “Low-Current and Wide Frequency Range Ionic-Exciter” to generate high-frequency and low-current AC and supply it to the battery to increase the battery capacity and improve the battery cycle life, particularly if the rate of discharge is relatively high, unless the user has turn this feature of the system off.

Once the battery is charged to the prescribed level, if the optimal temperature maintenance option has been selected by the user, the system controller would monitor the battery temperature and would turn the “High-Frequency and High-Current Battery Heater” on when the battery temperature drops below the prescribed threshold and turns it off when the battery temperature reaches its prescribed upper limit threshold, as for example, shown in the plot of FIG. 16.

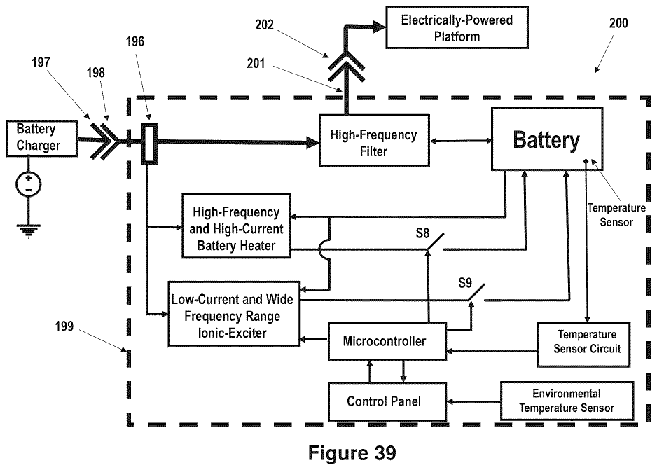

It is noted that in the “Battery with Integrated Universal Conditioner” system embodiments 185 and 190 of FIGS. 36 and 37, respectively, and the “Universal High-Frequency Battery Conditioning System” embodiment 180 of FIG. 35, the “High-Frequency and High-Current Battery Heater” and “Low-Frequency and Wide Frequency Range Ionic-Exciter” components of these systems are powered by the battery. In certain applications, however, it might be desirable for the above two components of the system be powered by external power while the battery is being charged, which would shorten the amount of time that it takes to charge the battery, particularly in cold environments in which a considerable amount of electrical energy is needed to heat the battery to its optimal charging temperature and maintain its temperature in its optimal range. In addition, by powering the “High-Frequency and High-Current Battery Heater” and “Low-Frequency and Wide Frequency Range Ionic-Exciter” components of these systems by external power would avoid the situation in which the battery state of charge falls below the required level that is needed to bring the temperature of the battery close to its optimal level for charging and even to a level that would prevent damage to the battery. Such a “Universal High-Frequency Battery Conditioning System” embodiment 191 of FIG. 38 was described above. However, it is highly desirable to also develop a battery in which the above system integrated. The advantages of such an integrated battery system were previously described for the “Battery with Integrated Universal Conditioner” system embodiment 190. Such a “Battery with Integrated Universal Conditioner” embodiment is shown in the block diagram of FIG. 39 and is indicated as embodiment 200 of the present invention.

FIG. 39 illustrates the block diagram of such a “Battery with Integrated Universal Conditioner” embodiment in which the “High-Frequency and High-Current Battery Heater” and “Low-Frequency and Wide Frequency Range Ionic-Exciter” components of this system may be powered either by an external source (for example while the battery is being charged by an external power source) or by the system battery, which is hereinafter identified as the embodiment 200 of the present invention. 197

The “Battery with Integrated Universal Conditioner” embodiment 200 of FIG. 39, shown with dashed lines, has identical components as the embodiment 190 of FIG. 37, except that “High-Frequency and High-Current Battery Heater” and “Low-Frequency and Wide Frequency Range Ionic-Exciter” components are designed to be powered either by an external source (such as via the “Battery Charger” as shown in FIG. 39) or by the system batteries. In “Battery with Integrated Universal Conditioner” embodiment 200 of FIG. 39, the “High-Frequency and High-Current Battery Heater” component of the system may have two separate circuits, one as, for example, described by FIGS. 13 and 13A, to operate by external power, and one as, for example, described by FIG. 14 to operate by battery power, as commanded by the system controller residing in the system microcontroller. The “Low-Current and Wide Frequency Range Ionic-Exciter” component may be similarly designed with two independent circuits for operation by either external power or by battery power. It is appreciated that such components with two separate circuits that are activated by a system microcontroller command are well known in the art and usually use switching elements to power one or the other circuit. The system microcontroller, which is usually provided inside a control unit enclosure (not shown) with a control panel, is also provided for controlling the operation of the system and setting all the required parameters for its operation as described later. The external power source to “High-Frequency and High-Current Battery Heater” and “Low-Current and Wide-Frequency Range Ionic-Exciter” components may be line power (usually an AC constant voltage line power) or a DC current, which may be provided by the “Battery Charger”.

The “Battery Charger” is powered by an external source. It is, however, appreciated by those skilled in the art that since most currently used battery chargers are not generally designed to filter high frequency currents from passing into its internal circuits, it is usually necessary to provide a “High-Frequency Filter”, FIG. 39, at the output of the battery charger to prevent high-frequency current generated by the “Battery with Integrated Universal Conditioner” from interfering with the operation of the battery charger electronics. Such “High-Frequency Filter” elements are well known in the art and are used in many battery chargers and usually comprises a properly sized inductor and capacitor elements to lower the amplitude of the input high-frequency current to an acceptable level for the operation of the battery charger. As can be seen in the block diagram of FIG. 39, the “Battery Charger” is connected to the “High-Frequency Filter” component via connection box 196 via the “Battery Charger” and “Battery with Integrated Universal Conditioner” connectors 197 and 198, respectively.

In the block diagram of FIG. 39, connection box 196 is intended to show an electrical connection junction for supplying power to the “High-Frequency and High-Current Battery Heater” and “Low-Frequency and Wide Frequency Range Ionic-Exciter” components of the embodiment 200. Junction box 196 may also be provided with a microprocessor activated switch (not shown), which could be used by the control system to turn the “Battery Charger” on and off for optimal operation of the overall system.

In addition, to prevent the high-frequency current from interfering with the operation of the electrical, electronic and other components of the “Electrically-Powered Platform” that is powered by the battery of the system embodiment 200 of FIG. 39, the battery output to the “Electrically-Powered Platform” is made via the “High-Frequency Filter” through connectors 201 and 202, so that the high-frequency current generated by the “High-Frequency and High-Current Battery Heater” and “Low-Frequency and Wide Frequency Range Ionic-Exciter” components of the “Universal High-Frequency Battery Conditioning System” are filtered from the input to the “Electrically-Powered Platform”.

It is appreciated that in the “Universal High-Frequency Battery Conditioning System” embodiment 200 of FIG. 39, the “High-Frequency and High-Current Battery Heater” and the “Low-Current and Wide Frequency Range Ionic-Exciter” components of the system are still designed to operate at high enough frequencies that would effectively “short” the capacitance between the battery electrodes to effectively isolate the electrochemical mechanism of the battery as has been previously described.

It is appreciated by those skilled in the art that operation of the “Low-Current and Wide Frequency Range Ionic-Exciter” component would result in a certain amount low-rate battery heating, which must be considered, particularly for operation in environments with temperatures that are significantly above room temperature.

The operation of the system of embodiment 200 of FIG. 39 is controlled by the provided programmable microcontroller. The temperature of the battery being charged is measured by a provided temperature sensor, such as a well-known thermocouple or thermistor or the like, the output of which is provided to the microcontroller via an appropriate “temperature sensor circuit” shown in FIG. 39. A temperature sensor is also provided for measuring environmental temperature of the battery and provide the information to the system controller for setting an optimal process for the required battery charging, heating and ionic excitation as previously described. The system “Control Panel” provides the means for the user to turn the system on and off and to set the operational requirements of the system, such as the operating temperature and its range, heating and charging rates, charge/discharge rates, etc., examples of which were provided previously for the other embodiments of the present invention. All described components of the “Battery with Integrated Universal Conditioner” embodiment 200, including junction 196 are packaged inside the housing 199 of the “Battery with Integrated Universal Conditioner” as shown by dashed lines in FIG. 39. The connectors 201 and 198 are also mounted on housing 199. The connectors 201 and 202 may be replaced by hard wires or the like when the “Battery with Integrated Universal Conditioner” is to be rarely disconnected from the “Electrically-Powered Platform”.

The system of embodiment 200 of FIG. 39 operates as follows. When the system is turned on for the first time, the user will use the provided system means described below, to set the system parameters and select the provided operational options. The parameters to be provided include the battery type, size, and all other pertinent characteristic information; heating temperature threshold and its acceptable range; acceptable heating and charging rate ranges; desired charging rate according to the time of day and weekdays; the option of charging without heating or heating without charging (which, may be selected when heating is required to keep a charged battery warm when needed). It is appreciated that many or even all these parameters and options may be set by the equipment manufacturer or seller, particularly if it is purchased together with the equipment in which the battery is installed. In some applications, the system may be provided with a limited number of set of parameters preset options, for example for overnight charging and keeping or bringing the battery at its optimal temperature and fully charged by certain time in the morning for optimal operational performance and to maximize the battery life.

It is also appreciated by those skilled in the art that both the above methods and means to input the required and desired charging and heating parameters and operational options (i.e., initializing the system) are well known in the art. Other well-known methods, such as factory setting of all the parameters and options for the user and providing minimal user input, usually buttons and/or switches, for the user interaction with the embodiment 200 system, such as on/off switch, emergency shut-down button, “High-Frequency and High-Current Battery Heater” and “Low-Current and Wide Frequency Range Ionic-Exciter” on/off switch, etc., may also be provided on the system control panel, FIG. 39. In addition, all or part of such parameter and operational settings may be set through a wireless connection using provided apps.

It is appreciated that in the block diagram of FIG. 39, the switches S8 and S9 are intended to indicate the means with which the system controller residing in the microcontroller would activate/deactivate the proper circuit of the “High-Frequency and High-Current Battery Heater” and “Low-Current and Wide Frequency Range Ionic-Exciter” components, respectively, to supply high-frequency current to the battery as it was previously described. It is appreciated that as it was previously indicated, the “High-Frequency and High-Current Battery Heater” and “Low-Current and Wide Frequency Range Ionic-Exciter” components may either be powered by external power through the lines shown in the block diagram of FIG. 39 or the battery. In addition, in the block diagram of FIG. 39, the “Battery Charger” is considered to be connected/disconnected to the system “High-Frequency Filter” by the user via the connectors 197 and 198. It is appreciated that in applications in which the platform is provided with other electrical power generator types, for example by solar powered generators or an internal combustion engine powered generator, etc., then these chargers would similarly be connected to the system through the same connectors.

Once the embodiment 200 system of FIG. 39 is initiated by setting all the required parameters and options as is described above, the user can turn the system on. Here, it is assumed that the “Battery Charger” is connected to the system and is activated to begin the charging process described below. If the “Battery Charger” is not connected to system or if it is connected but is not activated to charge the battery, then the system would essentially operate as it was described for embodiment 185 of FIG. 36. It is also assumed that since external power is available for the operation of the “Battery Charger”, when the charger is connected to the system, then external power is also available to the “High-Frequency and High-Current Battery Heater” and “Low-Current and Wide Frequency Range Ionic-Exciter” components of the system.

Once the system is turned on, the software driven system microcontroller collects data as to the battery and battery environment temperatures and:
Since the “High-Frequency and High-Current Battery Heater” and “Low-Current and Wide Frequency Range Ionic-Exciter” components are provided power by external sources, the system controller sets these components for operation with external power circuits.
If the battery temperature is below its optimal charging range, it would close the switch S8 and start the process of heating the battery to its optimal charging temperature range.
Microcontroller will then open the switch S8 and close switch S9 and activate the “Battery Charger” to begin to charge the battery while the high-frequency and low-current AC generated by the “Low-Current and Wide Frequency Range Ionic-Exciter” helps to increase battery capacity as well as improve the battery cycle life. Then once the battery is charged fully or to the prescribed level, the “Battery Charger” is turned off. Then:
   If the battery is/or is about to power the “Electrically-Powered Platform”, then the switch S9 is left closed and the “Low-Current and Wide Frequency Range Ionic-Exciter” continues to supply its generated high-frequency and low-current AC to the battery to increase the battery capacity and improve the battery cycle life, particularly if the rate of discharge is relatively high.
   If the battery is not going to power the “Electrically-Powered Platform”, then the microcontroller would open the switch S9 and end the supply of high-frequency and low-current AC to the battery.

It is appreciated that with the battery partially or fully charged, the system of embodiment 200 of FIG. 39 can be activated at any time, upon which the microcontroller is usually programmed to close the switch S9 to allow the “Low-Current and Wide Frequency Range Ionic-Exciter” to generate high-frequency and low-current AC and supply it to the battery to increase the battery capacity and improve the battery cycle life, particularly if the rate of discharge is relatively high, unless the user has turn this feature of the system off.

Once the battery is charged to the prescribed level, if the optimal temperature maintenance option has been selected by the user, the system controller would monitor the battery temperature and would turn the “High-Frequency and High-Current Battery Heater” on when the battery temperature drops below the prescribed threshold and turns it off when the battery temperature reaches its prescribed upper limit threshold, as for example, shown in the plot of FIG. 16.

In the block diagrams of the embodiments 180, 185, 190, 191 and 200 of FIGS. 35, 36, 37, 38 and 39, respectively, the “High-Frequency and High-Current Battery Heater” and “Low-Current and Wide Frequency Range Ionic-Exciter” are illustrated as separate components. However, it is appreciated by those skilled in the art that these components may in practice be integrated and fabricated as one unit, which may also include the system microcontroller and temperature sensor circuits as well as the switches S8 and S9.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated but should be constructed to cover all modifications that may fall within the scope of the appended claims.

What is claimed is:

1. A heating device for an energy storage device, the energy storage device having a core with an electrolyte having ions therein, the device comprising:
an energy storage device coupling configured to be coupled to the energy storage device;
a heater/ionic exciter coupled to the energy storage device coupling, wherein the heater/ionic exciter is configured to provide a high frequency input to the energy storage device when coupled to the energy storage device through the energy storage device coupling, wherein the heater/ionic exciter is configured to operate in each of at least two modes wherein a first of the two modes is a heating mode in which the high frequency input is set at or close to a maximum heating rate to substantially maximize an internal heating effect of the ions within the electrolyte of the energy storage device to generate heat and raise a temperature of the electrolyte, and a second of the two modes is a primarily ionic-excitation mode in which the high frequency input is set above the maximum heating rate to generate ionic-excitation of the electrolyte ions, the heater/ionic exciter receiving operating power from the energy storage device when the energy storage device is coupled to the energy storage device coupling;
a controller configured to control the heater/ionic exciter to operate in each of the at least two modes and to enable and disable providing the high frequency input to the energy storage device;
a temperature sensor circuit configured to receive an indication of a temperature of the energy storage device when the energy storage device is coupled to the energy storage device coupling and is configured to receive an indication of an environmental temperature, wherein the temperature sensor circuit is coupled to the controller to provide the controller with the indication of the temperature of the energy storage device and the indication of the environmental temperature, wherein the controller controls the heater/ionic exciter to operate in the first mode when the temperature of the energy storage device is below an operational temperature range and is configured to control the heater/ionic exciter to operate in the second mode when the energy storage device receives fast charging and is within the operational temperature range.

2. The device of claim 1, wherein the controller is configured to control the heater/ionic exciter to maintain the energy storage device within the operational temperature range when the energy storage device is used by an electrically powered platform.

3. The device of claim 1, comprising a control panel coupled to the controller, wherein the control panel is configured to receive operational parameters of the energy storage device and to provide the operational parameters to the controller for the control of the heater/ionic exciter.

4. The device of claim 3, wherein the operational parameters include at least one of energy storage device type, energy storage device size, the operational temperature range, heating rate range, charging rate range; charging rate according to day; and charging rate according to time of day.

5. The device of claim 3, wherein the control panel is configured to receive a time of intended platform service and to provide the time to the controller, wherein the controller is configured to bring the energy storage device to the operational temperature range by the time.

6. The device of claim 1, comprising a control panel coupled to the controller, wherein the control panel is configured to enable and disable the heater/ionic exciter.

7. The device of claim 1, comprising a first coupling coupled to the energy storage device, wherein the first coupling is configured to be coupled to an energy storage device charger and to an energy storage platform that is powered by the energy storage device.

8. The device of claim 7, comprising a high-frequency filter, wherein the high frequency filter is coupled between the first coupling and the energy storage device to filter the high frequency from being received by at least one of the energy storage device charger and the energy storage platform.

9. The device of claim 7, wherein the controller is configured to control the heater/ionic exciter to operate in the second mode when the energy storage device receives charging and is within the operational temperature range to reduce degradation of the energy storage device during the charging.

10. The device of claim 1, wherein the controller is configured to control the heater/ionic exciter to discontinue the second mode when the temperature of the energy storage device is above the operational temperature range.

11. An integrated self-heating device, the device comprising:
a battery having a core with an electrolyte having ions therein;
a heater/ionic exciter coupled to the battery, wherein the heater/ionic exciter is configured to provide a high frequency input to the battery, wherein the heater/ionic exciter is configured to operate in each of at least two modes wherein a first of the two modes is a heating mode in which the high frequency input is set at or close to a maximum heating rate to substantially maximize an internal heating effect of the ions within the electrolyte of the battery to generate heat and raise a temperature of the electrolyte, and a second of the two modes is a primarily ionic-excitation mode in which the high frequency input is set above the maximum heating rate to generate ionic-excitation of the electrolyte ions;
a controller configured to control the heater/ionic exciter to operate in each of the at least two modes and to enable and disable providing the high frequency input to the battery;
a temperature sensor circuit configured to receive an indication of a temperature of the battery, wherein the temperature sensor circuit is coupled to the controller to provide the controller with the indication of the temperature of the battery, wherein the controller controls the heater/ionic exciter to operate in the first mode when the temperature of the battery is below an operational temperature range and is configured to control the heater/ionic exciter to operate in the second mode when the battery receives fast charging and is within the operational temperature range.

12. The device of claim 11, comprising at least one of a first coupling between the battery and the heater/ionic exciter for powering the heater/ionic exciter from the battery when the heater/ionic exciter is operated in either of the first mode or the second mode; and a second coupling between a battery charger and the heater/ionic exciter for powering the heater/ionic exciter from the charger when the heater/ionic exciter is operated in either of the first mode or the second mode.

13. The device of claim 12, comprising both the first coupling and the second coupling, wherein the controller is configured to select the first coupling when the battery charger is not coupled to the second coupling and is configured to select the second coupling when the battery charger is coupled to the second coupling.

14. The device of claim 11, comprising a control panel coupled to the controller, wherein the control panel is configured to receive operational parameters of the battery and to provide the operational parameters to the controller for the control of the heater/ionic exciter.

15. The device of claim 11, comprising a high-frequency filter, wherein the high frequency filter is coupled between the battery and at least one of a battery charger and an electrically powered platform to filter the high frequency from being received by the at least one of the battery charger and the energy storage platform.

16. A high frequency conditioning device to reduce battery capacity loss during charging and discharging, the device comprising:
a battery having a core with an electrolyte having ions therein;
a wide frequency range ionic exciter coupled to the battery, wherein the wide frequency range ionic exciter is configured to provide an amplitude and a high frequency input to the battery, wherein the provided amplitude and the high frequency input is sufficient to generate ionic-excitation of the electrolyte ions while minimizing a battery heating level;
a controller configured to control the wide frequency range ionic exciter to select the amplitude and to select the high frequency input to the battery to reduce the battery capacity loss during at least one of the charging and discharging of the battery;
a temperature sensor circuit configured to receive an indication of a temperature of the battery, wherein the temperature sensor circuit is coupled to the controller to provide the controller with the indication of the temperature of the battery, wherein the controller is configured to control the wide frequency range ionic exciter during the at least one of the charging and discharging of the battery based on a size and type of the battery and the temperature of the battery.

17. The device of claim 16, wherein the wide frequency range ionic exciter is configured to receive operating power from at least one of a changer coupled to the device and the battery.

18. The device of claim 16, wherein the high frequency input is a first high frequency input, the device comprising
a heater/ionic exciter coupled to the battery, wherein the heater/ionic exciter is configured to provide a second high frequency input to the battery, wherein the heater/ionic exciter is configured to operate in a heating mode in which the second high frequency input is set at or close to a maximum heating rate to substantially maximize an internal heating effect of the ions within the electrolyte of the battery to generate heat and raise a temperature of the electrolyte,
the controller being configured to control the heater/ionic exciter to enable and disable providing the second high frequency input to the battery,
wherein the controller controls the heater/ionic exciter to operate in the heating mode when the temperature of the battery is below an operational temperature range and is configured to enable the wide frequency range ionic exciter when the battery receives charging or is being discharged.

19. The device of claim 18, wherein the heater/ionic exciter is configured to receive operating power from at least one of a battery charger coupled to the device and the battery.

20. The device of claim 16, comprising a high-frequency filter, wherein the high frequency filter is coupled between the battery and at least one of a battery charger and an energy storage platform that is powered by the battery to filter at least one of the first high frequency input and the second high frequency input from being received by at least one of the battery charger and the energy storage platform.

21. A high frequency conditioning device to reduce battery capacity loss during charging and discharging, the battery having a core with an electrolyte having ions therein, the device comprising:
a battery coupling configured to be coupled to the battery;
a wide frequency range ionic exciter coupled to the battery coupling, wherein the wide frequency range ionic exciter is configured to provide an amplitude and a high frequency input to the battery when coupled to the battery through the battery coupling, wherein the provided amplitude and the high frequency input is sufficient to generate ionic-excitation of the electrolyte ions while minimizing a battery heating level;
a controller configured to control the wide frequency range ionic exciter to select the amplitude and to select the high frequency input to the battery to reduce the battery capacity loss during at least one of the charging and discharging of the battery;
a temperature sensor circuit configured to receive an indication of a temperature of the battery, wherein the temperature sensor circuit is coupled to the controller to provide the controller with the indication of the temperature of the battery, wherein the controller is configured to control the wide frequency range ionic exciter during the at least one of the charging and discharging of the battery based on a size and type of the battery and the temperature of the battery.

22. The device of claim 21, wherein the high frequency input is a first high frequency input, the device comprising
a heater/ionic exciter coupled to the battery coupling, wherein the heater/ionic exciter is configured to provide a second high frequency input to the battery when the battery is coupled to the battery coupling, wherein the heater/ionic exciter is configured to operate in a heating mode in which the second high frequency input is set at or close to a maximum heating rate to substantially maximize an internal heating effect of the ions within the electrolyte of the battery to generate heat and raise a temperature of the electrolyte,
the controller being configured to control the heater/ionic exciter to enable and disable providing the second high frequency input to the battery,
wherein the controller controls the heater/ionic exciter to operate in the heating mode when the battery is coupled to the battery coupling and the temperature of the battery is below an operational temperature range and is configured to enable the wide frequency range ionic exciter when the battery receives charging or is being discharged.
